(19) United States
(12) Patent Application Publication
(10) Pub. No.: US 2026/0107324 A1
(43) Pub. Date: Apr. 16, 2026

(54) Methods and Apparatus for PRACH Transmission in non-SBFD and SBFD Symbols and/or Slots

(71) Applicant: Charter Communications Operating, LLC, St. Louis, MO (US)

(72) Inventors: Mojtaba Ahmadi Almasi, Portland, OR (US); Dumitru M. Ionescu, Poway, CA (US); Maulik Vaidya, Escondido, CA (US)

(21) Appl. No.: 19/356,148

(22) Filed: Oct. 12, 2025

Related U.S. Application Data
(60) Provisional application No. 63/706,726, filed on Oct. 13, 2024.

(51) Int. Cl. H04W 74/0833; H04L 5/14

(52) U.S. Cl. CPC H04W 74/0833; H04L 5/14

(57) ABSTRACT

Methods and apparatus for supporting efficient PRACH signaling in a communications system supporting Sub-band Full Duplex (SBFD) are described. A timing-frequency structure is implemented by a base station, which includes both non-SBFD slots and SBFD slots. The UE selects ROs corresponding to SBFD or non-SBFD slot(s) and performs an initial access attempt (with or without PRACH repetitions). In the case of failure of the initial access attempt, the UE performs an additional access attempt. The selection of RO(s) for the additional access attempt may be, and sometimes is, a function of the RO type (non-SBFD slot RO or SBFD slot RO) used in the initial access attempt. In some embodiments to provide diversity between attempts, the UE will select, for the additional access attempt, an RO corresponding to a different type of slot than used for the failed initial access attempt. However, this is not the case in all embodiments.

### RELATED APPLICATIONS

The present application claims the benefit of U.S. Provisional Patent Application titled “Methods and Apparatus for PRACH Transmission in non-SBFD and SBFD Symbols and/or Slots” which was filed on Oct. 13, 2024 and assigned application Ser. No. 63/706,726 and which is hereby expressly incorporated by reference in its entirety.

### FIELD

The present application relates to communications methods and apparatus, and more particularly, to methods and apparatus for supporting PRACH transmission in non-SBFD symbols and slots and in SBFD symbols and slots.

### BACKGROUND

Sub-band full duplex (SBFD) is a recent form of full duplexing that enables the simultaneous transmission of uplink (UL) and downlink (DL) signals using non-overlapping frequency resources within the confines of the same unpaired time division duplexing (TDD) carrier. Support for SBFD and inclusion of SBFD slots in timing structures used for controlling communication systems is currently under discussion. While the introduction of SBFD slots, in which a portion of the slot is used for downlink communications and another, often smaller, portion of resources in the slot are used for uplink communications, has the potential to reduce the time between opportunities for a user equipment (UE) to attempt to access a network, it introduces complexities and needs for communicating control information to allow a UE to understand which portions of a SBFD are available to the UE for access attempts and/or other uplink communications while other portions of the same slot are being used for downlink signaling.

The introduction of UEs capable of using uplink transmission opportunities in SBFD slots introduces opportunities to reduce the time required to connect to a network, e.g., by reducing the time between random access opportunities, but also creates signaling and resource utilization issues associated with SBFD utilization. The issues are complicated by the fact that many networks will likely include some UEs or other devices which are not capable of utilizing SBFD slots and/or uplink resources in such slots because they predate or do not include support for using SBFD slots and/or uplink resources in such slots. Devices which are able to take advantage of the features and/or transmission opportunities provided by SBFD slots are sometimes referred to as SBFD aware devices. In systems which support SBFD slots, timing structures used in the communication system can include a combination of Uplink only slots, sometimes referred to as Uplink slots, in which UEs can transmit uplink signals to base stations, e.g., gNBs, Downlink only slots, sometimes referred to as Downlink slots, and SBFD slots which can include a mix of Uplink and/or Downlink resources.

UEs or other devices which do not support the use of SBFD signaling or slots, e.g., because they predate or do not support such functionality, are referred to as non-SBFD devices or non-SBFD aware devices. Accordingly, a non-SBFD aware device is a device which cannot take advantage of features made possible by SBFD functionality.

Before a UE can communicate via a network it must perform what is sometimes referred to as an initial access. Initial access is performed before data communication occurs with the UE trying to connect to a network via a base station, e.g., gNB. When performing an initial access, a UE does not know which gNB it is trying to connect to. To establish the connection, UE and gNB follow an initial access procedure.

A common initial access procedure includes two main steps: a cell search step and a random access step. During cell search, a UE receives necessary information about the gNB that it wants to connect to along with synchronization signals and information about random access channel.

After receiving information about the random access channel, a UE will normally proceed with a random access procedure. The random access procedure typically includes transmission of a signal, by the UE on Physical Random Access Channel (PRACH) resources.

With the case of a legacy (non-SBFD aware) UE, the legacy UE is restricted to using PRACH resources only on non-SBFD slots. However, with the case of a SBFD-aware UE, PRACH resources may be available to be selected and used on both non-SBFD slots and SBFD slots.

Based on the above discussion, there is a need for new methods and apparatus to support random access attempts in an environment, in which SBFD slots including RACH occasion (RO) opportunities are available to be used by SBFD-aware UEs, in addition to non-SBFD slots. It would be beneficial if at least some of these new methods and apparatus facilitated UE-aware selection of ROs, which provided more efficient random access including a higher attempt success rate and/or provided for quicker access, e.g., lower latency. It would be beneficial if at least some of these new methods and apparatus were implemented without negatively impacting legacy UE access operations.

### SUMMARY

Methods and apparatus for supporting efficient PRACH signaling in a communications system supporting Sub-band Full Duplex (SBFD) are described. A timing-frequency structure is implemented by a base station, e.g., gNB, which includes both non-SBFD slots and SBFD slots. RACH Occasions (RO) are included in both non-SBFD slots and SBFD slots. Non-SBFD aware UEs, e.g., legacy UEs, are restricted to using ROs in non-SBFD slots. SBFD-aware UEs are generally allowed to use ROs corresponding to both non-SFBD slots and SBFD slots, but may be, and sometimes are, subject to restrictions and/or rules which may determine the type of slot to be used.

A UE, e.g., a SBFD-aware UE, may decide to perform an access attempt, without PRACH repetitions, said access attempt including transmitting a single PRACH signal on a selected RO. Alternatively, the UE may decide to perform an access attempt, with PRACH repetitions, said access attempt including multiple PRACH transmissions, each of the multiple PRACH transmissions corresponding to a different selected RO.

If the UE performs an initial access attempt (with or without PRACH repetitions) which results in failure, the UE may, and sometimes does, perform an additional access attempt, in response to the failure. The selection of RO(s) for the additional access attempt may be, and sometimes is, a function of the RO type (non-SBFD slot RO or SBFD slot RO) used in the initial access attempt. In some embodiments the UE will select an RO corresponding to a different type of slot than used for the failed initial access attempt for the additional access attempt. In this way, in such embodiments, slot diversity is achieved increasing the chance that the additional access attempt will succeed following failure of the original access attempt which was selected in some cases because the use of SBFD or a non-SBFD slot for the initial access attempt seemed based on signal measurement or other factors or more likely to succeed.

The UE selects one or more RACH Occasion (ROs), to transmit a PRACH signal for an access attempt, e.g., for the additional access attempt, from among a plurality alternative ROs including one or more ROs in non-SBFD slots and one or more ROs in SBFD slots. In some embodiments, the selection is based on one or more of: restrictions applied to the UE, type of slot used to communicate the PRACH signal in the initial access attempt, power measurement information, e.g., RSRP with respect to threshold(s), and latency considerations. In some embodiments, some base stations supporting SBFD and some SBFD-aware UEs support frequency hopping with regard to ROs, in addition to allowing the SBFD-aware UEs to use ROs in both non-SBFD slots and SBFD slots.

An exemplary method of operating a user equipment (UE) in accordance with some embodiments, includes: operating the UE to transmit a PRACH signal as part of an initial access attempt using a first symbol, said first symbol being a non-SBFD symbol or SBFD symbol in a timing structure including both non-SBFD symbols and SBFD symbols; detecting failure of the initial access attempt; and performing an additional access attempt by including transmitting a PRACH signal using a second symbol corresponding to a second time slot following a first time slot, in which said first symbol used for the initial access attempt was located.

While various features are discussed in the above summary, all features discussed above need not be supported in all embodiments and numerous variations are possible. Additional features, details and embodiments are discussed in the detailed description which follows.

### BRIEF DESCRIPTION OF THE FIGURES

FIG. 1 is a drawing of an exemplary communications system in accordance with an exemplary embodiment.

FIG. 2 is a drawing of an exemplary base station, e.g., a gNB, in accordance with an exemplary embodiment.

FIG. 3 is a drawing of an exemplary user equipment (UE), e.g., a SBFD-aware UE, in accordance with an exemplary embodiment.

FIG. 4 is a drawing of an exemplary user equipment (UE), e.g., a legacy UE which is a non SBFD-aware UE, in accordance with an exemplary embodiment.

FIG. 5A is a first part of a flowchart of an exemplary method of operating a UE in accordance with an exemplary embodiment.

FIG. 5B is a second part of a flowchart of an exemplary method of operating a UE in accordance with an exemplary embodiment.

FIG. 5C is a third part of a flowchart of an exemplary method of operating a UE in accordance with an exemplary embodiment.

FIG. 5D is a fourth part of a flowchart of an exemplary method of operating a UE in accordance with an exemplary embodiment.

FIG. 5E is a fifth part of a flowchart of an exemplary method of operating a UE in accordance with an exemplary embodiment.

FIG. 5F is a sixth part of a flowchart of an exemplary method of operating a UE in accordance with an exemplary embodiment.

FIG. 5G is a seventh part of a flowchart of an exemplary method of operating a UE in accordance with an exemplary embodiment.

FIG. 5H is an eighth part of a flowchart of an exemplary method of operating a UE in accordance with an exemplary embodiment.

FIG. 5 comprises the combination of FIG. 5A, FIG. 5B, FIG. 5C, FIG. 5D, FIG. 5E, FIG. 5F, FIG. 5G and FIG. 5H.

FIG. 6A is a first part of an exemplary signaling diagram, illustrating signaling and operations performed by a base station and a SBFD-aware UE, in accordance with an exemplary embodiment.

FIG. 6B is a second part of signaling diagram, illustrating signaling and operations performed by a base station and a SBFD-aware UE, in accordance with an exemplary embodiment.

FIG. 6C is a third part of a signaling diagram, illustrating signaling and exemplary operations performed by a base station and a SBFD-aware UE, in accordance with an exemplary embodiment.

FIG. 6 comprises the combination of FIG. 6A, FIG. 6B and FIG. 6B.

FIG. 7A is a first drawing illustrating features of an exemplary timing frequency structure including SBFD slots and non-SBFD slots.

FIG. 7B is a second drawing of the exemplary timing frequency structure of FIG. 7A with reference numbers used to identify each of the ROs in the SBFD and non-SBFD slots of FIG. 7A.

FIG. 7 is a drawing illustrating how FIGS. 7A and 7B can be combined to form a complete drawing illustrating features of an exemplary timing frequency structure including SBFD slots and non-SBFD slots.

FIG. 8 illustrates an example in which a UE, e.g., a SBFD aware UE, is allowed to transmit PRACH signals in only non-SBFD symbols/slots.

FIG. 9 illustrates an example in which a UE, e.g., a SBFD aware UE, is allowed to transmit PRACH signals in only SBFD symbols/slots.

FIG. 10 illustrates an example in which a UE, e.g., a SBFD aware UE, is allowed to transmit PRACH signals in non-SBFD symbols/slots and SBFD symbols/slots.

FIG. 11 illustrates an example in which a UE, e.g., a SBFD aware UE, is allowed to transmit PRACH repetitions, as part of an access attempt including PRACH repetitions, in only ROs in non-SBFD slots.

FIG. 12 illustrates an example in which a UE, e.g. a SBFD aware UE, is allowed to transmit PRACH repetitions, as part of an access attempt including PRACH repetitions, in only ROs in SBFD slots.

FIG. 13 illustrates an example in which a UE, e.g. a SBFD aware UE, is allowed to transmit PRACH repetitions in a mix of SBFD and non-SBFD slots, as part of an access attempt including PRACH repetitions.

FIG. 14 illustrates an example in which a UE, e.g. a SBFD aware UE, is allowed to, and does, perform frequency hopping with regard to use of ROs.

FIG. 15 illustrates an example in which a UE, e.g. a SBFD aware UE does not perform frequency hopping with regard to use of ROs.

FIG. 16 is a drawing illustrating an exemplary timing frequency structure including downlink slots, SBFD slots, and uplink slots (non-SBFD slots) and further illustrates exemplary ROs in SBFD slots and non-SBFD slots, for one particular SSB, in accordance with an exemplary embodiment.

FIG. 17 is a drawing which illustrates an example in which a SBFD aware UE transmits a PRACH signal in an initial access attempt (without repetitions) in a SBFD slot RO, and following failure of the initial attempt, transmits a PRACH signal in an additional access attempt (without repetitions) in a SBFD slot RO.

FIG. 18 is a drawing which illustrates an example in which a SBFD aware UE transmits a PRACH signal in an initial access attempt (without repetitions) in a SBFD slot RO, and following failure of the initial attempt, transmits a PRACH signal in an additional access attempt (without repetitions) in a non-SBFD slot RO.

FIG. 19 is a drawing which illustrates an example in which a SBFD aware UE transmits a PRACH signal in an initial access attempt (without repetitions) in a non-SBFD slot RO, and following failure of the initial attempt, transmits a PRACH signal in an additional access attempt (without repetitions) in a non-SBFD slot RO.

FIG. 20 is a drawing which illustrates an example in which a SBFD aware UE transmits a PRACH signal in an initial access attempt (without repetitions) in a non-SBFD slot RO, and following failure of the initial attempt, transmits a PRACH signal in an additional access attempt (without repetitions) in a SBFD slot RO.

FIG. 21 is a drawing which illustrates an example in which a SBFD aware UE transmits PRACH signals in an initial access attempt (with repetitions) in only SBFD slot ROs, and following failure of the initial attempt, transmits PRACH signals in an additional access attempt (without repetitions) in only SBFD slot ROs.

FIG. 22 is a drawing which illustrates an example in which a SBFD aware UE transmits PRACH signals in an initial access attempt (with repetitions) in only SBFD slot ROs, and following failure of the initial attempt, transmits PRACH signals in an additional access attempt (without repetitions) in only non-SBFD slot ROs.

FIG. 23 is a drawing which illustrates an example in which a SBFD aware UE transmits PRACH signals in an initial access attempt (with repetitions) in only SBFD slot ROs, and following failure of the initial attempt, transmits PRACH signals in an additional access attempt (without repetitions) in a mix of a SBFD slot RO and a non-SBFD slot RO.

FIG. 24 is a drawing which illustrates an example, in which a SBFD aware UE transmits PRACH signals in an initial access attempt (with repetitions) in only non-SBFD slot ROs, and following failure of the initial attempt, transmits PRACH signals in an additional access attempt (without repetitions) in only non-SBFD slot ROs.

FIG. 25 is a drawing which illustrates an example in which a SBFD aware UE transmits PRACH signals in an initial access attempt (with repetitions) in only non-SBFD slot ROs, and following failure of the initial attempt, transmits PRACH signals in an additional access attempt (without repetitions) in only SBFD slot ROs.

FIG. 26 is a drawing which illustrates an example in which a SBFD aware UE transmits PRACH signals in an initial access attempt (with repetitions) in only non-SBFD slot ROs, and following failure of the initial attempt, transmits PRACH signals in an additional access attempt (without repetitions) in a mix of a SBFD slot RO and a non-SBFD slot RO.

FIG. 27 is a drawing which illustrates an example in which a SBFD aware UE transmits PRACH signals in an initial access attempt (with repetitions) in a mix of a SBFD slot RO and a non-SBFD slot RO, and following failure of the initial attempt, transmits PRACH signals in an additional access attempt (without repetitions) in only SBFD slot ROs.

FIG. 28 is a drawing which illustrates an example in which a SBFD aware UE transmits PRACH signals in an initial access attempt (with repetitions) in a mix of a SBFD slot RO and a non-SBFD slot RO, and following failure of the initial attempt, transmits PRACH signals in an additional access attempt (without repetitions) in only non-SBFD slot ROs.

FIG. 29 is a drawing which illustrates an example in which a SBFD aware UE transmits PRACH signals in an initial access attempt (with repetitions) in a mix of a SBFD slot RO and a non-SBFD slot RO, and following failure of the initial attempt, transmits PRACH signals in an additional access attempt (without repetitions) in a mix of a SBFD slot RO and a non-SBFD slot RO.

FIG. 30 is a drawing illustrating an exemplary timing frequency structure including downlink slots, SBFD slots, and uplink slots (non-SBFD slots) and, which further illustrates exemplary ROs in SBFD slots and non-SBFD slots, for one particular SSB, in accordance with an exemplary embodiment.

### DETAILED DESCRIPTION

This invention relates to PRACH (physical random access channel) transmission in SBFD (sub-band full-duplex) and non-SBFD symbols/slots.

In some embodiments first, a RACH (random access channel) access attempt is made with a Physical Random Access Channel (PRACH) transmission. In accordance with one aspect of the invention, assuming the UE is an SBFD capable device, after a PRACH attempt fails, a UE (user equipment) is allowed to transmit the next PRACH signal in an SBFD or non-SBFD slot, regardless of whether the previous PRACH transmission occurred in a non-SBFD or SBFD slot. This allows a device to perform a follow up access attempt without having to wait to perform the attempt in the same type of symbol or slot as was used for the initial access attempt. SSB-RO (e.g., SSB-RACH Occasion mapping may or may not be same in non-SBFD symbols and SBFD symbols. Non-SBFD capable UEs will be limited to using non-SBFD symbols/slots for access attempts.

Another feature relates to PRACH repetitions in a mix of non-SBFD and SBFD symbols/slots. Regardless of whether or not SSB-RO mapping is same or different in non-SBFD and SBFD symbols/slots, a UE can, in some embodiments, transmit PRACH repetitions in either non-SBFD and/or SBFD symbols/slots allowing for use of both types of slots for retransmissions. In such a case the UE can choose the next available RO regardless of whether it corresponds to a non-SBFD or SBFD symbol or slot.

In various embodiments frequency hopping for PRACH repetitions is supported in a mix of non-SBFD and SBFD symbols/slots. Frequency hopping can be beneficial in terms of allowing for a low latency and higher probability of preamble detection than if frequency hopping was not supported.

It should be appreciated that frequency hopping as well as other features optional in some cases, and not all features/aspects are required for all embodiments.

Before getting into the details of various embodiments and features of the invention, some terminology will first be explained.

There are normally 14 OFDM symbols per slot in various embodiments.

In an Uplink (UL) slot: all the OFDM symbols in time domain and all the resource blocks (RBs) in frequency domain are allocated for UL direction.

In a Downlink (DL) slot all the OFDM symbols in time domain and all the resource blocks (RBs) in frequency domain are allocated for DL direction.

In an UL symbol: all the RBs are allocated for UL direction and there is only one OFDM symbol in time domain.

In a DL symbol: all the RBs are allocated for DL direction and there is only one OFDM symbol in time domain.

A sub-band full duplex (SBFD) slot is a slot used for downlink (DL), but in the OFDM symbols within the SBFD slot some of the RBs (e.g., 20% of the RBs) are allocated for UL transmission. Thus, an SBFD slot and/or SB symbol can support some uplink transmission but normally far less than an UL slot.

SBFD symbol: This is a symbol that occupies one OFDM symbol, but some of the RBs are allocated for UL transmission with others allocated for DL transmission.

A non-SBFD slot and/or symbol is a slot or symbol where the RBs are allocated for UL or DL transmissions but not both UL and DL in the same slot/symbol.

Before UE transmits/receives data or control signaling from gNB, it should access a channel which is called an initial random access channel (RACH). There are two different RACH methods: 4-step contention-based random access (CBRA) and 2-step CBRA when UE is in idle mode. Also, there is 4-step contention-free random access (CFRA) and 2-step CFRA which is used when UE is in RRC-connected mode.

Various exemplary embodiments discussed herein focus on 4-step CBRA, although the described methods can be applied to the other random access methods as well.

These 4 steps of CBRA in one exemplary embodiment are as follows:

Before step 1, a base station, e.g., gNB, transmits an Synchronization Signal/PBCH block (SSB) burst set. The UE receives one or multiple SSBs. If multiple SSBs are received, the UE selects the SSB with the highest Reference Signal Received Power (RSRP).

Step 1 (MSG1): UE transmits a Physical Random Access Channel (PRACH) signal toward gNB. The signal is a Zadoff-Chu sequence constructed from a preamble. To transmit the PRACH, a UE needs to find a proper RO (RACH Ocassion, e.g., an occasion which can be used to send an access related signal on the PRACH). This is done through SSB-RO mapping obtained from the SSB/PBCH and SIB1 signaling before MSG1 is sent by the UE.

Step 2 (MSG2): gNB detects the PRACH and preamble. Then, the gNB sends a Downlink Control Information (DCI) and Physical Data Shared Channel (PDSCH) information. The Cyclic redundancy check (CRC) in the DCI is scrambled by RA-RNTI which is obtained from RO's time and frequency information. The PDSCH, contains UL grant, TC-RNTI, etc.

Step 3 (MSG3): UE transmits its ID scrambled by TC-RNTI.

Step 4 (MSG4): gNB sends a DCI and PDSCH. The PDSCH verifies that gNB has received the MSG3.

Finally, UE transmit HARTQ-ACK through PUCCH to inform gNB the has received the MSG4.

In legacy SSB-RO mapping approaches, ROs are located only in non-SBFD symbols (only UL symbols/slots). In order to reduce latency and/or PRACH collision, SBFD symbols/slots can, and in various embodiments are, also allocated for PRACH transmission (e.g., ROs). However, the frequency resources (e.g., Resource Blocks (RBs)) and the time duration (i.e., OFDM symbols) in SBFD symbols/slots can be, and in some embodiments are, different from that of the non-SBFD symbols. For instance, the number of RBs in SBFD symbols is usually limited to 50 RBs. However, in a non-SBFD symbol (e.g., an UL symbol), the number of RBs allocated for ROs can be up to 96 RBs. Also, the starting RBs in SBFD and non-SBFD symbols are different. Therefore, a different or similar SSB-RO mapping and PRACH format may be followed in non-SBFD and SBFD symbols/slots.

In various embodiments of the invention a one random access attempt relies on a single PRACH transmission where MSG1 can occur in ROs anchored in either non-SBFD or SBFD symbols/slots regardless of whether the SBFD and non-SBFD symbols/slots use the same or different format(s) for the PRACH signal. In some embodiments restrictions on subsequent access attempts following a failed initial access attempt may or may not be in place depending on the embodiment. In some embodiments following a failed access attempt a UE will pick an RO with the same type of PRACH signal.

Further, PRACH repetitions adopted in some known standards were applied only in non-SBFD symbols/slots in order to improve the probability of preamble detection.

In accordance with one feature of the invention, one random access attempt can use PRACH repetitions that are supported in a mix of non-SBFD and SBFD sequentially valid symbols/slots conditioned on the PRACH signals being the same in said mix of non-SBFD and SBFD sequentially valid symbols/slots. The PRACH signal associated with RO anchored in non-SBFD symbol/slot can and sometimes does have a different format/length as long as both formats use the same preamble (index). It is worth mentioning that the common index will be mapped to the same RAPID (random access preamble index), thereby not confusing the gNB in MSG2 while allowing more repetitions of the respective preamble (e.g., 12+6) and, in turn, an improved detection statistic and detection probability.

Last, one random access attempt can use frequency hopping for PRACH repetitions that are supported in a mix of non-SBFD and SBFD sequentially valid symbols/slots with the PRACH signals being the same in said mix of non-SBFD and SBFD sequentially valid symbols/slots. The benefits of frequency hopping is two-folded: latency reduction in PRACH repetitions and improving detection statistic and detection probability through frequency diversity.

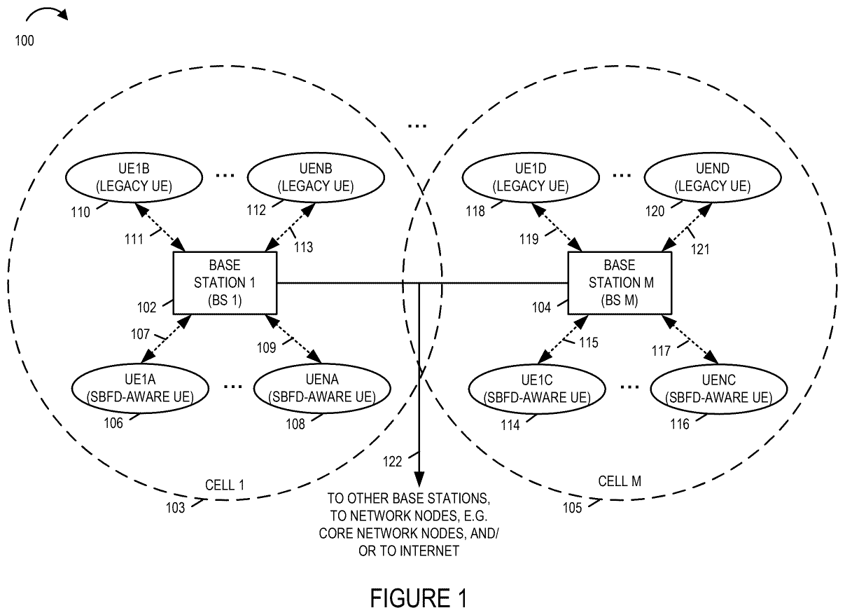

FIG. 1 is a drawing of an exemplary communications system 100 in accordance with an exemplary embodiment. Exemplary communications system 100 includes a plurality of base stations (base station 1 102, . . . , base station M 104) coupled together, to network nodes, e.g., to 5G core network nodes, and/or to the Internet via communications backhaul link(s) 122. Exemplary communications system 100 further includes a plurality of user equipments (UEs) (UE1A 106, . . . , UENA 108, UE1B 110, . . . , UENB 112, UE1C 114, . . . , UENC 116, UE1D 118, . . . , UEND 120). At least some of the UEs are mobile wireless devices which may move throughout system 100 and be connected to different base stations at different time. Some of the UEs are SBFD-aware UEs, while other UEs are legacy UEs. UE1A 106, UENA 108, UE1C 114, and UENC 116 are SBFD-aware UEs. UE1B 110, UENB 112, UE1D 118, and UEND 120 are legacy UEs.

Base station 1 (BS 1) 102 has a corresponding cellular coverage area 103. UEs (106, 108, 110 and 112 are currently located within cellular coverage area 103. UE1A 106 is coupled to BS 1 102 via wireless connection 107. UENA 108 is coupled to BS 1 102 via wireless connection 109. UE1B 110 is coupled to BS 1 102 via wireless connection 111. UENB 112 is coupled to BS 1 102 via wireless connection 113.

Base station M (BS M) 104 has a corresponding cellular coverage area 105. UEs (114, 116, 118 and 120 are currently located within cellular coverage area 105. UE1C 114 is coupled to BS M 104 via wireless connection 115. UENC 116 is coupled to BS M 104 via wireless connection 117. UE1D 118 is coupled to BS M 104 via wireless connection 119. UEND 120 is coupled to BS M 104 via wireless connection 121.

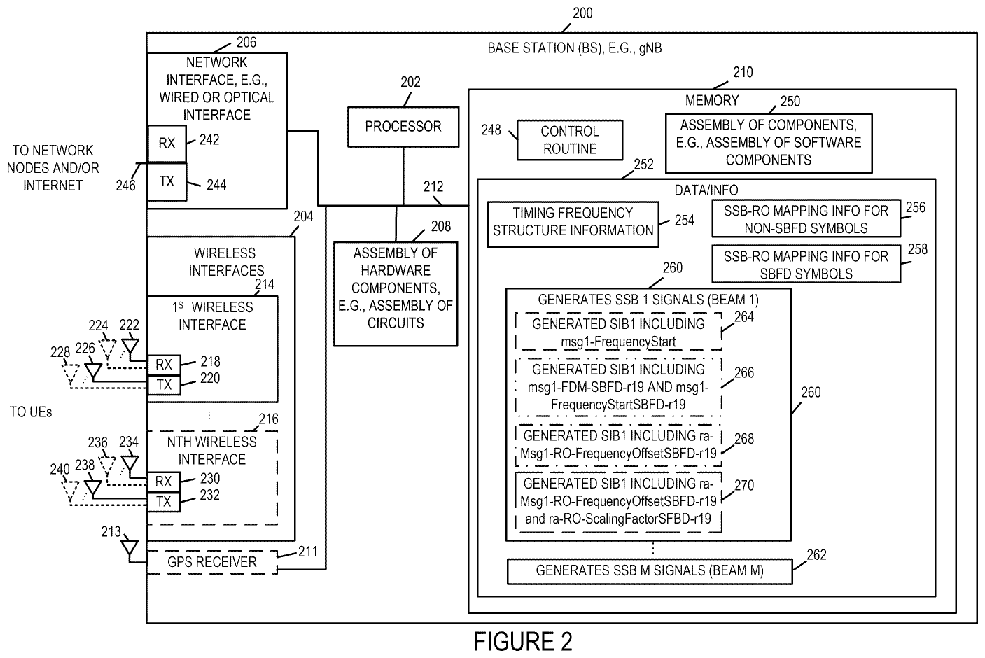

FIG. 2 is a drawing of an exemplary base station 200, e.g., a gNB, in accordance with an exemplary embodiment. Exemplary base station 200 is, e.g., BS 1 102 or BS M 104 of system 100 of FIG. 1. Exemplary base station 200 includes a processor 202, e.g., a CPU, wireless interfaces 204, a network interface 206, an assembly of hardware components 208, e.g., an assembly of circuits, and memory 210 coupled together via bus 212 over which the various elements may interchange data and information. In some embodiments, base station 200 further includes a GPS receiver 211 coupled to bus 212.

Wireless interfaces 204 includes one or more wireless interfaces (1st wireless interface 214, . . . , Nth wireless interface 216). 1st wireless interface 214 includes wireless receiver 218 and wireless transmitter 220. Wireless receiver 218 is coupled to one or more receiver antennas (222, . . . , 224) via which the base station 200 receives wireless uplink signals from UEs. Wireless transmitter 220 is coupled to one or more transmit antennas (226, . . . , 228) via which the base station 200 transmits wireless downlink signals to UEs. In some embodiments one or more antennas are used by both the receiver 218 and transmitter 220. Nth wireless interface 216 includes wireless receiver 230 and wireless transmitter 232. Wireless receiver 230 is coupled to one or more receive antennas (234, . . . , 236) via which the base station 200 receives wireless uplink signals from UEs. Wireless transmitter 232 is coupled to one or more transmit antennas (238, . . . , 40) via which the base station 200 transmits wireless downlink signals to UEs. In some embodiments one or more antennas are used by both the receiver 230 and transmitter 232. In some embodiments different wireless interfaces correspond to different communications bands, different spectrum, and/or different communications protocols.

Network interface 206, e.g., a wired or optical interface, includes receiver 242, transmitter 244 and connector 246. Network interface 206 couples the base station 200 to network nodes, e.g., other base stations, core network nodes, e.g., 5G core network nodes, and/or the Internet.

GPS receiver 211 is coupled to GPS receive antenna 213. GPS signals, received via GPS receive antenna 213, are processed by the GPS receiver 211 to determine time, position, e.g. latitude, longitude and altitude, and velocity information. In some embodiment the GPS receiver 211 is used to facilitate a precise placement of the base station 200, e.g., as part of an installation process.

Memory 210 includes a control routine 248, an assembly of components 250 and data/information 252. Control routine 248 includes instructions which when executed by processor 202 control the base station 200 to implement basic operational functions, e.g., read memory, write to memory, control an interface, load a program, subroutine, or app, etc. Assembly of components 250, e.g., an assembly of software components, e.g., routines, subroutines, applications, etc., includes, e.g., code, e.g., machine executable instructions, which when executed by processor 202, controls the base station 200 to implement steps of a method in accordance with the present invention. Data/information 252 includes timing-frequency structure information 54, said timing-frequency structure, being implemented by base station 200 includes non-SBFD slots, each non-SBFD slot including one or more non-SBFD symbols and SBFD slots, each SBFD slot including one or more SBFD symbols. Data/information 252 includes timing-frequency structure information 254, SSB-RO mapping information for non-SBFD symbols 256, SSB-RO mapping information for SBFD symbols 258 and generated Synchronization Signal Block (SSB) signals for a plurality of beams (generated SSB 1 signals 260 corresponding to beam 1, . . . , generated SSB M signals 262 corresponding to beam M). SSB 1 information 260 includes, in some embodiments, a generated SIB1 including a msg1-FrequencyStart 264. SSB 1 information 260 includes, in some embodiments, a generated SIB1 including a msg1-FDM-SBFD-r19 and a msg1-FrequencyStartSBFD-r19 1166. SSB 1 information 260 includes, in some embodiments, a generated SIB1 including a Msg1-RO-FrequencyOffsetSBFD-r19 268. SSB 1 information 260 includes, in some embodiments, a generated SIB1 including a ra-RO-FrequencyOffset SBFD-r19 and a ra-RO-ScalingFactorSFBD-r19 270.

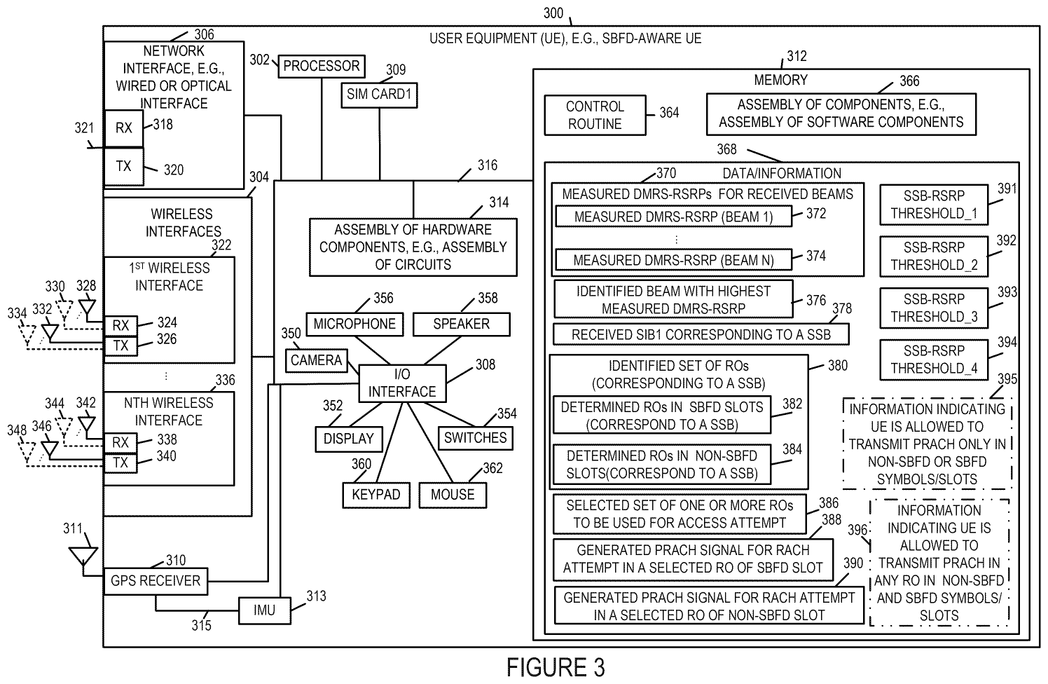

FIG. 3 is a drawing of an exemplary user equipment (UE) 300, e.g., a SBFD-aware UE, in accordance with an exemplary embodiment. Exemplary UE 200 of FIG. 3 is, e.g., any of UEs (106, 108, 114, 116) of system 100 of FIG. 1.

Exemplary UE 300 includes a processor 302, e.g., a CPU, wireless interfaces 304, a network interface 306, e.g., a wired or optical interface, I/O interface 308, GPS receiver 310, inertial measurement unit (IMU) 313, and assembly of hardware components 314, e.g., an assembly of circuits, coupled together via bus 316 over which the various elements may interchange data and information. In various embodiments, UE 300 further includes SIM card 1 309 coupled to bus 316.

Wireless interfaces 304 includes a plurality of wireless interfaces (1st wireless interface 322, . . . , Nth wireless interface 336). 1st wireless interface 322 includes wireless receiver 324 and wireless transmitter 326. Wireless receiver 324 is coupled to one or more receiver antennas (328, . . . , 330) via which the UE 300 receives wireless downlink signals from base stations. Wireless transmitter 326 is coupled to one or more transmit antennas (332, . . . , 34) via which the UE 300 transmits wireless uplink signals to base stations. In some embodiments one or more antennas are used by both the receiver 324 and transmitter 326. Nth wireless interface 336 includes wireless receiver 338 and wireless transmitter 340. Wireless receiver 338 is coupled to one or more receive antennas (342, . . . , 344) via which the UE 300 receives wireless downlink signals from base stations. Wireless transmitter 340 is coupled to one or more transmit antennas (346, . . . , 348) via which the UE 300 transmits wireless uplink signals to base stations. In some embodiments one or more antennas are used by both the receiver 338 and transmitter 340. In some embodiments different wireless interfaces correspond to different communications bands, different spectrum, and/or different communications protocols.

Network interface 306, e.g., a wired or optical interface, includes receiver 318, transmitter 320 and connector 321. Network interface 306 may, and sometimes does, couple UE 300 to base stations, network nodes and/or the Internet, e.g., when the UE 1200 is stationary and located at a site with a wireline and/or optical connection.

GPS receiver 310 is coupled to GPS antenna 311. GPS receiver 310 is further coupled to IMU 313, e.g., an IMU on a chip including gyroscopes and accelerometers. GPS signals, received via GPS receive antenna 311, are processed by the GPS receiver 310 to determine time, position, e.g. latitude, longitude and altitude, and velocity information of UE 300. In some embodiments, information from IMU 313, e.g., accelerometer and/or gyroscopes measurements over time, are used, in conjunction with or in place of GPS measurements to determine position, e.g. latitude, longitude and altitude, and velocity information of UE 300. SIM card 1 309 includes information corresponding to a first communications network operator to which the owner of UE 300 is a subscriber.

UE 300 further includes a plurality of I/O devices (camera 350, display 352, e.g., a touch screen display, switches 354, microphone 356, speaker 358, keypad 360 and mouse 62) coupled to I/O interface 08, which couples the various I/O devices to other elements of the UE 300 via bus 316.

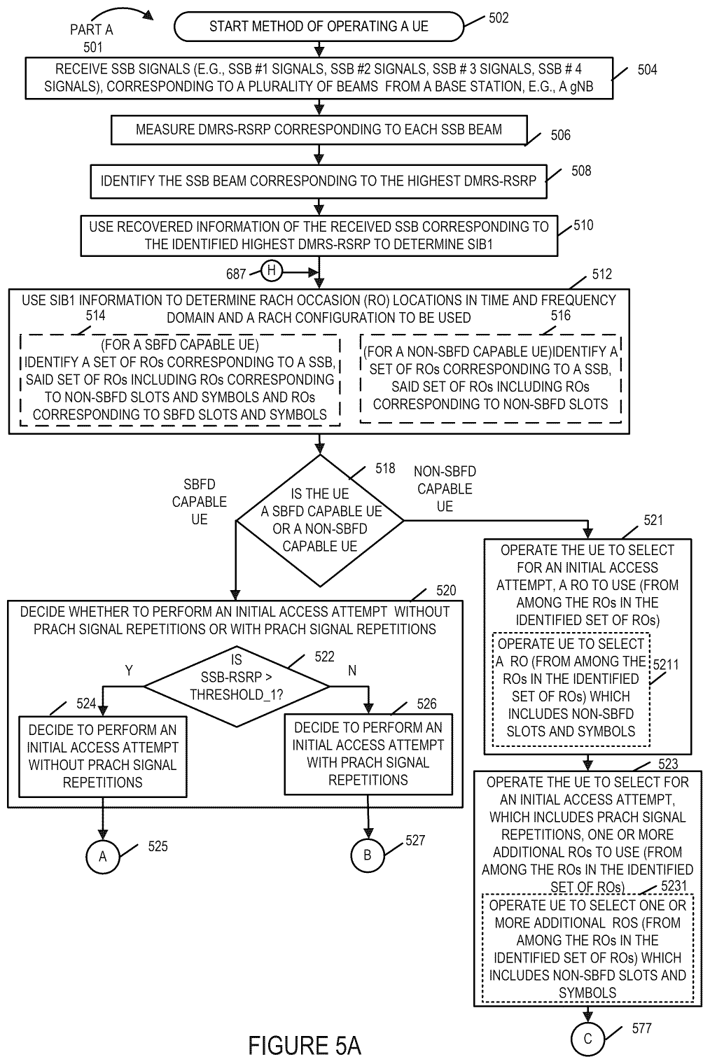

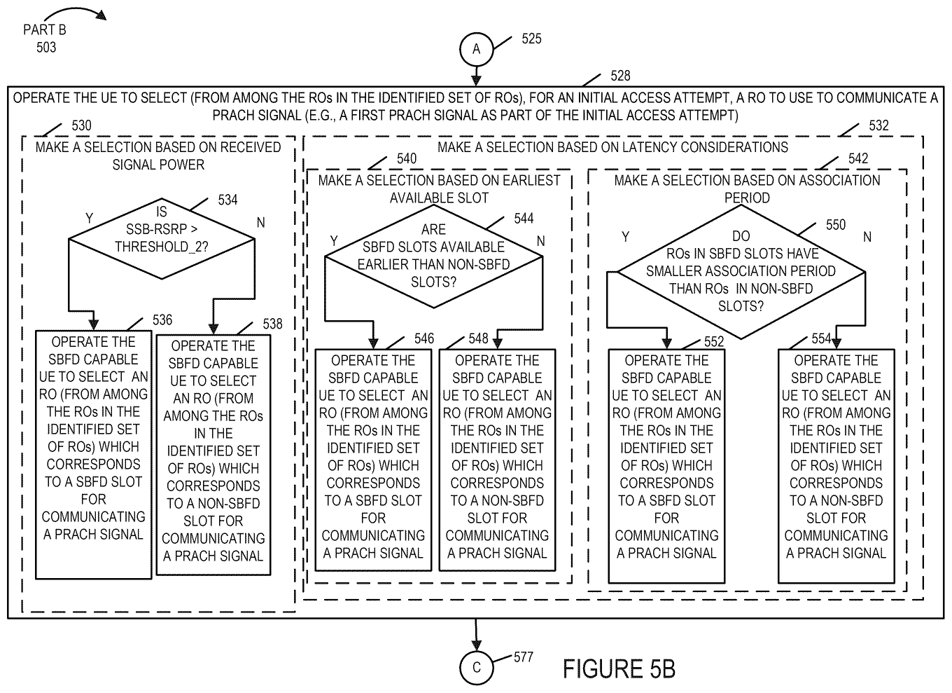

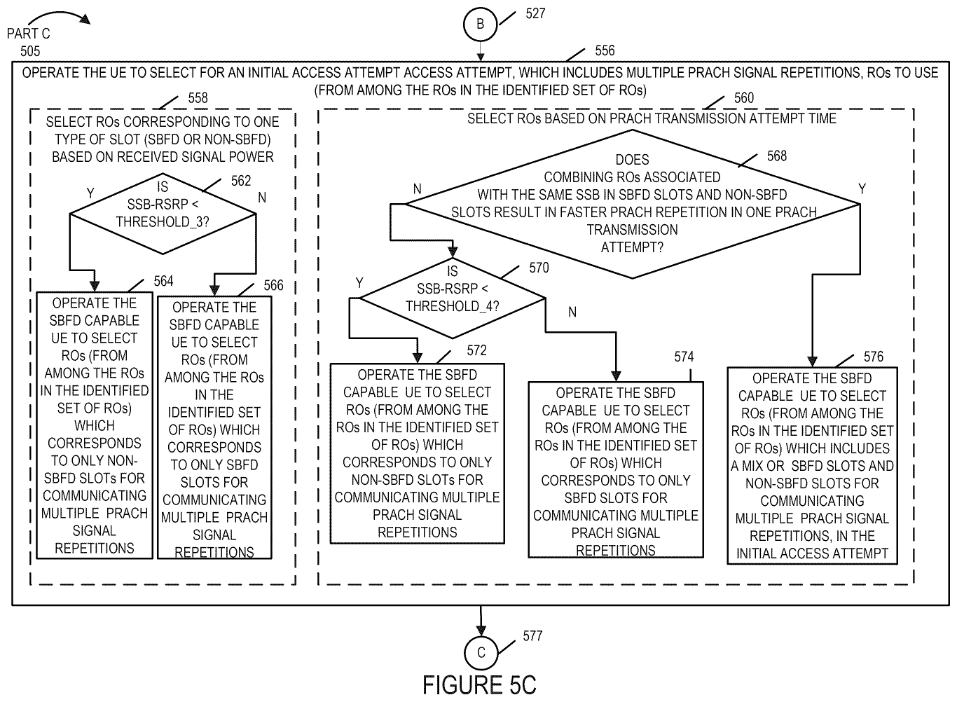

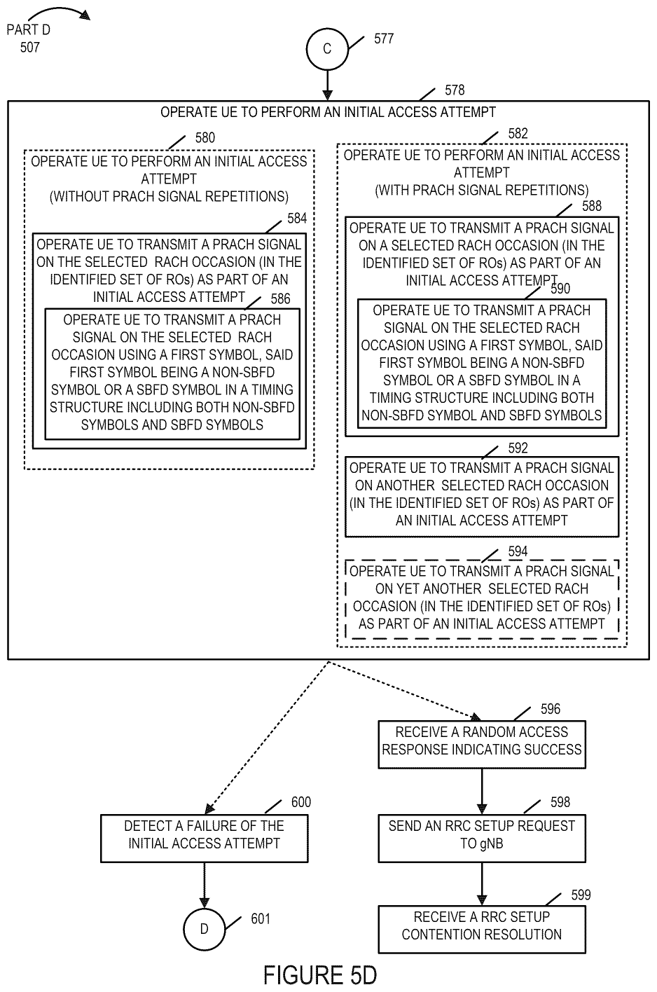

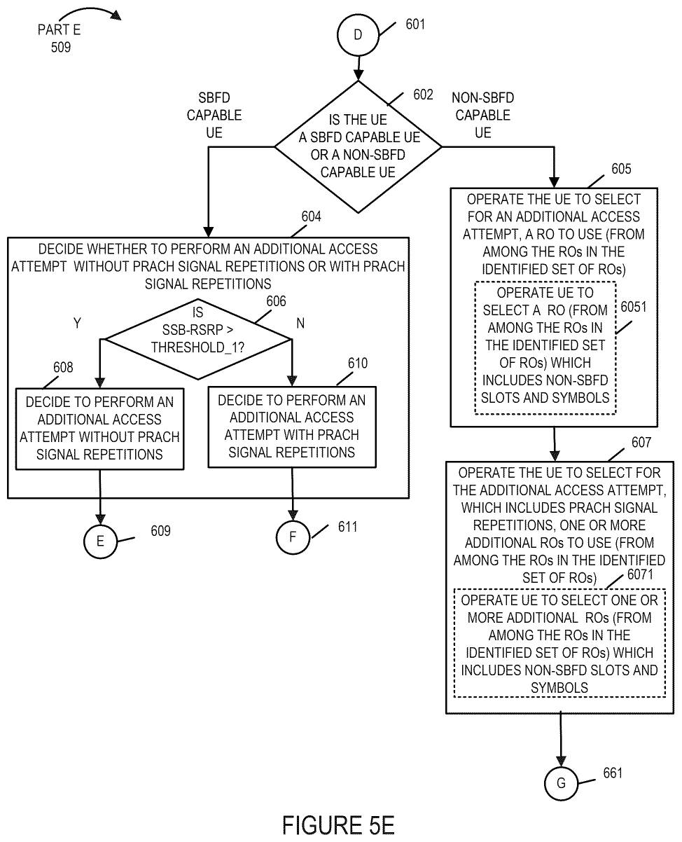

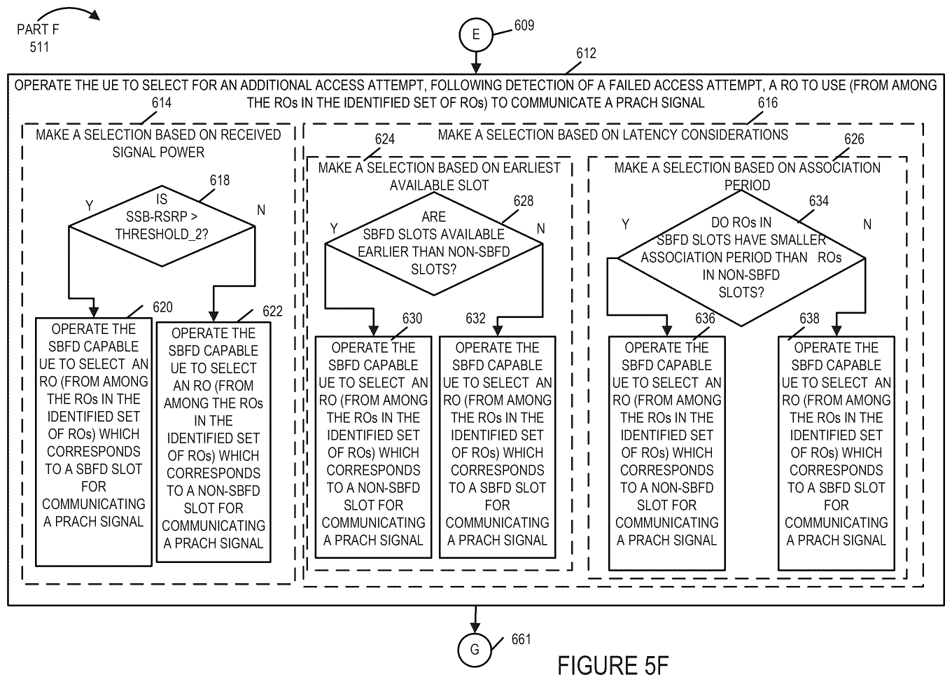

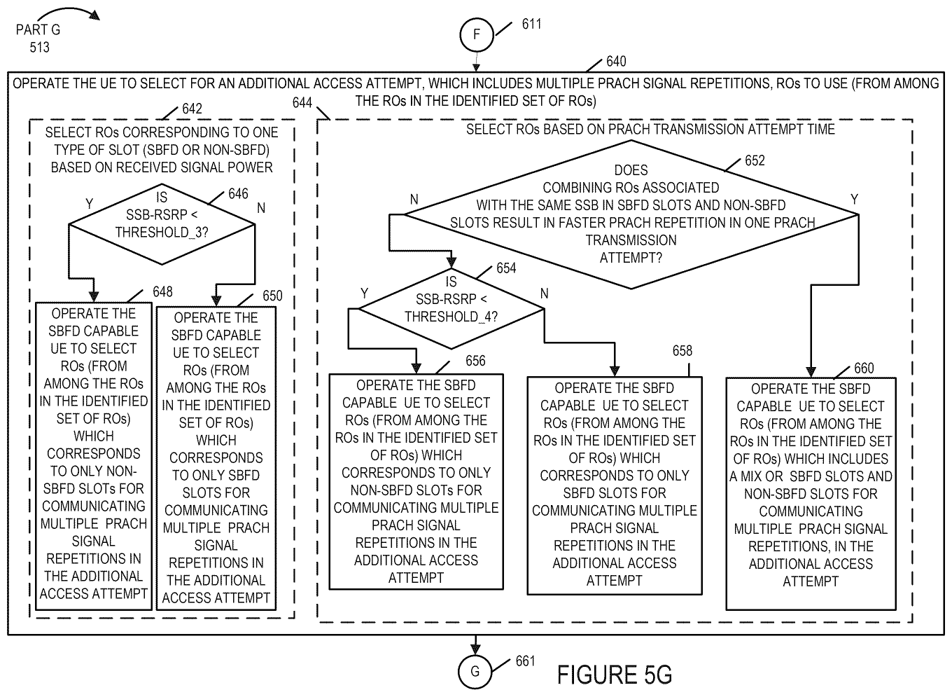

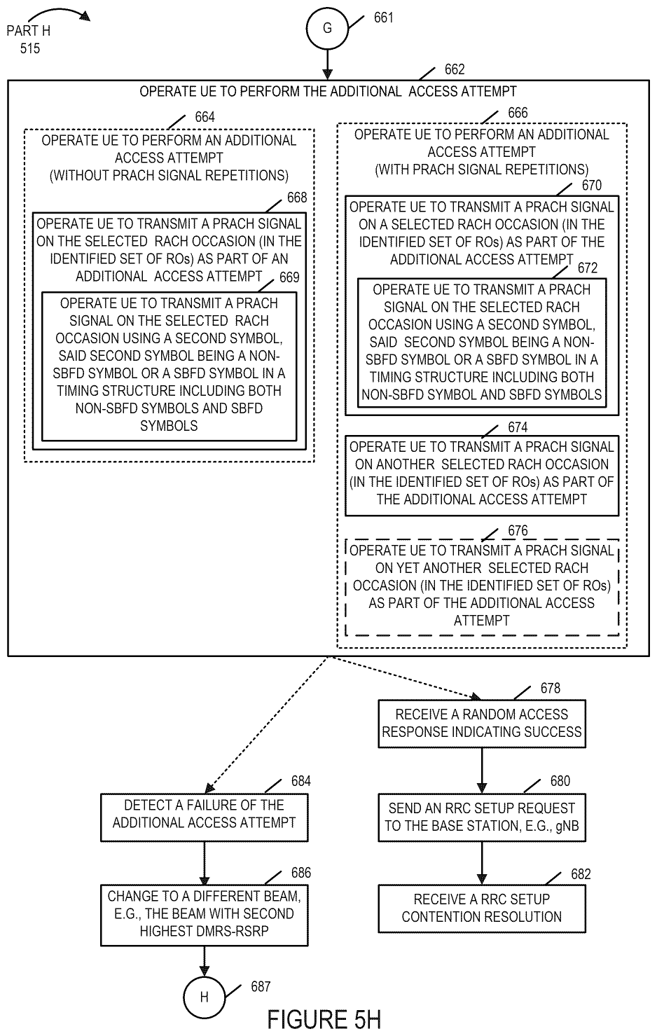

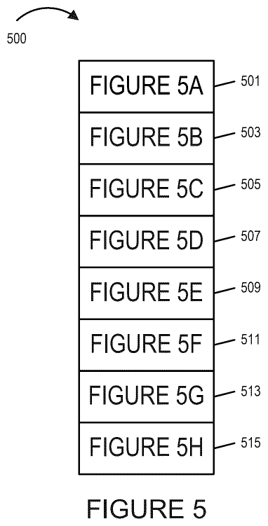

Memory 312 includes a control routine 364, an assembly of components 366, e.g., an assembly of software components, and data/information 1268. Control routine 364 includes instructions which when executed by processor 302 control the UE 300 to implement basic operational functions, e.g., read memory, write to memory, control an interface, load a program, subroutine, or app, etc. Assembly of components 366, e.g., an assembly of software components, e.g., routines, subroutines, applications, etc., includes, e.g., code, e.g., machine executable instructions, which when executed by processor 302, controls the UE 300 to implement steps of a method in accordance with an exemplary embodiment of the present invention, e.g., steps of the method of flowchart 500 of FIG. 5, which are implemented by a SBFD capable UE, sometimes otherwise referred to as a SBFD-aware UE. Data/information 368 includes measured DMRS-RSPSs for received beams 370 (measured DMRS-RSRP for beam 1 372, . . . , measured DMRS-RSRP for beam M 374), an identified beam with the highest measured DMRS-RSRP 376, a received SIB1 corresponding to a SSB 378, e.g., a received SIB1 378 corresponding to the beam identified to be the beam with the highest measured DMRS-RSPP, and information 380 identifying a set of ROs corresponding to a SSB, e.g., the SSB corresponding to the SSB beam with the highest measured DMRS-RSRP. Information 380 including information 382 identifying determined ROs in SBFD slots corresponding to the SSB, which may be used by the UE 300 and information 384 identifying determined ROs in non-SBFD slots corresponding to the SSB, which may be used by the UE 300., Data/information 368 further includes a selected set 386 of one or more ROs to be used for an access attempt, e.g., an initial access attempt or an additional access attempt. Data/information 368 further includes a generated PRACH signal 388 for a RACH attempt in RACH occasion (RO) of SBFD slot, and generated PRACH signal 390 for a RACH attempt in RACH occasion (RO) of a non-SBFD slot. In some embodiments, data/information 368 includes information 395 indicating that the UE is allowed to transmit PRACH only in non-SBFD or SBFD symbols/slots, e.g., if the first PRACH attempt fails, the UE is to transmit the second PRACH attempt on the same type of symbol/slot (non-SBFD or SBFD) as was used for the first PRACH attempt. In some embodiments, data/information 368 includes information 396 indicating that the UE is allowed to transmit PRACH in any RO in non-SBFD and SBFD symbols/slots, e.g., if the first PRACH attempt fails, the UE is to transmit the second PRACH attempt on the same or different type of symbol/slot (non-SBFD or SBFD) as was used for the first PRACH attempt. Data/information 368 further includes SSB-RSRP threshold_1 391, SSB-RSRP threshold_2 392, SSB-RSRP threshold_3 393, and SSB-RSRP threshold_4 394. In some embodiments, the SSB-RSRP threshold 1 391 is used in determining as to whether the UE is to perform an initial access attempt without PRACH signal repetitions or with PRACH signal repetitions. In some embodiments, the SSB-RSRP threshold 1 391 is used in determining as to whether the UE is to perform an additional access attempt, e.g., following a failure of the initial access attempt, without PRACH signal repetitions or with PRACH signal repetitions. In some embodiments, the SSB-RSRP threshold 2 392 is used in selecting, based on received signals power, the type of RO, e.g., SBFD slot RO or non-SBFD slot RO, for an access attempt without repetitions. In some embodiments, the SSB-RSRP threshold 3 393 is used in selecting, based on received signal power, the type of ROs, e.g., SBFD slot ROs or non-SBFD slot ROs, to use for an access attempt with repetitions. In some embodiments, the SSB-RSRP threshold 4 394 is used in selecting, based on latency considerations and received signal power, the type of ROs, e.g., SBFD slot ROs or non-SBFD slot ROs, to use for an access attempt with repetitions.

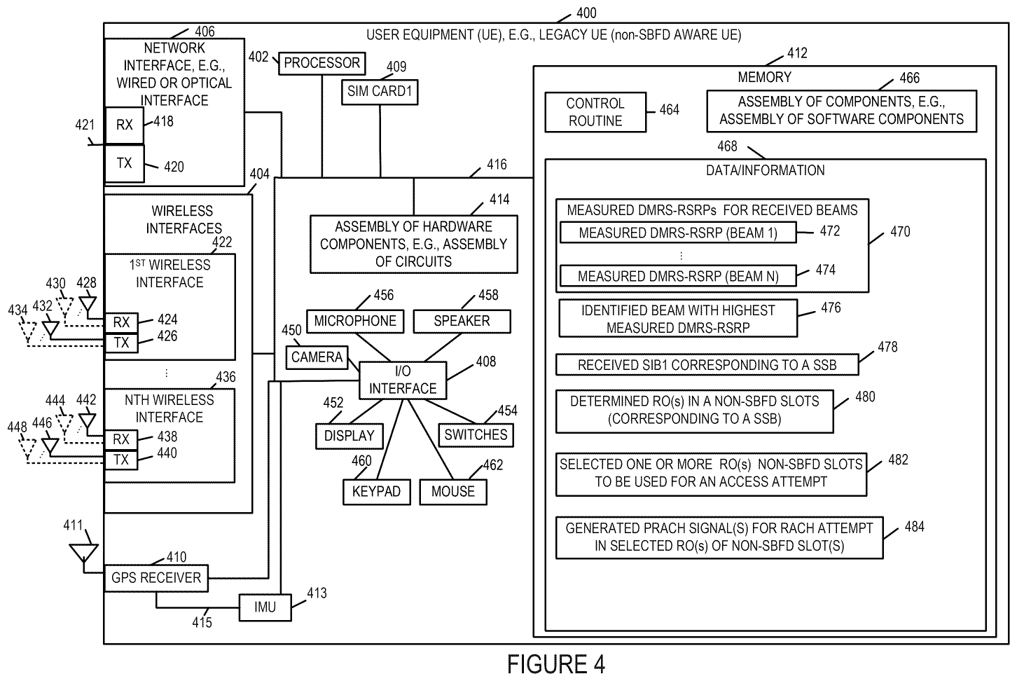

FIG. 4 is a drawing of an exemplary user equipment (UE) 400, e.g., a legacy UE, sometimes referred to as a non-SBFD aware UE or a non-SBFD capable UE, in accordance with an exemplary embodiment. Exemplary UE 400 of FIG. 4 is, e.g., any of UEs (110, 112, 118, 120) of system 100 of FIG. 1.

Exemplary UE 400 includes a processor 402, e.g., a CPU, wireless interfaces 404, a network interface 406, e.g., a wired or optical interface, I/O interface 408, GPS receiver 410, inertial measurement unit (IMU) 413, and assembly of hardware components 414, e.g., an assembly of circuits, coupled together via bus 416 over which the various elements may interchange data and information. In various embodiments, UE 400 further includes SIM card 1 409 coupled to bus 416.

Wireless interfaces 404 includes a plurality of wireless interfaces (1st wireless interface 422, . . . , Nth wireless interface 436). 1st wireless interface 422 includes wireless receiver 424 and wireless transmitter 426. Wireless receiver 424 is coupled to one or more receiver antennas (428, . . . , 430) via which the UE 400 receives wireless downlink signals from base stations. Wireless transmitter 426 is coupled to one or more transmit antennas (432, . . . , 434) via which the UE 400 transmits wireless uplink signals to base stations. In some embodiments one or more antennas are used by both the receiver 424 and transmitter 426. Nth wireless interface 436 includes wireless receiver 438 and wireless transmitter 440. Wireless receiver 438 is coupled to one or more receive antennas (442, . . . , 444) via which the UE 400 receives wireless downlink signals from base stations. Wireless transmitter 440 is coupled to one or more transmit antennas (446, . . . , 448) via which the UE 400 transmits wireless uplink signals to base stations. In some embodiments one or more antennas are used by both the receiver 438 and transmitter 440. In some embodiments different wireless interfaces correspond to different communications bands, different spectrum, and/or different communications protocols.

Network interface 406, e.g., a wired or optical interface, includes receiver 418, transmitter 420 and connector 421. Network interface 406 may, and sometimes does, couple UE 400 to base stations, network nodes and/or the Internet, e.g., when the UE 400 is stationary and located at a site with a wireline and/or optical connection.

GPS receiver 410 is coupled to GPS antenna 411. GPS receiver 410 is further coupled to IMU 413, e.g., an IMU on a chip including gyroscopes and accelerometers. GPS signals, received via GPS receive antenna 411, are processed by the GPS receiver 410 to determine time, position, e.g. latitude, longitude and altitude, and velocity information of UE 400. In some embodiments, information from IMU 413, e.g., accelerometer and/or gyroscopes measurements over time, are used, in conjunction with or in place of GPS measurements to determine position, e.g. latitude, longitude and altitude, and velocity information of UE 400. SIM card 1 409 includes information corresponding to a first communications network operator to which the owner of UE 400 is a subscriber.

UE 400 further includes a plurality of I/O devices (camera 450, display 452, e.g., a touch screen display, switches 454, microphone 456, speaker 458, keypad 460 and mouse 462) coupled to I/O interface 408, which couples the various I/O devices to other elements of the UE 400 via bus 416.

Memory 412 includes a control routine 464, an assembly of components 466, e.g., an assembly of software components, and data/information 468. Control routine 464 includes instructions which when executed by processor 402 control the UE 400 to implement basic operational functions, e.g., read memory, write to memory, control an interface, load a program, subroutine, or app, etc. Assembly of components 466, e.g., an assembly of software components, e.g., routines, subroutines, applications, etc., includes, e.g., code, e.g., machine executable instructions, which when executed by processor 402, controls the UE 400 to implement steps of a method, e.g. steps of the method of flowchart 500 of FIG. 5 which are performed by a non-SBFD capable UE, sometimes referred to as a non-SBFD aware UE or a legacy UE, in accordance with an exemplary embodiment of the present invention.

Data/information 468 includes measured DMRS-RSPSs for received beams 470 (measured DMRS-RSRP for beam 1 472, . . . , measured DMRS-RSRP for beam M 474), an identified beam with the highest measured DMRS-RSRP 476, a received SIB1 478 corresponding to a SSB, e.g., a received SIB1 478 corresponding to the beam identified to be the beam with the highest measured DMRS-RSPP. Data/information 468 further includes a received SIB1 corresponding to a SSB 478, e.g., the SSB corresponding to the identified SSB beam with the highest measured DMRS-RSRP, determined ROs in non-SBFD slots 480, which may be used by UE 400, information 482 identifying one or more selected ROs in non-SBFD slots to be used for an access attempt, and generated PRACH signal(s) 484 for a RACH attempt in RACH occasion (RO(s)) of a non-SBFD slot.

FIG. 5, comprising the combination of FIG. 5A, FIG. 5B, FIG. 5C, FIG. 5D, FIG. 5E, FIG. 5F, FIG. 5G and FIG. 5H, is a flowchart 500, comprising the combination of Part A 501, Part B 503, Part C 505, Part E 507, Part F 511, Part G 513, and Part H 515, of an exemplary method of operating a UE in accordance with an exemplary embodiment. Operation starts in step 502, in which the UE is powered on and initialized and proceeds to step 504. In step 504 the UE receives Synchronization Signal Block (SSB) signals (e.g., SSB #1 signals, SSB #2 signal, SSB #3 signal, SSB #4 signals) corresponding to a plurality of beams from a base station, e.g. a gNB. Operation proceeds from step 504 to step 506.

In step 506 the UE measures the DMRS-RSRP corresponding to each SSB beam. Operation proceeds from step 506 to step 508. In step 508 the UE identifies the SSB beam corresponding to the highest DMRS-RSRP. Operation proceeds from step 510 to step 512.

In step 512 the UE uses SIB1 information to determine RACH occasion (RO) locations in the time and frequency domain and a RACH configuration to be used. If the UE is a SBFD capable UE, then the UE performs step 514 as part of step 512. In step 514 the UE identifies a set of ROs corresponding to a SSB, e.g., the SSB corresponding to the identified SSB beam of step 508, said set of ROs including ROs corresponding to non-SBFD slots and symbols and ROs corresponding to SBFD slots and symbols. Alternativey, If the UE is a non-SBFD capable UE, then the UE performs step 516 as part of step 512. In step 516 the UE identifies a set of ROs corresponding to a SSB, e.g., the SSB corresponding to the identified SSB beam of step 508, said set of ROs including ROs corresponding to non-SBFD slots and symbols. Operation proceeds from step 512 to step 518.

In step 518, if the UE is a SBFD capable UE, then operation proceeds from step 518 to step 520. Alternatively, in step 518, if the UE is a non-SBFD capable UE, then operation proceeds from step 518 to step 521.

Returning to step 520, in step 520, the UE decides whether to perform an initial access attempt without PRACH signal repetitions or with PRACH signal repetitions. Step 520 includes steps 522, 524 and 526. In step 522 the UE compares the SSB-RSRP of the identified beam with the highest DMRS-RSRP to threshold_1. If the SSB-RSRP is greater than threshold_1, then operation proceeds from step 522 to step 524, in which the UE decides to perform an initial access attempt without PRACH signal repetitions. However, if the SSB-RSRP is not greater than threshold_1, then operation proceeds from step 522 to step 526, in which the UE decides to perform an initial access attempt with PRACH signal repetitions. Thus, when the received RSRP is strong, e.g., above SSB-RSRP threshold_1, the UE decides to perform an initial access attempt with a single PRACH signal, since the single PRACH signal is likely to get through to the base station; otherwise, the UE decides, under less ideal conditions, to perform an initial access attempt with repetitions, since it is suspected that the probability of success of a single PRACH signal is not sufficiently high enough under current channel conditions.

Operation proceeds from step 524, via connecting node A 525 to step 528 of FIG. 5B. In step 528 the UE is operated to select (from the identified set of ROs of step 514), for an initial access attempt, a RO to use to communicate a PRACH signal (e.g., a first PRACH signal as part of the initial access attempt). In some embodiments, step 528 includes step 520 in which the UE makes a selection based on received signal power. In some other embodiments, step 528 includes step 532, in which the UE makes a selection based on latency considerations.

Step 530 includes step 534, step 536 and step 538. In step 534, the UE compares the SSB-RSRP to threshold_2 and determines whether or not the SSB-RSRP is greater than threshold_2. If the determination of step 534 is that the SSB-RSRP is greater than threshold_2, then operation proceeds from step 534 to step 536 in which the SBFD capable UE is operated to select a RO (from among the ROs in the identified set of ROs of step 514) which corresponds to a SBFD slot for communicating a PRACH signal. However, if the determination of step 534 is that the SSB-RSRP is not greater than threshold_2, then operation proceeds from step 534 to step 538 in which the SBFD capable UE is operated to select a RO (from among the RO in the identified set of ROs of step 514) which corresponds to a non-SBFD slot for communicating a PRACH signal.

Retuning to step 532, step 532 includes, in some embodiments, step 540, while in other embodiments, step 532 includes step 542. In step 540 the UE makes a selection based on the earliest available slot. In step 542 the UE makes a selection based on association time periods.

Step 540 includes steps 544, 46 and 548. In step 544 the UE determines if SBFD slots are available earlier than non-SBFD slots. If the determination of step 544 is that SBFD slots are available earlier than non-SBFD slots, then operation proceeds from step 544 to step 546, in which the SBFD capable UE is operated to select a RO (from among the ROs in the identified set of ROs of step 514) which corresponds to a SBFD slot for communicating a PRACH signal. However, if the determination of step 544 is that SBFD slots are not available earlier than non-SBFD slots, then operation proceeds from step 544 to step 548 in which the SBFD capable UE is operated to select a RO (from among the RO in the identified set of ROs of step 514) which corresponds to a non-SBFD slot for communicating a PRACH signal. Thus, in step 540 the UE selects the earliest available RO for conveying the PRACH signal irrespective of whether the RO corresponds to a SBFD slot or a non-SBFD slot.

Step 542 includes steps 550, 552 and 554. In step 550 the UE determines if ROs in SBFD slots have a smaller association time period than ROs in non-SBFD slots. If the determination of step 550 is that ROs in SBFD slots have a smaller association time period than ROs in non-SBFD slots, then operation proceeds from step 550 to step 554, in which the SBFD capable UE is operated to select a RO (from among the ROs in the identified set of ROs of step 514) which corresponds to a SBFD slot for communicating a PRACH signal. However, if the determination of step 550 is that ROs in SBFD slots do not have a smaller association time period than ROs in non-SBFD slots, then operation proceeds from step 550 to step 554 in which the SBFD capable UE is operated to select a RO (from among the ROs in the identified set of ROs of step 514) which corresponds to a non-SBFD slot for communicating a PRACH signal. Operation proceeds from step 528, via connecting node C 577 to step 578 of FIG. 5D.

Returning to step 526 of FIG. 5A, operation proceeds from step 526, via connecting node B 527 to step 556 of FIG. 5C. In step 556 the UE is operated to select (from the identified set of ROs of step 514), for an initial access attempt which includes multiple PRACH signal repetitions, ROs to use to communicate PRACH signals, as part of the initial access attempt including repetitions. In some embodiments, step 556 includes step 558 in which the UE selects ROs corresponding to one type of slot (SBFD or non-SBFD) based on received signal power. In some other embodiments, step 556 includes step 560, in which the UE selects ROs based on PRACH transmission attempt time.

Step 558 includes step 562, step 564 and step 566. In step 562, the UE compares the SSB-RSRP to threshold_3 and determines whether or not the SSB-RSRP is less than threshold_3. If the determination of step 562 is that the SSB-RSRP is less than threshold_3, then operation proceeds from step 562 to step 564 in which the SBFD capable UE is operated to select ROs (from among the ROs in the identified set of ROs of step 514) which corresponds to only non-SBFD slots for communicating multiple PRACH signal repetitions. However, if the determination of step 562 is that the SSB-RSRP is not less than threshold_3, then operation proceeds from step 562 to step 566 in which the SBFD capable UE is operated to select ROs (from among the ROs in the identified set of ROs of step 514) which corresponds to only SBFD slots for communicating multiple PRACH signal repetitions.

Returning to step 560, step 560 includes steps 568, 570, 572, 574 and 576. In step 568 the UE determines if combining ROs, associated with the same SSB of interest, in SBFD slots and non-SBFD slots results in faster PRACH repetition in a PRACH transmission attempt, than an approach of only using one type of slot. If the determination of step 568 is that combining ROs, associated with the same SSB of interest, in SBFD slots and non-SBSD slots will result in a faster PRACH repetition, then operation proceeds from step 568 to step 576, in which the SBFD capable UE is operated to select ROs (from among the ROs in the identified set of ROs of step 514) which includes a mix of SBFD slots and non-SBFD slots for communicating multiple PRACH signal repetitions in the initial access attempt. However, if the determination of step 568 is that combining ROs, associated with the same SSB of interest, in SBFD slots and non-SBSD slots will not result in a faster PRACH repetition, then operation proceeds from step 568 to step 570.

In step 570, the UE compares the SSB-RSRP to threshold_4 and determines whether or not the SSB-RSRP is less than threshold_4. If the determination of step 570 is that the SSB-RSRP is less than threshold_4, then operation proceeds from step 570 to step 572 in which the SBFD capable UE is operated to select ROs (from among the ROs in the identified set of ROs of step 514) which corresponds to only non-SBFD slots for communicating multiple PRACH signal repetitions. However, if the determination of step 570 is that the SSB-RSRP is not less than threshold_4, then operation proceeds from step 570 to step 574 in which the SBFD capable UE is operated to select ROs (from among the ROs in the identified set of ROs of step 514) which corresponds to only SBFD slots for communicating multiple PRACH signal repetitions. Operation proceeds from step 576, via connecting node C 577 to step 578 of FIG. 5D.

Returning to step 521 of FIG. 5A, in step 521 the UE, which is a non-SBFD capable UE, is operated to select for an initial access attempt, a RO to use from among the ROs in the identified set of ROs of step 516. Step 521 includes step 5211, in which the UE is operated to select a RO, from among the identified set of ROs of step 516, which includes non-SBFD slots and symbols. Operation proceeds from step 521 to step 523. In step 523, the UE selects, for an initial access attempt which includes PRACH signal repetitions, one or more additional ROs to use from among the ROs in the identified set of ROs of step 516. Step 523 includes step 5231 in which the UE is operated to select one or more additional ROs from among the ROs in the identified set of ROs of step 516, which includes non-SBFD symbols and slots.

Step 523 is bypassed for an embodiment, in which the non-SBFD capable UE has decided to perform an initial access attempt without repetitions. Operation proceeds from step 523, via connecting node C 577 to step 578 of FIG. 5D.

In step 578 the UE is operated to perform an initial access attempt. Step 578 includes step 580 and 582. If it has been decided that the initial access attempt is without PRACH signal repetitions, then step 580 is performed in which the UE is operated to perform an initial access attempt without PRACH signal repetitions. Step 580 includes step 584 in which the UE is operated to transmit a PRACH signal on the selected RACH occasion (RO) as part of an initial access attempt. The selected RO is obtained from one of steps 536, 538, 546, 548, 552, 554, or 521. Step 584 includes step 586, in which the UE is operated to transmit a PRACH signal on the selected RO using a first symbol, said first symbol being a non-SBFD symbol or a SBFD symbol in a timing structure including both non-SBFD symbols and SBFD symbols.

Alternatively, if it has been decided that the initial access attempt is with PRACH signal repetitions, then step 582 is performed in which the UE is operated to perform an initial access attempt with PRACH signal repetitions. Step 582 includes step 588, step 592, and in some embodiments, step 594. In step 588 the UE is operated to transmit a PRACH signal on a selected RACH occasion (RO) as part of an initial access attempt. The selected RO is obtained from one of steps 564, 566, 572, 574, 576, or 521. Step 588 includes step 590, in which the UE is operated to transmit a PRACH signal on a selected RO using a first symbol, said first symbol being a non-SBFD symbol or a SBFD symbol in a timing structure including both non-SBFD symbols and SBFD symbols. Operation proceeds from step 590 to step 592, in which the UE is operated to transmit a PRACH signal on another selected RACH occasion as part of the initial access attempt. The selected RO is obtained from one of steps 564, 566, 572, 574, 576, or 523. In some embodiments, operation proceeds from step 592 to step 594. In other embodiments, step 594 is bypassed. In step 594 the UE is operated to transmit a PRACH signal on yet another selected RACH occasion as part of the initial access attempt. The selected RO is obtained from one of steps 564, 566, 572, 574, 576, or 523.

Operation proceeds from step 570 to one of step 596 or step 600. In step 596 the UE receives a random access response, e.g., from the base station, e.g. the gNB, indicating success of the initial access attempt. Operation proceeds from step 596 to step 598, in which the UE sends a RRC setup request to base station, e.g. gNB. Operation proceeds from step 598 to step 599, in which the UE receives a RRC setup contention resolution message from the base station, e.g. gNB.

Alternatively, in step 600 the UE detects failure of the initial access attempt. Operation proceeds from step 600, via connecting node D 601, to step 602 of FIG. 5E.

In step 602, if the UE is a SBFD capable UE, then operation proceeds from step 602 to step 604. Alternatively, in step 602, if the UE is a non-SBFD capable UE, then operation proceeds from step 602 to step 605.

Returning to step 604, in step 604, the UE decides whether to perform an additional access attempt without PRACH signal repetitions or with PRACH signal repetitions. Step 604 includes steps 606, 608 and 610. In step 606 the UE compares the SSB-RSRP of the identified beam with the highest DMRS-RSRP to threshold_1. If the SSB-RSRP is greater than threshold_1, then operation proceeds from step 606 to step 608, in which the UE decides to perform an additional access attempt without PRACH signal repetitions. However, if the SSB-RSRP is not greater than threshold_1, then operation proceeds from step 606 to step 610, in which the UE decides to perform an additional access attempt with PRACH signal repetitions. Thus, when the received RSRP is strong, e.g., above SSB-RSRP threshold_1, the UE decides to perform an additional access attempt with a single PRACH signal, since the single PRACH signal is likely to get through to the base station; otherwise, the UE decides, under less ideal conditions, to perform an additional access attempt with repetitions, since it is suspected that the probability of success of a single PRACH signal is not sufficiently high enough under current channel conditions.

Operation proceeds from step 608, via connecting node E 609 to step 612 of FIG. 5F. In step 612 the UE is operated to select (from the identified set of ROs of step 514), for an additional attempt, following detection of a failed access attempt, a RO to use to communicate a PRACH signal (e.g., a first PRACH signal as part of the additional access attempt). In some embodiments, step 612 includes step 614 in which the UE makes a selection based on received signal power. In some other embodiments, step 612 includes step 616, in which the UE makes a selection based on latency considerations.

Step 614 includes step 618, step 620 and step 622. In step 618, the UE compares the SSB-RSRP to threshold_2 and determines whether or not the SSB-RSRP is greater than threshold_2. If the determination of step 618 is that the SSB-RSRP is greater than threshold_2, then operation proceeds from step 618 to step 620 in which the SBFD capable UE is operated to select a RO (from among the ROs in the identified set of ROs of step 514) which corresponds to a SBFD slot for communicating a PRACH signal. However, if the determination of step 618 is that the SSB-RSRP is not greater than threshold_2, then operation proceeds from step 618 to step 622 in which the SBFD capable UE is operated to select a RO (from among the RO in the identified set of ROs of step 514) which corresponds to a non-SBFD slot for communicating a PRACH signal.

Retuning to step 616, step 616 includes, in some embodiments, step 624, while in other embodiments, step 616 includes step 626. In step 624 the UE makes a selection based on the earliest available slot. In step 626 the UE makes a selection based on association time periods.

Step 624 includes steps 628, 630 and 632. In step 628 the UE determines if SBFD slots are available earlier than non-SBFD slots. If the determination of step 628 is that SBFD slots are available earlier than non-SBFD slots, then operation proceeds from step 628 to step 630, in which the SBFD capable UE is operated to select a RO (from among the ROs in the identified set of ROs of step 514) which corresponds to a non-SBFD slot for communicating a PRACH signal. However, if the determination of step 628 is that SBFD slots are not available earlier than non-SBFD slots, then operation proceeds from step 628 to step 632 in which the SBFD capable UE is operated to select a RO (from among the RO in the identified set of ROs of step 514) which corresponds to a SBFD slot for communicating a PRACH signal.

Step 626 includes steps 634, 636 and 638. In step 634 the UE determines if ROs in SBFD slots have a smaller association time period than ROs in non-SBFD slots. If the determination of step 634 is that ROs in SBFD slots have a smaller association time period than ROs in non-SBFD slots, then operation proceeds from step 634 to step 636, in which the SBFD capable UE is operated to select a RO (from among the ROs in the identified set of ROs of step 514) which corresponds to a non-SBFD slot for communicating a PRACH signal. However, if the determination of step 634 is that ROs in SBFD slots do not have a smaller association time period than ROs in non-SBFD slots, then operation proceeds from step 634 to step 638 in which the SBFD capable UE is operated to select a RO (from among the ROs in the identified set of ROs of step 514) which corresponds to a SBFD slot for communicating a PRACH signal. Operation proceeds from step 612, via connecting node G 661 to step 662 of FIG. 5H.

Returning to step 610 of FIG. 5E, operation proceeds from step 610, via connecting node F 611 to step 640 of FIG. 5G. In step 640 the UE is operated to select (from the identified set of ROs of step 514), for an additional access attempt which includes multiple PRACH signal repetitions, ROs to use to communicate PRACH signals, as part of the additional access attempt including repetitions. In some embodiments, step 640 includes step 642 in which the UE selects ROs corresponding to one type of slot (SBFD or non-SBFD) based on received signal power. In some other embodiments, step 640 includes step 644, in which the UE selects ROs based on PRACH transmission attempt time.

Step 642 includes step 646, step 648 and step 650. In step 646, the UE compares the SSB-RSRP to threshold_3 and determines whether or not the SSB-RSRP is less than threshold_3. If the determination of step 646 is that the SSB-RSRP is less than threshold_3, then operation proceeds from step 646 to step 648 in which the SBFD capable UE is operated to select ROs (from among the ROs in the identified set of ROs of step 514) which corresponds to only non-SBFD slots for communicating multiple PRACH signal repetitions. However, if the determination of step 646 is that the SSB-RSRP is not less than threshold_3, then operation proceeds from step 646 to step 650 in which the SBFD capable UE is operated to select ROs (from among the ROs in the identified set of ROs of step 514) which corresponds to only SBFD slots for communicating multiple PRACH signal repetitions.

Returning to step 644, step 644 includes steps 652, 654, 656, 658 and 660. In step 652 the UE determines if combining ROs, associated with the same SSB of interest, in SBFD slots and non-SBFD slots results in faster PRACH repetition in a PRACH transmission attempt, than an approach of only using one type of slot. If the determination of step 652 is that combing ROs, associated with the same SSB of interest, in SBFD slots and non-SBSD slots will result in a faster PRACH repetition, then operation proceeds from step 652 to step 660, in which the SBFD capable UE is operated to select ROs (from among the ROs in the identified set of ROs of step 514) which includes a mix of SBFD slots and non-SBFD slots for communicating multiple PRACH signal repetitions in the additional access attempt. However, if the determination of step 652 is that combing ROs, associated with the same SSB of interest, in SBFD slots and non-SBSD slots will not result in a faster PRACH repetition, then operation proceeds from step 652 to step 654.

In step 654, the UE compares the SSB-RSRP to threshold_4 and determines whether or not the SSB-RSRP is less than threshold_4. If the determination of step 654 is that the SSB-RSRP is less than threshold_4, then operation proceeds from step 654 to step 656, in which the SBFD capable UE is operated to select ROs (from among the ROs in the identified set of ROs of step 514) which corresponds to only non-SBFD slots for communicating multiple PRACH signal repetitions as part of the additional access attempt. However, if the determination of step 654 is that the SSB-RSRP is not less than threshold_4, then operation proceeds from step 654 to step 658 in which the SBFD capable UE is operated to select ROs (from among the ROs in the identified set of ROs of step 514) which corresponds to only SBFD slots for communicating multiple PRACH signal repetitions as part of the additional access attempt. Operation proceeds from step 640, via connecting node G 661 to step 662 of FIG. 5H.

Returning to step 605 of FIG. 5E, in step 604 the UE, which is a non-SBFD capable UE, is operated to select for an additional access attempt, a RO to use from among the ROs in the identified set of ROs of step 516. Step 605 includes step 6051, in which the UE is operated to select a RO, from among the identified set of ROs of step 516, which includes non-SBFD slots and symbols. Operation proceeds from step 605 to step 607. In step 607, the UE selects, for the additional access attempt, which includes PRACH signal repetitions, one or more additional ROs to use from among the ROs in the identified set of ROs of step 516. Step 607 includes step 6071 in which the UE is operated to select one or more additional ROs from among the ROs in the identified set of ROs of step 516, which includes non-SBFD symbols and slots. Step 607 is bypassed for an embodiment, in which the non-SBFD capable UE has decided to perform an additional access attempt without repetitions. Operation proceeds from step 607, via connecting node G 661 to step 662 of FIG. 5H.

In step 662 the UE is operated to perform the initial access attempt. Step 662 includes step 664 and 666. If it has been decided that the additional access attempt is without PRACH signal repetitions, then step 664 is performed in which the UE is operated to perform the additional access attempt without PRACH signal repetitions. Step 664 includes step 668 in which the UE is operated to transmit a PRACH signal on the selected RACH occasion (RO) as part of the additional access attempt.

Alternatively, if it has been decided that the additional access attempt is with PRACH signal repetitions, then step 666 is performed in which the UE is operated to perform the additional access attempt with PRACH signal repetitions. Step 666 includes step 670, step 674, and in some embodiments, step 676. In step 670 the UE is operated to transmit a PRACH signal on a selected RACH occasion (RO) as part of the additional access attempt. The selected RO is obtained from one of steps 648, 650, 656, 658, 660, or 605. Step 670 includes step 672, in which the UE is operated to transmit a PRACH signal on a selected RO using a symbol, said symbol being a non-SBFD symbol or a SBFD symbol in a timing structure including both non-SBFD symbols and SBFD symbols. Operation proceeds from step 670 to step 674, in which the UE is operated to transmit a PRACH signal on another selected RACH occasion (RO) as part of the additional access attempt. The selected RO is obtained from one of steps 648, 650, 656, 658, 660, or 607. In some embodiments, operation proceeds from step 674 to step 676. In other embodiments, step 676 is bypassed. In step 676 the UE is operated to transmit a PRACH signal on yet another selected RACH occasion (RO) as part of the additional access attempt. The selected RO is obtained from one of steps 648, 650, 656, 658, 660, or 607.

Operation proceeds from step 662 to one of step 678 or step 684. In step 678 the UE receives a random access response, e.g., from the base station, e.g. the gNB, indicating success of the additional access attempt. Operation proceeds from step 678 to step 680, in which the UE sends a RRC setup request to base station, e.g. gNB. Operation proceeds from step 680 to step 682, in which the UE receives a RRC setup contention resolution message from the base station, e.g. gNB.

Alternatively, in step 600 the UE detects failure of the initial access attempt. Operation proceeds from step 600, via connecting node D 601, to step 602 of FIG. 5E.

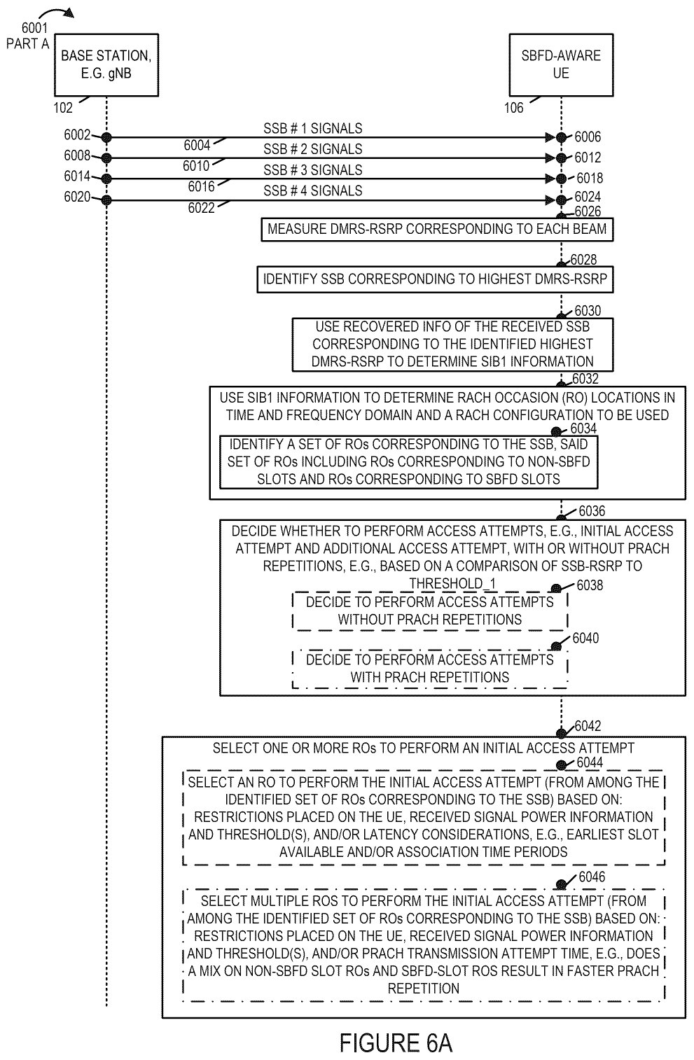

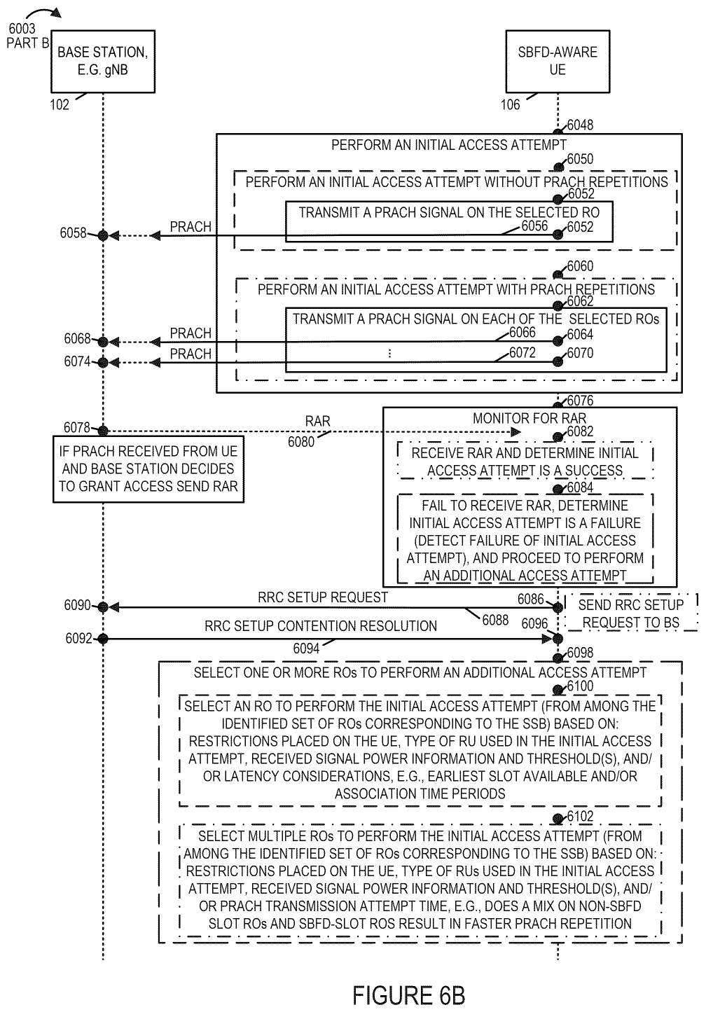

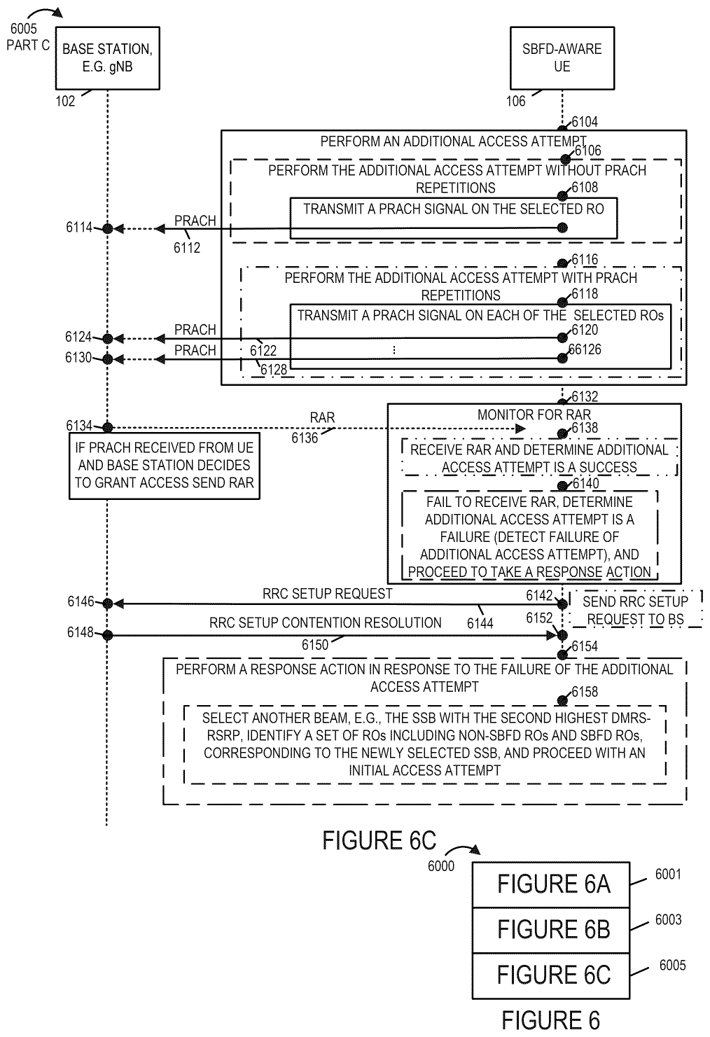

FIG. 6, comprising the combination of FIG. 6A, FIG. 6B and FIG. 6C, is a signaling diagram 6000, including Part A 6001, Part B 6003 and Part C 6005, illustrating signaling and operations performed by exemplary base station 102, e.g., a gNB, and exemplary SBFD-aware UE 106, in accordance with an exemplary embodiment.

In step 6002 base station 102 generates and sends SSB #1 signals 6004 to UE 106, which are received by UE 106 in step 6006. In step 6008 base station 102 generates and sends SSB #2 signals 6010 to UE 106, which are received by UE 106 in step 60012. In step 6014 base station 102 generates and sends SSB #3 signals 6016 to UE 106, which are received by UE 106 in step 6018. In step 6020 base station 102 generates and sends SSB #1 signals 6022 to UE 106, which are received by UE 106 in step 6024. In step 6026, UE 106 measure DeModulation Reference signal-Reference Signal Received Power (DMRS-RSRP) corresponding to each of the beams. In step 6028 UE 106 identifies the SSB corresponding to the highest DMRS-RSRP. In step 6038 UE 106 uses recovered information of the received SSB corresponding to the identified highest DMRS-RSRP to determine a set of System Information Block 1 (SIB 1) information. In step 6032 UE 106 used the SIB 1 information to determine RACH occasion (RO) locations in time and frequency domain and a RACH configuration to be used. Step 6032 includes step 6034, in which UE 106 identifies a set of ROs corresponding to the SSB, said set of ROs including ROs corresponding to non-SBFD slots and ROs corresponding to SBFD slots.

In step 6036 UE 106 decides whether to perform access attempts, e.g. an initial access attempt and an additional access attempt, if the initial access attempt fails, with or without PRACH repetitions, e.g., based on a comparison of SSB-RSRP to threshold_1. (For example, see the approach of steps 520 and 604 of flowchart 500, which is used in some exemplary embodiments.) An iteration of step 6036 includes one or step 6038 and 6040. In step 6038 UE 106 decides to perform access attempts without PRACH repetitions. In step 6040 UE 106 decides to perform access attempts with PRACH repetitions.

In step 6042, UE 106 selects one or more ROs to perform an initial access attempt. If the UE decided to perform access attempts without PRACH repetitions, then UE 106 performs step 6044, in which UE 106 selects an RO to perform the initial access attempt (from among the identified ROs corresponding to the SSB) based on: restrictions placed on the UE (e.g., limiting the UE to use only one type of RO (non-SBFD or SBFD) and/or not allowing frequency hopping with regard to ROs, received signal power information and threshold(s), and/or latency considerations, e.g., earliest slot available and/or association time periods. In some embodiments, in step 6044 UE 106 performs step 528 of FIG. 5B.

Alternatively, if the UE decided to perform access attempts with PRACH repetitions, then UE 106 performs step 6046, in which UE 106 selects multiple ROs to perform the initial access attempt (from among the identified ROs corresponding to the SSB) based on: restrictions placed on the UE (e.g., limiting the UE to use only one type of RO (non-SBFD or SBFD) and/or not allowing frequency hopping with regard to ROs, received signal power information and threshold(s), and/or PRACH transmission attempt time e.g., does a mix on non-SBFD slot ROs and SBFD slot-ROs result in faster PRACH repetition. In some embodiments, in step 6046 UE 106 performs step 558 of FIG. 5C.

In step 6048, UE 106 performs an initial access attempt. If the UE decided to perform access attempts without PRACH repetitions, then UE 106 performs step 6050, in which UE 106 performs an initial access attempt without PRACH repetitions. Step 6050 includes step 6052 in which UE 106 transmits a PRACH signal 6056 on the selected RO. The PRACH signal 6056 is directed to base station 102, which may or may not receive and receive the PRACH signal 6056. In step 6058, which may or may not occur, base station 102, receives PRACH signal 6056 and successfully recovers the communicated information.

Alternatively, if the UE decided to perform access attempts with PRACH repetitions, then UE 106 performs step 6060, in which UE 106 performs an initial access attempt with PRACH repetitions. Step 6060 includes step 6062, in which UE 106 transmits a PRACH signal on each of the selected ROs. In step 6064 UE 106 transmits PRACH signal 6066, which is directed to base station 102. Base station 102 may or may not receive and receive the PRACH signal 6066. In step 6068, which may or may not occur, base station 102, receives PRACH signal 6066 and successfully recovers the communicated information. In step 6070 UE 106 transmits PRACH signal 6072, which is directed to base station 102. Base station 102 may or may not receive and receive the PRACH signal 6072. In step 6074, which may or may not occur, base station 102, receives PRACH signal 6074 and successfully recovers the communicated information.

In step 6076 UE 106 monitors for a RAR from base station 102, in response to the transmitted one or more PRACH signals, as part of the initial access attempt.

If the base station, 102 received one or more PRACHs from UE 106, and base station 102 has decided to grant access to UE 102, then in step 6078, base station 102 sends a RAR 6080 to UE 102. In step 6082, which may be performed, UE 106 receives RAR 6080 and determines the initial access attempt is a success. Alternatively, the UE performs steps 6084, in which the UE fails to receive a RAR, e.g., within an expected predetermined time interval, determines that the initial access attempt is a failure (e.g., the UE has detected failure of the initial access attempt based on not receiving the RAR), and the UE proceeds to perform an additional access attempt.

Operation proceeds from step 6082 to step 6086, in which the UE 106 generates and sends a RRC setup request 6088 to base station 102. In step 6092, base station 102 receives the RRC setup request 6088, and in response in step 6082, base station 102 generates and sends a RRC setup contention resolution message 6094 to UE 106, which receives the RRC setup contention resolution 6094 in step 6096.

Alternatively, in response to a detected failure of the initial access attempt, operation proceeds from step 6084 to step 6098, in which the UE 106 selects one or more ROs to perform the additional access attempt. If the UE decided to perform access attempts without PRACH repetitions, then UE 106 performs step 6100, in which UE 106 selects an RO to perform the additional access attempt (from among the identified ROs corresponding to the SSB) based on: restrictions placed on the UE (e.g., limiting the UE to use only one type of RO (non-SBFD or SBFD) and/or not allowing frequency hopping with regard to ROs, the type of RO used in the initial access attempt, received signal power information and threshold(s), and/or latency considerations, e.g., earliest slot available and/or association time periods. In some embodiments, in step 6100 UE 106 performs step 612 of FIG. 5F.

Alternatively, if the UE 106 decided to perform access attempts with PRACH repetitions, then UE 106 performs step 6102, in which UE 106 selects multiple ROs to perform the additional access attempt (from among the identified ROs corresponding to the SSB) based on: restrictions placed on the UE (e.g., limiting the UE to use only one type of RO (non-SBFD or SBFD) and/or not allowing frequency hopping with regard to ROs, the type of ROs used in the additional access attempt, received signal power information and threshold(s), and/or PRACH transmission attempt time e.g., does a mix on non-SBFD slot ROs and SBFD slot ROs result in faster PRACH repetition. In some embodiments, in step 6046 UE 106 performs step 640 of FIG. 5G.

In step 6104, UE 106 performs the additional access attempt. If the UE decided to perform access attempts without PRACH repetitions, then UE 106 performs step 6106, in which UE 106 performs the additional access attempt without PRACH repetitions. Step 6106 includes step 6108 in which UE 106 transmits a PRACH signal 6112 on the selected RO. The PRACH signal 6102 is directed to base station 102, which may or may not receive and receive the PRACH signal 6106. In step 6114, which may or may not occur, base station 102, receives PRACH signal 6112 and successfully recovers the communicated information.

Alternatively, if the UE 106 decided to perform access attempts with PRACH repetitions, then UE 106 performs step 6116, in which UE 106 performs the additional access attempt with PRACH repetitions. Step 6116 includes step 6118, in which UE 106 transmits a PRACH signal on each of the selected ROs. In step 6120 UE 106 transmits PRACH signal 6122, which is directed to base station 102. Base station 102 may or may not receive and receive the PRACH signal 6122. In step 6124, which may or may not occur, base station 102, receives PRACH signal 6122 and successfully recovers the communicated information. In step 6126 UE 106 transmits PRACH signal 6128, which is directed to base station 102. Base station 102 may or may not receive and receive the PRACH signal 6128. In step 6130, which may or may not occur, base station 102, receives PRACH signal 6128 and successfully recovers the communicated information.

In step 6132 UE 106 monitors for a RAR from base station 102, in response to the transmitted one or more PRACH signals, as part of the additional access attempt.

If the base station, 102 received one or more PRACHs from UE 106, and base station 102 has decided to grant access to UE 102, then in step 6134, base station 102 sends a RAR 6136 to UE 102. In step 6138, which may be performed, UE 106 receives RAR 6136 and determines the initial access attempt is a success. Alternatively, the UE 106 performs steps 6140, in which the UE fails to receive a RAR, e.g., within an expected predetermined time interval, determines that the additional access attempt is a failure (e.g., the UE has detected failure of the additional access attempt based on not receiving the RAR), and the UE 106 proceeds to perform take a response action.

Operation proceeds from step 6138 to step 6142, in which the UE 106 generates and sends a RRC setup request 6144 to base station 102. In step 6134, base station 102 receives the RRC setup request 6144, and in response in step 6148, base station 102 generates and sends a RRC setup contention resolution message 6150 to UE 106, which receives the RRC setup contention resolution 6150 in step 6152.

Alternatively, in response to a detected failure of the additional access attempt, operation proceeds from step 6140 to step 6154, in which the UE 106 performs a response action in response to the failure of the additional access attempt. In some embodiments, step 6154 includes step 6158, in which the UE 106 selects another beam, e.g., the SSB with the second highest DMRS-RSRP, then returns to step 6030, and continues with the process, e.g., recovering SIB 1 information, identifying a set of ROs including non-SBFD ROs and SBFD ROs, corresponding to the newly selected SSB, deciding whether to perform the initial access with or without PRACH repetitions, selecting one or more ROs, and performing the initial access attempt, etc.

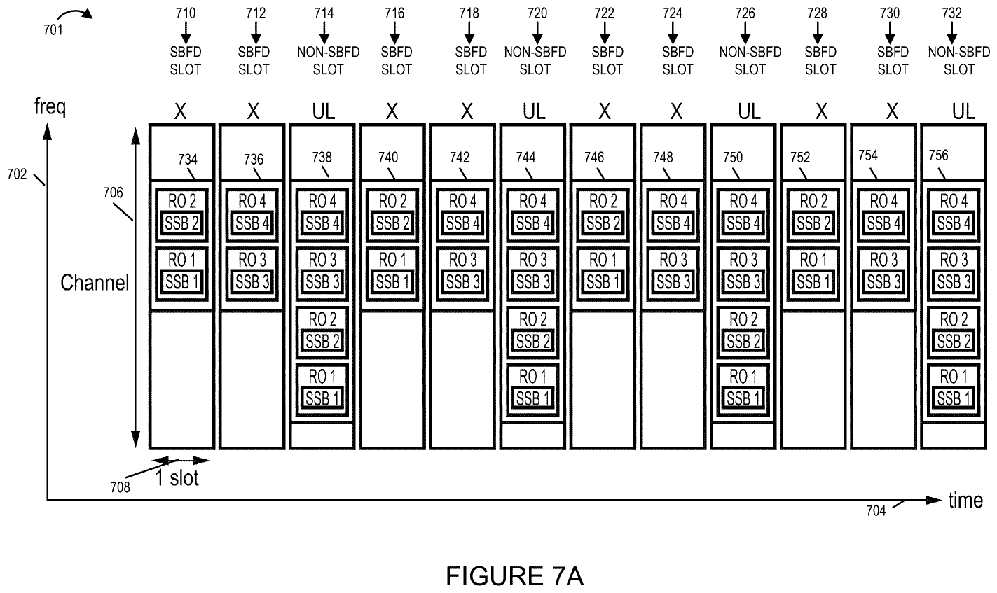

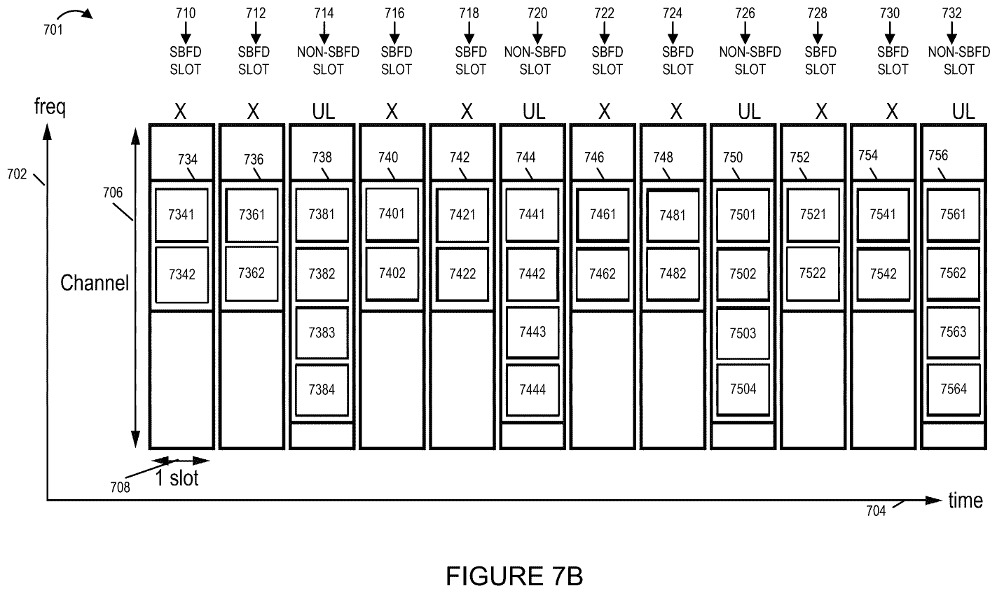

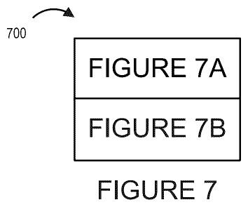

FIG. 7 is a drawing 700 illustrating how FIGS. 7A and 7 B can be combined to form a complete drawing illustrating features of an exemplary timing frequency structure including SBFD slots and non-SBFD slots.

FIG. 7A is a first drawing illustrating features of an exemplary timing frequency structure 701 including SBFD slots and non-SBFD slots.

FIG. 7B is a second drawing of the exemplary timing frequency structure of FIG. 7A with reference numbers used to identify each of the ROs in the SBFD and non-SBFD slots of FIG. 7A.

FIG. 7A is a drawing 701 illustrating an exemplary timing frequency structure including SBFD slots and non-SBFD slots. Vertical axis 702 represents frequency while horizontal axis 704 represents time. The non-SBFD slots are uplink slots, represented by UL.

The SBFD slots, represented by X, are predominately used for DL, but include a portion used for uplink, e.g., a portion used for RACH Occasions (ROs). An exemplary slot duration 708 is shown for slot 710. For simplicity a pattern of XXU is shown, which corresponds to a TDD slot pattern of DDU, although a common choice in practice is DDDDU.

The exemplary timing frequency structure of FIG. 7 includes SBFD slot 710, SBFD slot 712, non-SBFD slot 714, SBFD slot 716, SBFD slot 718, non-SBFD slot 720, SBFD slot 722, SBFD slot 224, non-SBFD slot 726, SBFD slot 728, SBFD slot 730, non-and SBFD slot 732.

Channel 706 represents a bandwidth in the frequency domain. In SBFD slot 710 time-frequency resource block 734 is used for ROs. Time-frequency resource block 734 includes: i) a first time-frequency resource block 7341, which is allocated to be used by UEs using SSB 2, and is thus labeled RO 2; and ii) a second time-frequency resource block 7342, which is allocated to be used by UEs using SSB 1, and is thus labeled RO 1.

In SBFD slot 712 time-frequency resource block 736 is used for ROs. Time-frequency resource block 736 includes: i) a first time-frequency resource block 7361, which is allocated to be used by UEs using SSB 4, and is thus labeled RO 4; and ii) a second time-frequency resource block 7362, which is allocated to be used by UEs using SSB 3, and is thus labeled RO 3.

In non-SBFD slot 714 time-frequency resource block 738 is used for ROs. Time-frequency resource block 738 includes: i) a first time-frequency resource block 7381, which is allocated to be used by UEs using SSB 4, and is thus labeled RO 4; ii) a second time-frequency resource block 7382, which is allocated to be used by UEs using SSB 3, and is thus labeled RO 3; ii) a third time-frequency resource block 7383, which is allocated to be used by UEs using SSB 2, and is thus labeled RO 2; iii) a fourth time-frequency resource block 7384, which is allocated to be used by UEs using SSB 1, and is thus labeled RO 1.

In SBFD slot 716 time-frequency resource block 740 is used for ROs. Time-frequency resource block 740 includes: i) a first time-frequency resource block 7401, which is allocated to be used by UEs using SSB 2, and is thus labeled RO 2; and ii) a second time-frequency resource block 7402, which is allocated to be used by UEs using SSB 1, and is thus labeled RO 1.

In SBFD slot 718 time-frequency resource block 742 is used for ROs. Time-frequency resource block 742 includes: i) a first time-frequency resource block 7421, which is allocated to be used by UEs using SSB 4, and is thus labeled RO 4; and ii) a second time-frequency resource block 7422, which is allocated to be used by UEs using SSB 3, and is thus labeled RO 3.

In non-SBFD slot 720 time-frequency resource block 744 is used for ROs. Time-frequency resource block 744 includes: i) a first time-frequency resource block 7441, which is allocated to be used by UEs using SSB 4, and is thus labeled RO 4; ii) a second time-frequency resource block 7442, which is allocated to be used by UEs using SSB 3, and is thus labeled RO 3; ii) a third time-frequency resource block 7443, which is allocated to be used by UEs using SSB 2, and is thus labeled RO 2; iii) a fourth time-frequency resource block 7444, which is allocated to be used by UEs using SSB 1, and is thus labeled RO 1.

In SBFD slot 722 time-frequency resource block 746 is used for ROs. Time-frequency resource block 746 includes: i) a first time-frequency resource block 7461, which is allocated to be used by UEs using SSB 2, and is thus labeled RO 2; and ii) a second time-frequency resource block 7462, which is allocated to be used by UEs using SSB 1, and is thus labeled RO 1.

In SBFD slot 724 time-frequency resource block 748 is used for ROs. Time-frequency resource block 748 includes: i) a first time-frequency resource block 7481, which is allocated to be used by UEs using SSB 4, and is thus labeled RO 4; and ii) a second time-frequency resource block 7482, which is allocated to be used by UEs using SSB 3, and is thus labeled RO 3.

In non-SBFD slot 726 time-frequency resource block 750 is used for ROs. Time-frequency resource block 750 includes: i) a first time-frequency resource block 7501, which is allocated to be used by UEs using SSB 4, and is thus labeled RO 4; ii) a second time-frequency resource block 7502, which is allocated to be used by UEs using SSB 3, and is thus labeled RO 3; ii) a third time-frequency resource block 7503, which is allocated to be used by UEs using SSB 2, and is thus labeled RO 2; iii) a fourth time-frequency resource block 7504, which is allocated to be used by UEs using SSB 1, and is thus labeled RO 1.

In SBFD slot 728 time-frequency resource block 752 is used for ROs. Time-frequency resource block 752 includes: i) a first time-frequency resource block 7521, which is allocated to be used by UEs using SSB 2, and is thus labeled RO 2; and ii) a second time-frequency resource block 7522, which is allocated to be used by UEs using SSB 1, and is thus labeled RO 1.

In SBFD slot 730 time-frequency resource block 754 is used for ROs. Time-frequency resource block 754 includes: i) a first time-frequency resource block 7541, which is allocated to be used by UEs using SSB 4, and is thus labeled RO 4; and ii) a second time-frequency resource block 7542, which is allocated to be used by UEs using SSB 3, and is thus labeled RO 3.

In non-SBFD slot 732 time-frequency resource block 756 is used for ROs. Time-frequency resource block 756 includes: i) a first time-frequency resource block 7561, which is allocated to be used by UEs using SSB 4, and is thus labeled RO 4; ii) a second time-frequency resource block 7542, which is allocated to be used by UEs using SSB 3, and is thus labeled RO 3; ii) a third time-frequency resource block 7543, which is allocated to be used by UEs using SSB 2, and is thus labeled RO 2; iii) a fourth time-frequency resource block 7544, which is allocated to be used by UEs using SSB 1, and is thus labeled RO 1.

Non-SBFD aware UEs can only use ROs in UL slots, which are designated as non-SBFD slots. In some embodiments, SBFD-aware UEs can use ROs in SBFD slots and non-SBFD slots. In some embodiments SBFD-aware UEs are controlled to use ROs in only SBFD slots, thus leaving the ROs in the non-SBFD slots, UL slots, for the legacy UE, e.g., non-SBFD aware UEs. In some embodiments, a SBFD aware UE may be, and sometimes is, restricted to transmitting in one type of slot, e.g., a non-SBFD slot or a SBFD slot. In some embodiments, the UE may use ROs in either SBFD slots or non-SBFD slots, with the UE making the decision as to which type of slot to use, based on power measurement information, latency considerations, and/or other information.

In the example of FIG. 7, with regard to the time-frequency resources to be used for RACH occasions, in non-SBFD symbols/slots, the FDM=2, while in SBFD symbols/slots the FDM=4.

FIG. 7B is drawing illustrating reference numbers on each of the ROs in the SBFD and non-SBFD slots of FIG. 7A.

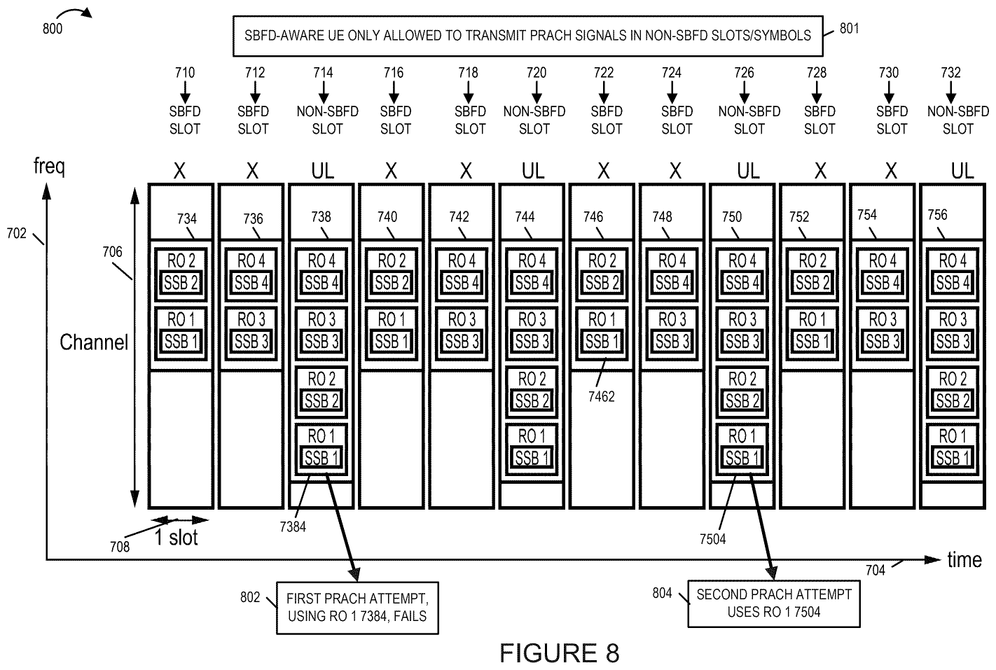

FIG. 8 is a drawing 800 illustrating an example in which a UE, e.g., a SBFD aware UE, is allowed to transmit PRACH signals in only non-SBFD symbols/slots, as indicated by information box 801. Consider that the exemplary UE is using SSB 1. The UE makes a first PRACH attempt (initial access attempt) using RO 1 7384, which is located in non-SBFD slot 714. Consider that this first PRACH attempt fails (as indicated by information box 802), e.g., the UE does not receive a RAR indicating success in the expected time interval. The UE makes a second PRACH attempt (additional access attempt) using RO 1 7504, which is located in non-SBFD slot 726, as indicated by information box 804. In this example, the UE was not allowed to make a PRACH transmission using RO 1 7462 in SBFD slot 722.

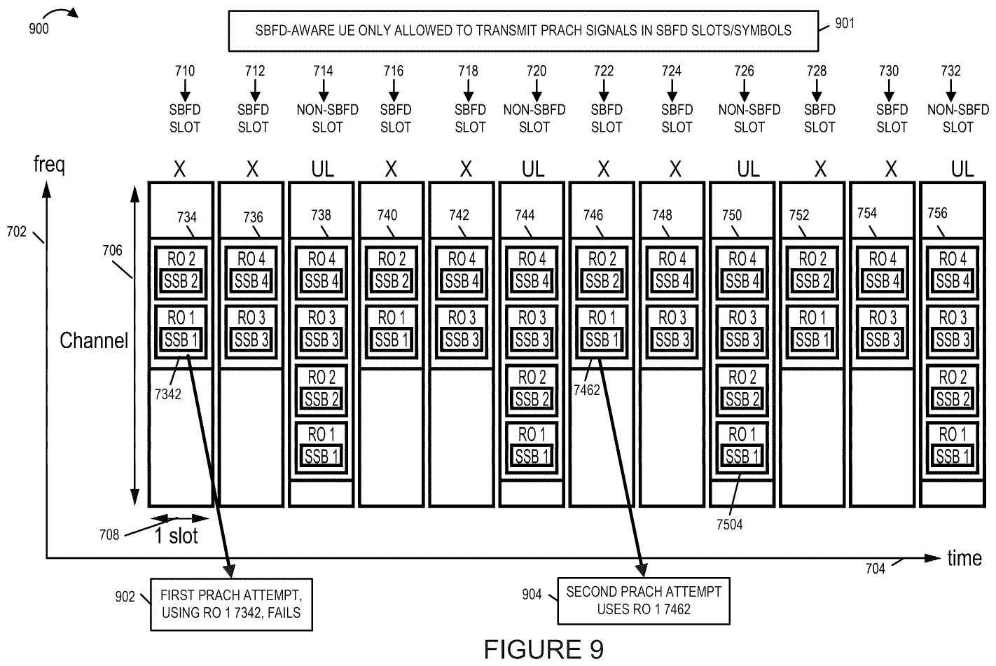

FIG. 9 is a drawing 900 illustrating an example in which a UE, e.g., a SBFD aware UE, is allowed to transmit PRACH signals in only SBFD symbols/slots, as indicated by information box 901. Consider that the exemplary UE is using SSB 1. The UE makes a first PRACH attempt (initial access attempt) using RO 1 7342, which is located in SBFD slot 710. Consider that this first PRACH attempt fails (as indicated by information box 902), e.g., the UE does not receive a RAR indicating success in the expected time interval. The UE makes a second PRACH attempt (additional access attempt) using RO 1 7462, which is located in SBFD slot 722. In this example, the UE was not allowed to make a PRACH transmission using RO 1 7504 in non-SBFD slot 726.

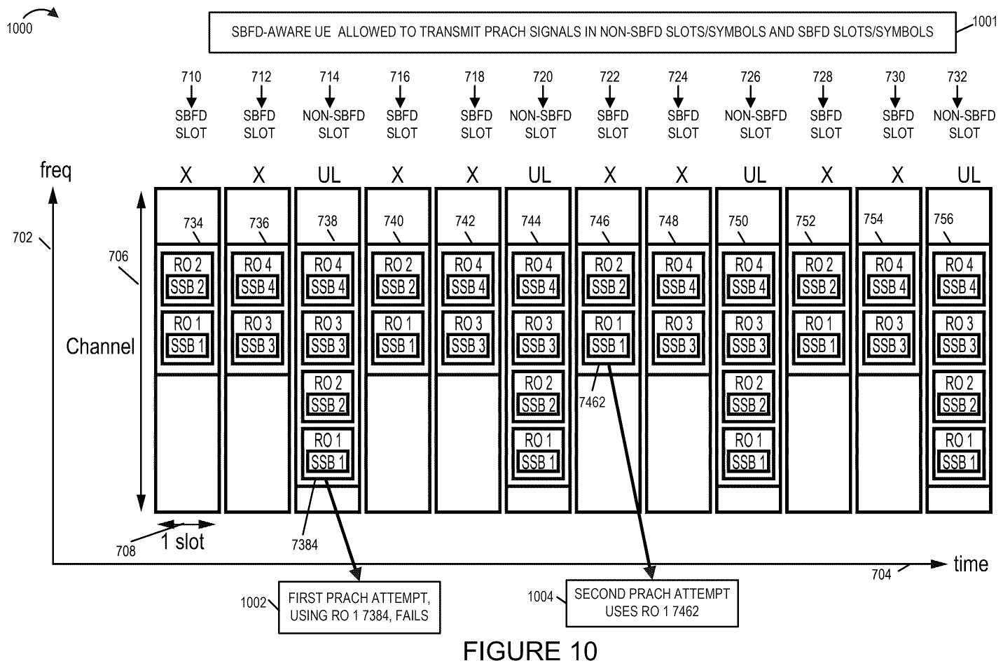

FIG. 10 is a drawing 1000 illustrating an example in which a UE, e.g., a SBFD aware UE, is allowed to transmit PRACH signals in non-SBFD symbols/slots and SBFD symbols/slots, as indicated by information box 1001. Consider that the exemplary UE is using SSB 1. The UE makes a first PRACH attempt (initial access attempt) using RO 1 7384, which is located in SBFD slot 714. Consider that this first PRACH attempt fails (as indicated by information box 1002), e.g., the UE does not receive a RAR indicating success in the expected time interval. The UE makes a second PRACH attempt (additional access attempt) using RO 1 7462, which is located in SBFD slot 722.

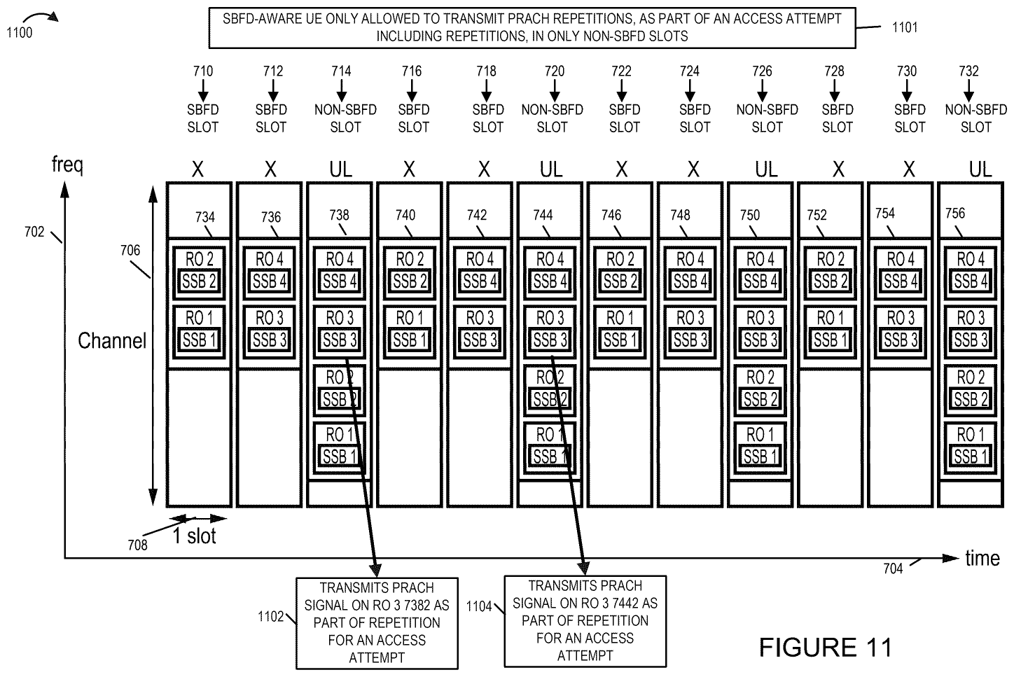

FIG. 11 is a drawing 1100 illustrating an example in which a UE, e.g., a SBFD aware UE, is allowed to transmit PRACH repetitions, as part of an access attempt including PRACH repetitions, in only ROs in non-SBFD slots, as indicated by information box 1101.

Consider that the exemplary UE is using SSB 3. The UE transmits a PRACH signal on RO 3 7382 in non-SBFD slot 714 (as indicated by information box 1102) and transmits a PRACH signal on RO 3 7442 in non-SBFD slot 720 (as indicated by information box 1104), as part of an access attempt including PRACH repetitions.

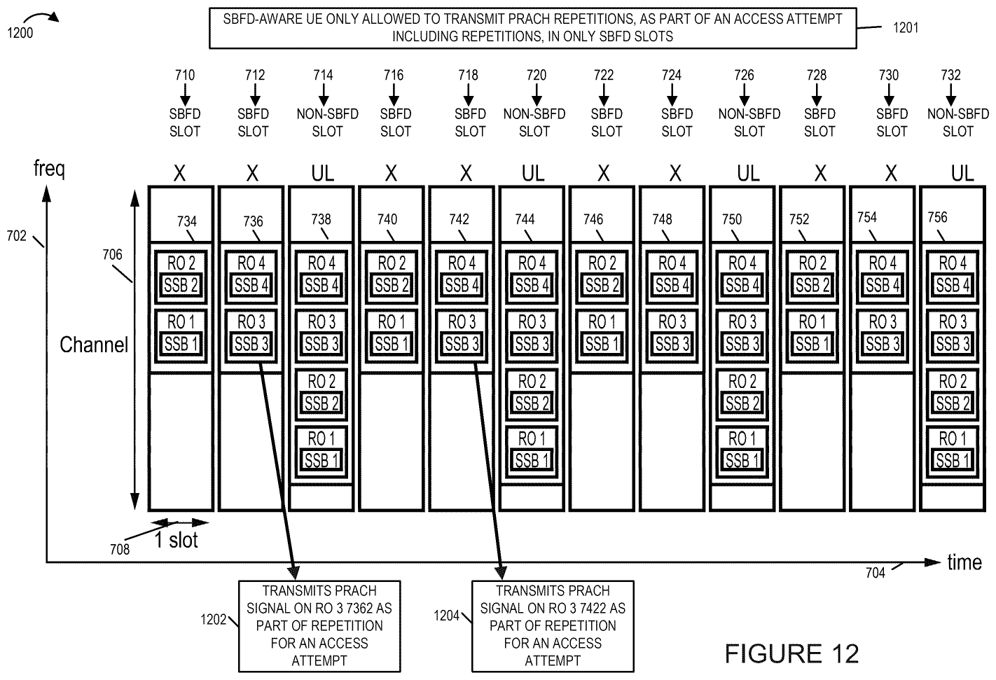

FIG. 12 is a drawing 1200 illustrating an example in which a UE, e.g. a SBFD aware UE, is allowed to transmit PRACH repetitions, as part of an access attempt including PRACH repetitions, in only ROs in SBFD slots, as indicated by information box 1201.

Consider that the exemplary UE is using SSB 3. The UE transmits a PRACH signal on RO 3 7362 in SBFD slot 712 (as indicated by information box 1202) and transmits a PRACH signal on RO 3 7422 in SBFD slot 718 (as indicated by information box 1204), as part of a access attempt including PRACH repetitions.

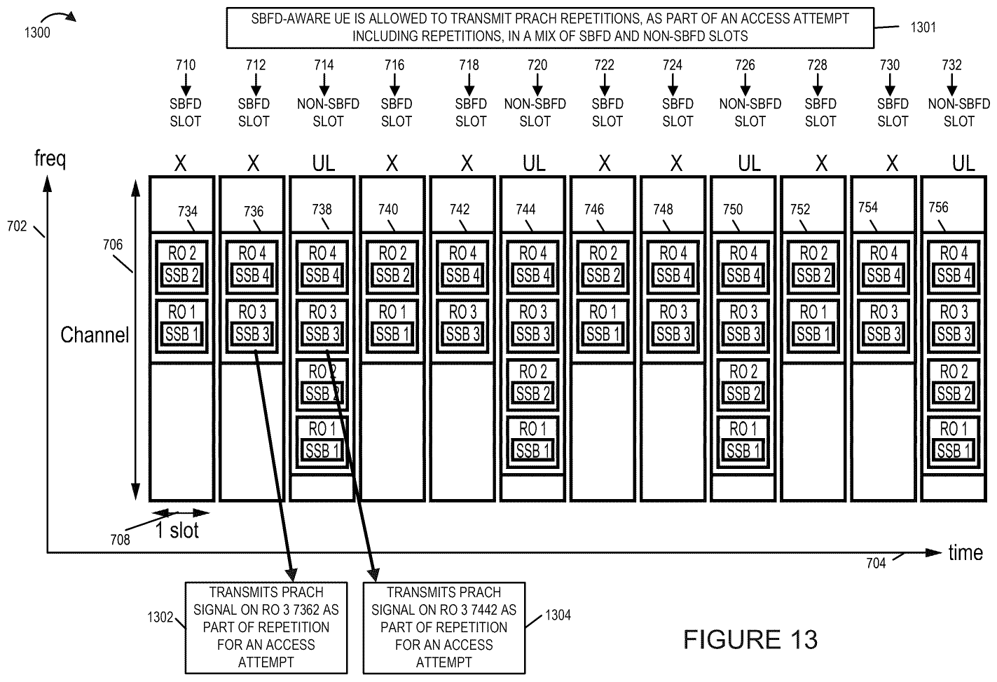

FIG. 13 is a drawing 1300 illustrating an example in which a UE, e.g. a SBFD aware UE, is allowed to transmit PRACH repetitions in a mix of SBFD and non-SBFD slots, as part of an access attempt including PRACH repetitions, as indicated by information box 1301.

Consider that the exemplary UE is using SSB 3. The UE transmits a PRACH signal on RO 3 7362 in SBFD slot 712 (as indicted by information box 1302) and transmits a PRACH signal on RO 3 7382 in non-SBFD slot 714 (as indicated by information box 1304), as part of a access attempt including PRACH repetition.

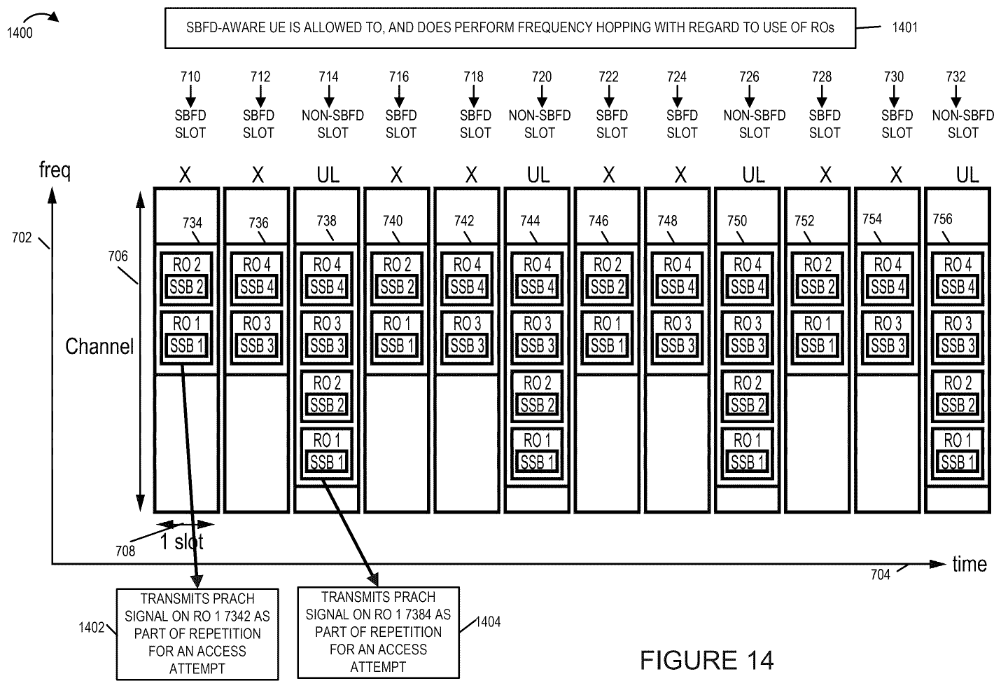

FIG. 14 is a drawing 1400 illustrating an example in which a UE, e.g. a SBFD aware UE, is allowed to, and does, perform frequency hopping with regard to use of ROs by information box 1401. Consider that the exemplary UE is using SSB 1 and the UE decides to perform an access attempt with repetition, as indicated by information box 1401. The UE transmits a PRACH signal on RO 7342 in SBFD slot 710 (as indicated by information box 1402) and transmits a PRACH) signal on RO 1 7384 in non-SBFD slot 714, as part of an access attempt including PRACH repetitions (as indicated by information box 1404).

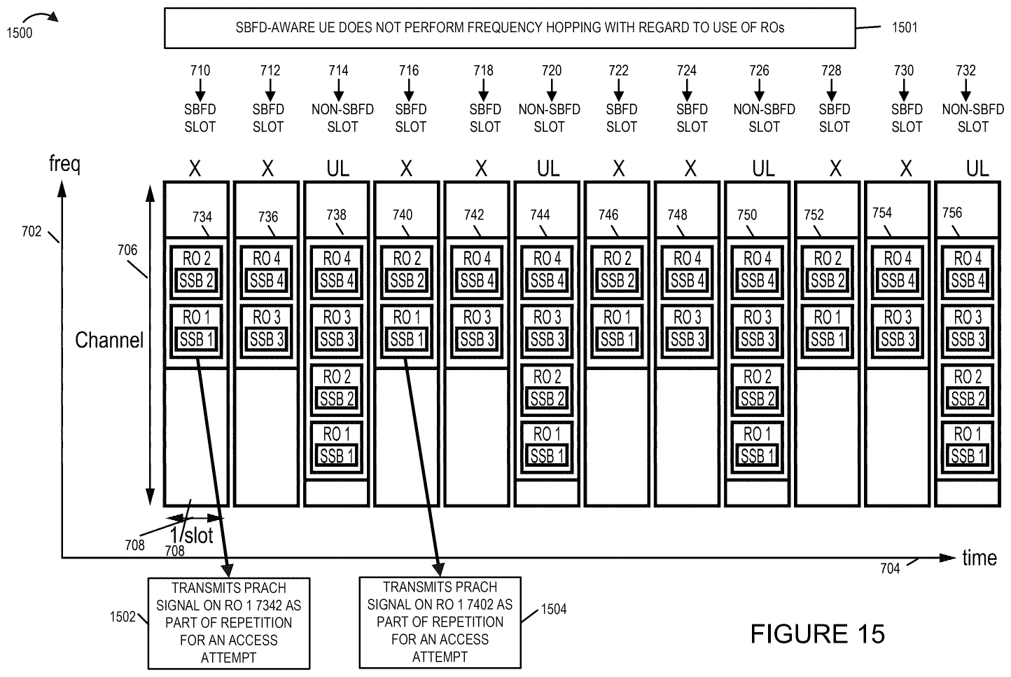

FIG. 15 is a drawing 1500 illustrating an example in which a UE, e.g. a SBFD aware UE, does not perform frequency hopping with regard to use of ROs by information box 1501. Consider that the exemplary UE is using SSB 1 and the UE decides to perform an access attempt with repetition. The UE transmits a PRACH signal on RO 7342 in SBFD slot 710 (as indicated by information box 1502) and transmits a PRACH signal on RO 1 7042 in SBFD slot 716 (as indicated by information box 1502), as part of an access attempt including PRACH repetitions.

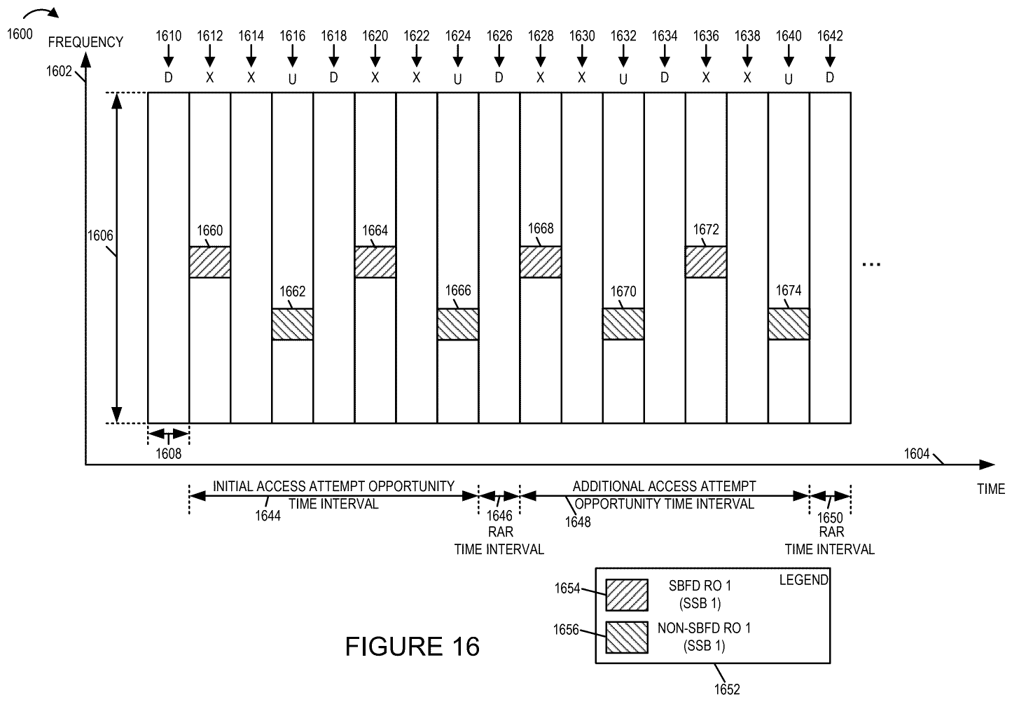

FIG. 16 is a drawing 1600 illustrating an exemplary timing frequency structure including downlink slots, SBFD slots, and uplink slots, in accordance with an exemplary embodiment. The downlink slots carry DL signals. The SBFD slots can carry both downlink and uplink signals, and the uplink slots carry uplink signals. Vertical axis 1602 represents frequency while horizontal axis 704 represents time. The UL slots are sometimes referred to as non-SBFD slots. Portions of the UL slots are typically used for RACH occasions (ROs). The SBFD slots, represented by X, are predominately used for DL, but include a portion used for uplink, e.g., a portion used for RACH Occasions (ROs). An exemplary slot duration 1608 is shown for slot 1610. For simplicity a pattern of DXXU is shown, which corresponds to a TDD slot pattern of DDDU, although a common choice in practice is DDDDU. Sets of ROs are defined for each of a plurality of SSBs. For simplicity only the ROs, corresponding to SSB1, are shown in FIG. 16; however, it should be appreciated that there are actually sets of ROs corresponding to each SSB beam. FIG. 7 illustrates an exemplary structure showing ROs corresponding to different SSBs.

Drawing 1600 illustrates that the exemplary timing-frequency structure includes the following sequency of slots (downlink slot 1610, SBFD slot 1612, SBFD slot 1614, uplink (non-SBFD) slot 1616, downlink slot 1618, SBFD slot 1620, SBFD slot 1622, uplink (non-SBFD) slot 1624, downlink slot 1626, SBFD slot 1628, SBFD slot 1630, uplink (non-SBFD) slot 1632, downlink slot 1634, SBFD slot 1636, SBFD slot 1638, uplink (non-SBFD) slot 1640, and downlink slot 1642.

FIG. 16 further includes a legend 1652, which indicates that a SBFD RO which corresponds to SSB 1, is designated as SBFD RO 1, and is represented in the time-frequency drawing 1600 by a box 1654 with left to right ascending line shading. Legend 1652, further indicates that a non-SBFD RO which corresponds to SSB 1, is designated as non-SBFD RO 1, and is represented in the time-frequency drawing 1600 by a box 1656 with left to right descending line shading.

SBFD slot 1612 includes SBFD RO 1 1660. Uplink (non-SBFD) slot 1616 includes non-SBFD RO 1 1662. SBFD slot 1620 includes SBFD RO 1 1664. Uplink (non-SBFD) slot 1624 includes non-SBFD RO 1 1666. SBFD slot 1628 includes SBFD RO 1 1668. Uplink (non-SBFD) slot 1632 includes non-SBFD RO 1 1670. SBFD slot 1636 includes SBFD RO 1 1672. Uplink (non-SBFD) slot 1640 includes non-SBFD RO 1 1674.

In this example, time interval 1644 represents an initial access opportunity time interval during which a UE, attempting to obtain access, may send one or more PRACH signals to the base station using one or more ROs. Time interval 1646, which maps to downlink slot 1626, corresponds to a RAR time interval, during which the base station may send a RAR signal, indicating success, to a UE, which sent a PRACH signal using a RO during the initial access attempt opportunity time interval 1644. Time interval 1648 represents an additional access opportunity time interval, which may be used by a UE, which failed to obtain access from its PRACH signal attempt(s) during the initial access attempt opportunity, e.g., did not receive a RAR indicating success during RAR time interval 1646. Time interval 1650, which maps to downlink slot 1642, corresponds to a RAR time interval, during which the base station may send a RAR signal, indicating success, to a UE which sent a PRACH signal using a RO during the additional access attempt opportunity time interval 1648.

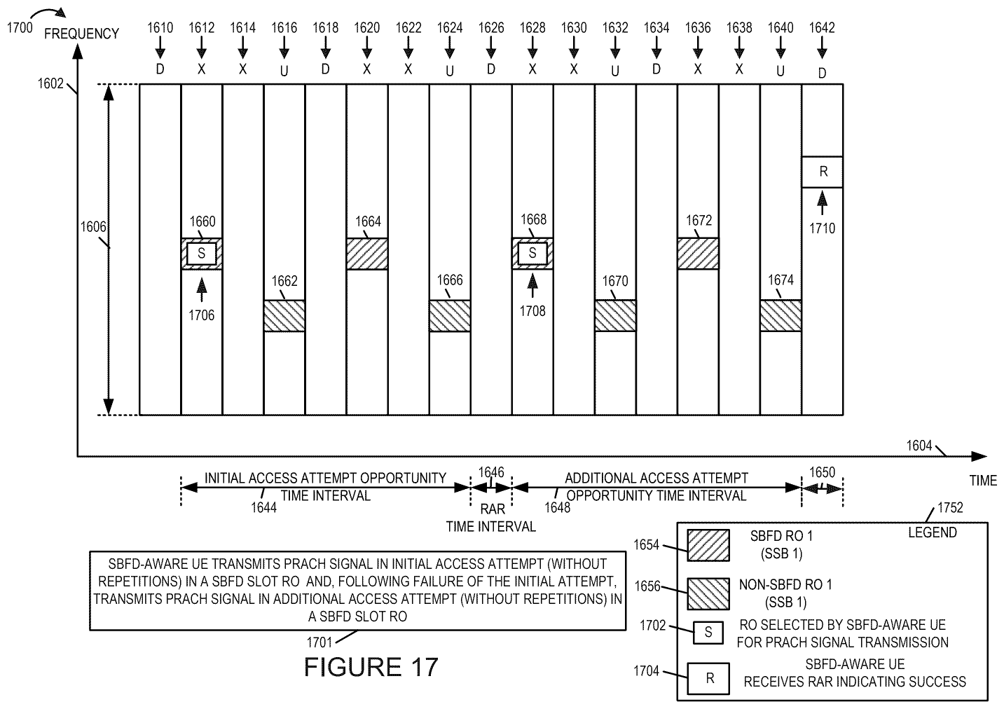

FIG. 17 is a drawing 1700 which illustrates an example in which a SBFD aware UE transmits a PRACH signal in an initial access attempt (without repetitions) in a SBFD slot RO, and following failure of the initial attempt, transmits a PRACH signal in an additional access attempt (without repetitions) in a SBFD slot RO, as indicated by information box 1701. The example of FIG. 17 is based on the timing frequency structure of FIG. 16.

FIG. 17 further includes a legend 1752, which indicates that a SBFD RO which corresponds to SSB 1, is designated as SBFD RO 1, and is represented in the time-frequency drawing 1700 by a box 1654 with left to right ascending line shading. Legend 1652, further indicates that a non-SBFD RO which corresponds to SSB 1, is designated as non-SBFD RO 1, and is represented in the time-frequency drawing 1700 by a box 1656 with left to right descending line shading. Legend 1752 further indicates that a small box with “S” indicates that the identified RO, has been selected by the SBFD-aware UE for PRACH transmission. Exemplary RO selection criteria and methods are included in the flowchart of FIG. 5. Legend 1752 further indicates that a small box with “R” indicates that the SBFD aware UE has received a RAR indicating success.

In the example of FIG. 17, the SBFD-aware UE, which is using SSB 1, performs an initial access attempt (without repetitions) and transmits a PRACH signal in selected SBFD RO 1 1660 of SBFD slot 1616, as indicated by arrow 1706. In this example, the initial access attempt was a failure and the UE did not receive a RAR message, indicating success, during RAR time interval 1646. In response to the failure, the SBFD-aware UE, performs an additional access attempt (without repetitions) and transmits a PRACH signal in selected SBFD RO 1 1668 of SBFD slot 1628, as indicated by arrow 1708. In this example, the additional access attempt was a success and the UE receives a RAR message, indicating success, during RAR time interval 1650, as indicated by arrow 1710.

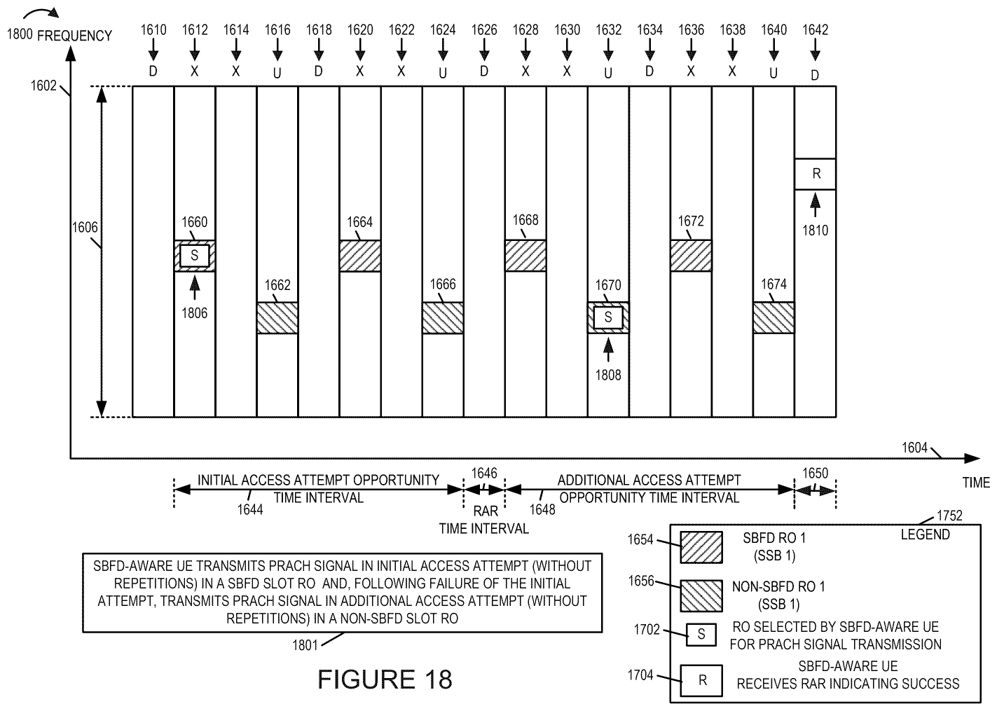

FIG. 18 is a drawing 1800 which illustrates an example in which a SBFD aware UE transmits a PRACH signal in an initial access attempt (without repetitions) in a SBFD slot RO, and following failure of the initial attempt, transmits a PRACH signal in an additional access attempt (without repetitions) in a non-SBFD slot RO, as indicated by information box 1801. The example of FIG. 18 is based on the timing frequency structure of FIG. 16.

FIG. 18 further includes legend 1752, which indicates that a SBFD RO which corresponds to SSB 1, is designated as SBFD RO 1, and is represented in the time-frequency drawing 1800 by a box 1654 with left to right ascending line shading. Legend 1752 further indicates that a non-SBFD RO which corresponds to SSB 1, is designated as non-SBFD RO 1, and is represented in the time-frequency drawing 1800 by a box 1656 with left to right descending line shading. Legend 1752 further indicates that a small box with “S” indicates that the identified RO, has been selected by the SBFD-aware UE for PRACH transmission. Exemplary RO selection criteria and methods are included in the flowchart of FIG. 5. Legend 1752 further indicates that a small box with “R” indicates that the SBFD aware UE has received a RAR indicating success.

In the example of FIG. 18, the SBFD-aware UE, which is using SSB 1, performs an initial access attempt (without repetitions) and transmits a PRACH signal in selected SBFD RO 1 1660 of SBFD slot 1616, as indicated by arrow 1806. In this example, the initial access attempt was a failure, and the UE did not receive a RAR message, indicating success, during RAR time interval 1646. In response to the failure, the SBFD-aware UE, performs an additional access attempt (without repetitions) and transmits a PRACH signal in selected non-SBFD RO 1 1670 of non-SBFD slot 1632, as indicated by arrow 1808. In this example, the additional access attempt was a success, and the UE receives a RAR message, indicating success, during RAR time interval 1650, as indicated by arrow 1810.

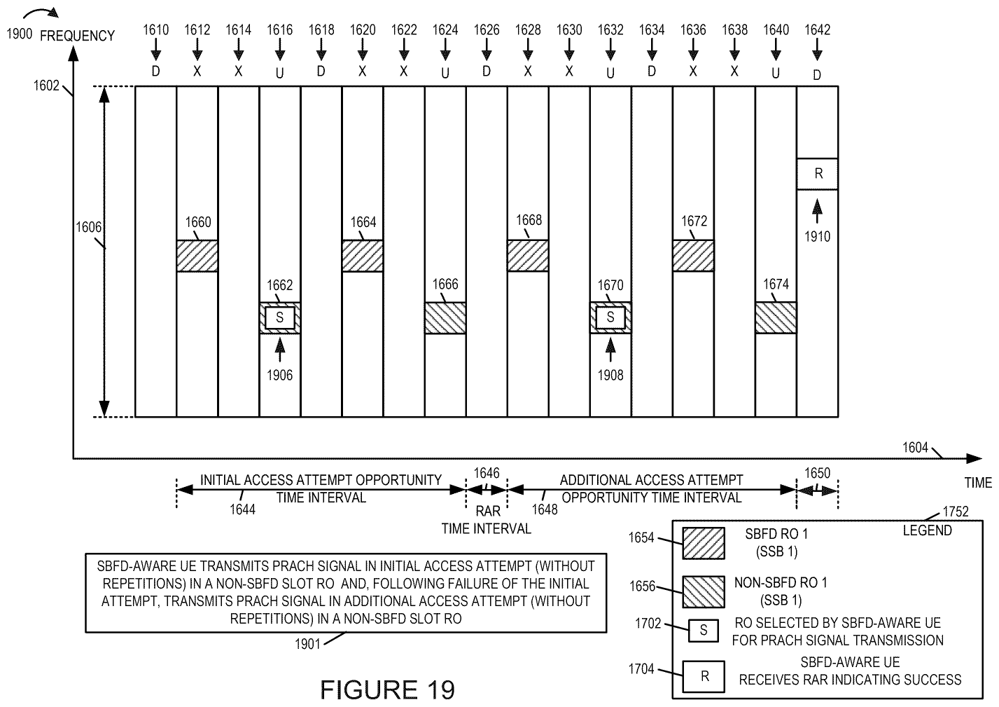

FIG. 19 is a drawing 1900 which illustrates an example in which a SBFD aware UE transmits a PRACH signal in an initial access attempt (without repetitions) in a non-SBFD slot RO, and following failure of the initial attempt, transmits a PRACH signal in an additional access attempt (without repetitions) in a non-SBFD slot RO, as indicated by information box 1901. The example of FIG. 19 is based on the timing frequency structure of FIG. 16.

FIG. 19 further includes legend 1752, which indicates that a SBFD RO which corresponds to SSB 1, is designated as SBFD RO 1, and is represented in the time-frequency drawing 1900 by a box 1654 with left to right ascending line shading. Legend 1752, further indicates that a non-SBFD RO which corresponds to SSB 1, is designated as non-SBFD RO 1, and is represented in the time-frequency drawing 1900 by a box 1656 with left to right descending line shading. Legend 1752 further indicates that a small box with “S” indicates that the identified RO, has been selected by the SBFD-aware UE for PRACH transmission. Exemplary RO selection criteria and methods are included in the flowchart of FIG. 5. Legend 1752 further indicates that a small box with “R” indicates that the SBFD aware UE has received a RAR indicating success.

In the example of FIG. 19, the SBFD-aware UE, which is using SSB 1, performs an initial access attempt (without repetitions) and transmits a PRACH signal in selected non-SBFD RO 1 1662 of non-SBFD slot 1616, as indicated by arrow 1906. In this example, the initial access attempt was a failure, and the UE did not receive a RAR message, indicating success, during RAR time interval 1646. In response to the failure, the SBFD-aware UE, performs an additional access attempt (without repetitions) and transmits a PRACH signal in selected non-SBFD RO 1 1670 of non-SBFD slot 1632, as indicated by arrow 1908. In this example, the additional access attempt was a success, and the UE receives a RAR message, indicating success, during RAR time interval 1650, as indicated by arrow 1910.

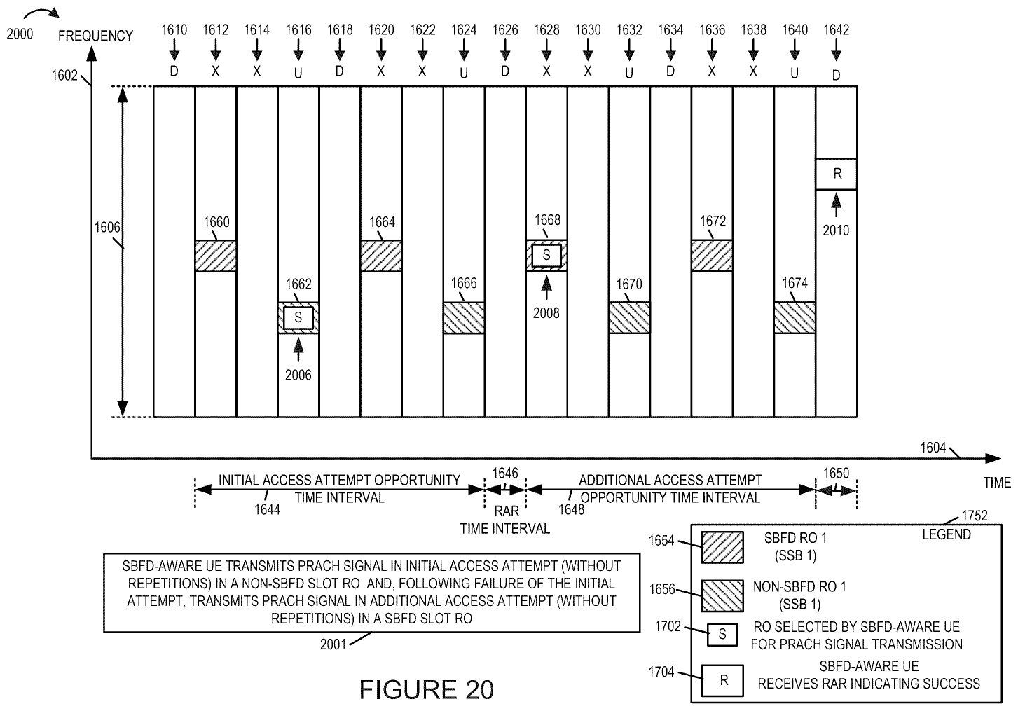

FIG. 20 is a drawing 2000 which illustrates an example in which a SBFD aware UE transmits a PRACH signal in an initial access attempt (without repetitions) in a non-SBFD slot RO, and following failure of the initial attempt, transmits a PRACH signal in an additional access attempt (without repetitions) in a SBFD slot RO, as indicated by information box 2001. The example of FIG. 20 is based on the timing frequency structure of FIG. 16.

FIG. 20 further includes legend 1752, which indicates that a SBFD RO which corresponds to SSB 1, is designated as SBFD RO 1, and is represented in the time-frequency drawing 2000 by a box 1654 with left to right ascending line shading. Legend 1752, further indicates that a non-SBFD RO which corresponds to SSB 1, is designated as non-SBFD RO 1, and is represented in the time-frequency drawing 2000 by a box 1656 with left to right descending line shading. Legend 1752 further indicates that a small box with “S” indicates that the identified RO, has been selected by the SBFD-aware UE for PRACH transmission. Exemplary RO selection criteria and methods are included in the flowchart of FIG. 5. Legend 1752 further indicates that a small box with “R” indicates that the SBFD aware UE has received a RAR indicating success.

In the example of FIG. 20, the SBFD-aware UE, which is using SSB 1, performs an initial access attempt (without repetitions) and transmits a PRACH signal in selected non-SBFD RO 1 1662 of non-SBFD slot 1616, as indicated by arrow 2006. In this example, the initial access attempt was a failure, and the UE did not receive a RAR message, indicating success, during RAR time interval 1646. In response to the failure, the SBFD-aware UE, performs an additional access attempt (without repetitions) and transmits a PRACH signal in selected SBFD RO 1 1668 of SBFD slot 1628, as indicated by arrow 2008. In this example, the additional access attempt was a success, and the UE receives a RAR message, indicating success, during RAR time interval 1650, as indicated by arrow 2010.

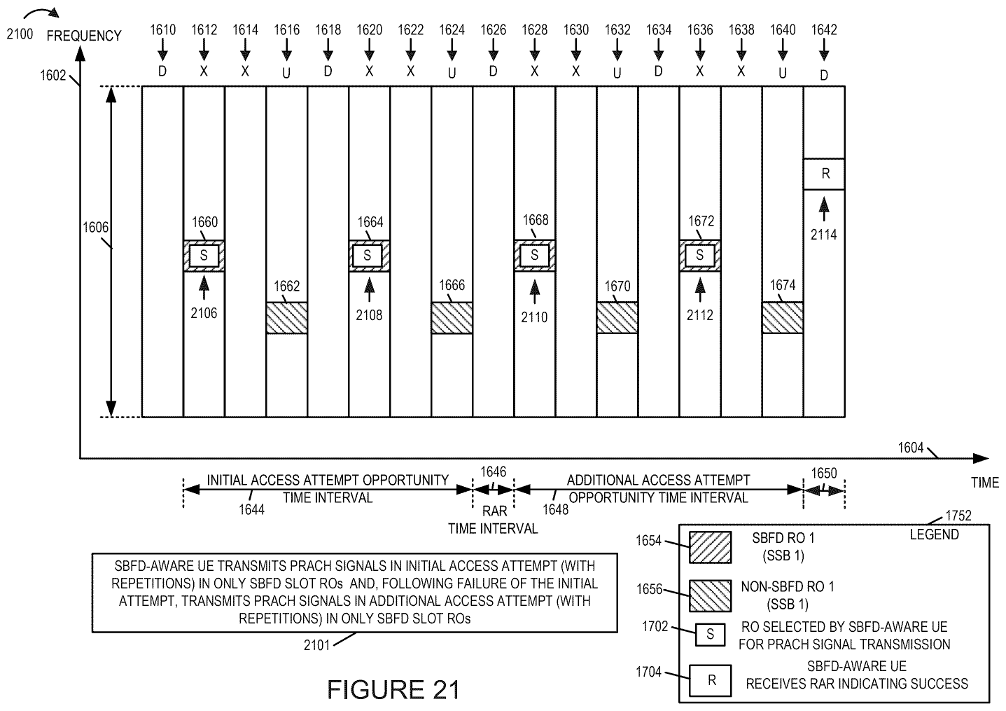

FIG. 21 is a drawing 2100 which illustrates an example in which a SBFD aware UE transmits PRACH signals in an initial access attempt (with repetitions) in only SBFD slot ROs, and following failure of the initial attempt, transmits PRACH signals in an additional access attempt (without repetitions) in only SBFD slot ROs, as indicated by information box 2101. The example of FIG. 21 is based on the timing frequency structure of FIG. 16.

FIG. 21 further includes legend 1752, which indicates that a SBFD RO which corresponds to SSB 1, is designated as SBFD RO 1, and is represented in the time-frequency drawing 2100 by a box 1654 with left to right ascending line shading. Legend 1752 further indicates that a non-SBFD RO which corresponds to SSB 1, is designated as non-SBFD RO 1, and is represented in the time-frequency drawing 2100 by a box 1656 with left to right descending line shading. Legend 1752 further indicates that a small box with “S” indicates that the identified RO, has been selected by the SBFD-aware UE for PRACH transmission. Exemplary RO selection criteria and methods are included in the flowchart of FIG. 5. Legend 1752 further indicates that a small box with “R” indicates that the SBFD aware UE has received a RAR indicating success.

In the example of FIG. 21, the SBFD-aware UE, which is using SSB 1, performs an initial access attempt (with repetitions) and transmits a PRACH signal in each of: selected SBFD RO 1 1660 of SBFD slot 1612, as indicated by arrow 2106 and selected SBFD RO 1 1664 of SBFD slot 1620, as indicated by arrow 2108. In this example, the initial access attempt was a failure, and the UE did not receive a RAR message, indicating success, during RAR time interval 1646. In response to the failure, the SBFD-aware UE, performs an additional access attempt (with repetitions) and transmits a PRACH signal in each of: selected SBFD RO 1 1668 of SBFD slot 1628, as indicated by arrow 2110, and selected SBFD RO 1 1672 of SBFD slot 1636, as indicated by arrow 2112. In this example, the additional access attempt was a success, and the UE receives a RAR message, indicating success, during RAR time interval 1650, as indicated by arrow 2114.

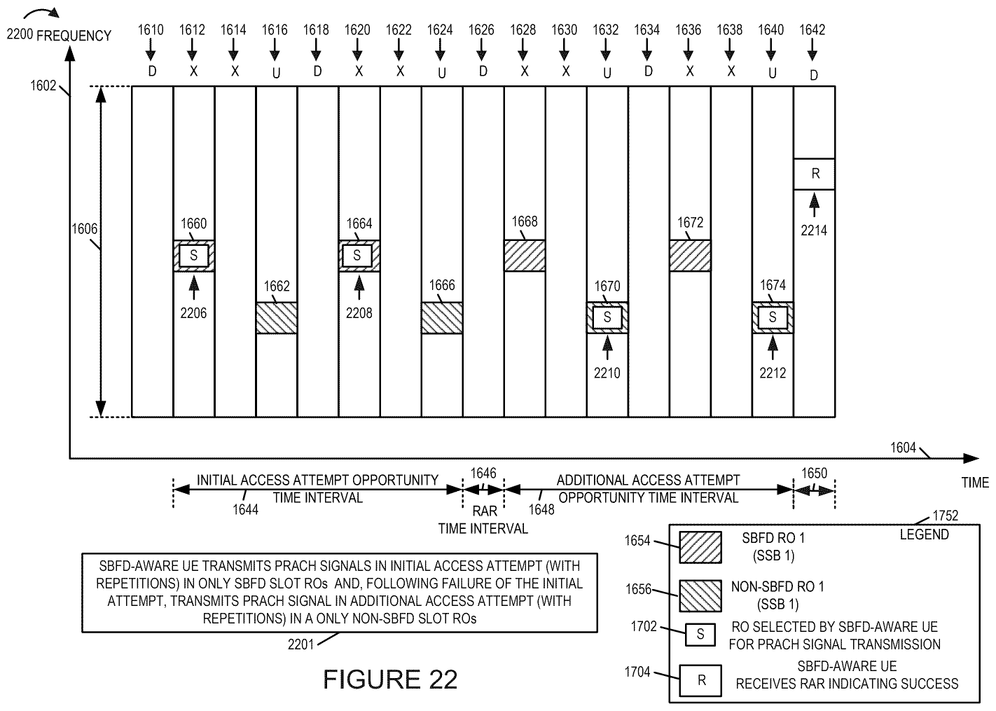

FIG. 22 is a drawing 2200 which illustrates an example in which a SBFD aware UE transmits PRACH signals in an initial access attempt (with repetitions) in only SBFD slot ROs, and following failure of the initial attempt, transmits PRACH signals in an additional access attempt (without repetitions) in only non-SBFD slot ROs, as indicated by information box 2201. The example of FIG. 22 is based on the timing frequency structure of FIG. 16.

FIG. 22 further includes legend 1752, which indicates that a SBFD RO which corresponds to SSB 1, is designated as SBFD RO 1, and is represented in the time-frequency drawing 2200 by a box 1654 with left to right ascending line shading. Legend 1752 further indicates that a non-SBFD RO which corresponds to SSB 1, is designated as non-SBFD RO 1, and is represented in the time-frequency drawing 2200 by a box 1656 with left to right descending line shading. Legend 1752 further indicates that a small box with “S” indicates that the identified RO, has been selected by the SBFD-aware UE for PRACH transmission. Exemplary RO selection criteria and methods are included in the flowchart of FIG. 5. Legend 1752 further indicates that a small box with “R” indicates that the SBFD aware UE has received a RAR indicating success.

In the example of FIG. 22, the SBFD-aware UE, which is using SSB 1, performs an initial access attempt (with repetitions) and transmits a PRACH signal in each of: selected SBFD RO 1 1660 of SBFD slot 1612, as indicated by arrow 2206 and selected SBFD RO 1 1664 of SBFD slot 1620, as indicated by arrow 2208. In this example, the initial access attempt was a failure, and the UE did not receive a RAR message, indicating success, during RAR time interval 1646. In response to the failure, the SBFD-aware UE, performs an additional access attempt (with repetitions) and transmits a PRACH signal in each of: selected non-SBFD RO 1 1670 of non-SBFD slot 1632, as indicated by arrow 2210, and selected non-SBFD RO 1 1674 of non-SBFD slot 1640, as indicated by arrow 2212. In this example, the additional access attempt was a success, and the UE receives a RAR message, indicating success, during RAR time interval 1650, as indicated by arrow 2214.

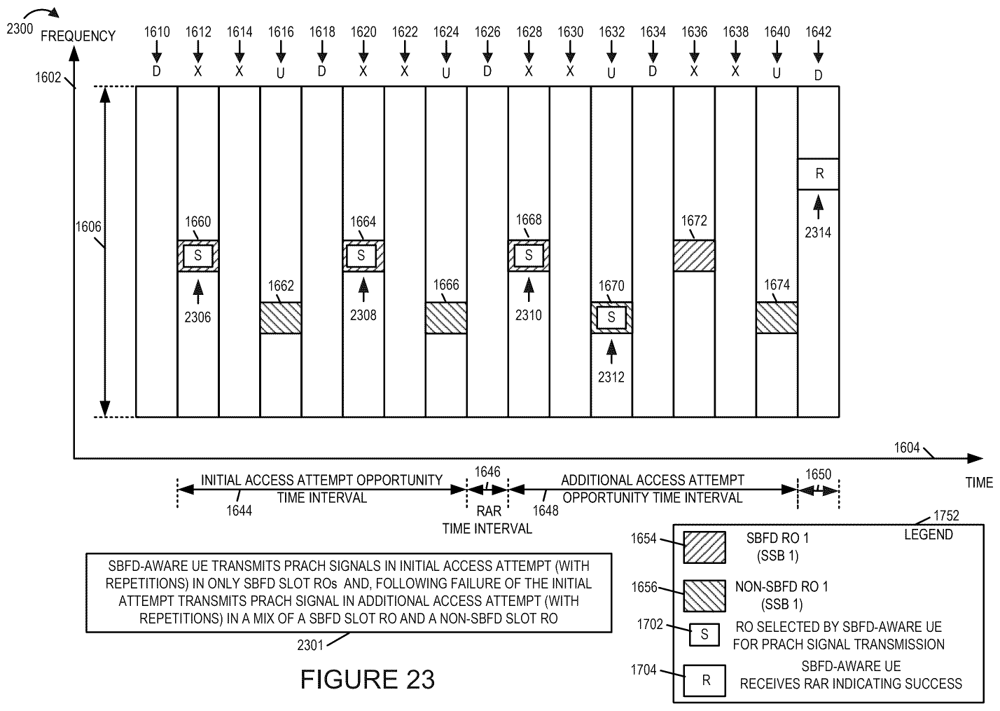

FIG. 23 is a drawing 2300 which illustrates an example in which a SBFD aware UE transmits PRACH signals in an initial access attempt (with repetitions) in only SBFD slot ROs, and following failure of the initial attempt, transmits PRACH signals in an additional access attempt (without repetitions) in a mix of a SBFD slot RO and a non-SBFD slot RO, as indicated by information box 2301. The example of FIG. 23 is based on the timing frequency structure of FIG. 16.

FIG. 23 further includes legend 1752, which indicates that a SBFD RO which corresponds to SSB 1, is designated as SBFD RO 1, and is represented in the time-frequency drawing 2300 by a box 1654 with left to right ascending line shading. Legend 1752 further indicates that a non-SBFD RO which corresponds to SSB 1, is designated as non-SBFD RO 1, and is represented in the time-frequency drawing 2300 by a box 1656 with left to right descending line shading. Legend 1752 further indicates that a small box with “S” indicates that the identified RO, has been selected by the SBFD-aware UE for PRACH transmission. Exemplary RO selection criteria and methods are included in the flowchart of FIG. 5. Legend 1752 further indicates that a small box with “R” indicates that the SBFD aware UE has received a RAR indicating success.

In the example of FIG. 23, the SBFD-aware UE, which is using SSB 1, performs an initial access attempt (with repetitions) and transmits a PRACH signal in each of: selected SBFD RO 1 1660 of SBFD slot 1612, as indicated by arrow 2306 and selected SBFD RO 1 1664 of SBFD slot 1620, as indicated by arrow 2308. In this example, the initial access attempt was a failure, and the UE did not receive a RAR message, indicating success, during RAR time interval 1646. In response to the failure, the SBFD-aware UE, performs an additional access attempt (with repetitions) and transmits a PRACH signal in each of: selected SBFD RO 1 1668 of SBFD slot 1628, as indicated by arrow 2310, and selected non-SBFD RO 1 1670 of non-SBFD slot 1632, as indicated by arrow 2312. In this example, the additional access attempt was a success, and the UE receives a RAR message, indicating success, during RAR time interval 1650, as indicated by arrow 2314.

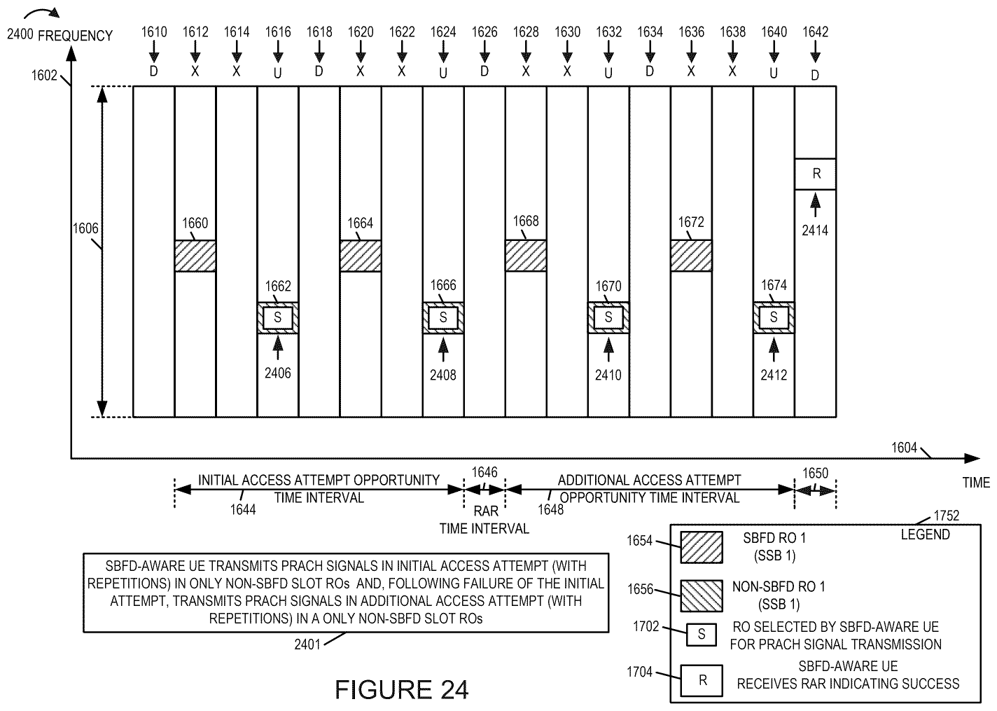

FIG. 24 is a drawing 2400 which illustrates an example in which a SBFD aware UE transmits PRACH signals in an initial access attempt (with repetitions) in only non-SBFD slot ROs, and following failure of the initial attempt, transmits PRACH signals in an additional access attempt (without repetitions) in only non-SBFD slot ROs, as indicated by information box 2401. The example of FIG. 24 is based on the timing frequency structure of FIG. 16.

FIG. 24 further includes legend 1752, which indicates that a SBFD RO which corresponds to SSB 1, is designated as SBFD RO 1, and is represented in the time-frequency drawing 2400 by a box 1654 with left to right ascending line shading. Legend 1752 further indicates that a non-SBFD RO which corresponds to SSB 1, is designated as non-SBFD RO 1, and is represented in the time-frequency drawing 2400 by a box 1656 with left to right descending line shading. Legend 1752 further indicates that a small box with “S” indicates that the identified RO, has been selected by the SBFD-aware UE for PRACH transmission. Exemplary RO selection criteria and methods are included in the flowchart of FIG. 5. Legend 1752 further indicates that a small box with “R” indicates that the SBFD aware UE has received a RAR indicating success.

In the example of FIG. 24, the SBFD-aware UE, which is using SSB 1, performs an initial access attempt (with repetitions) and transmits a PRACH signal in each of: selected non-SBFD RO 1 1662 of non-SBFD slot 1616, as indicated by arrow 2406 and selected non-SBFD RO 1 1666 of non-SBFD slot 1624, as indicated by arrow 2408. In this example, the initial access attempt was a failure, and the UE did not receive a RAR message, indicating success, during RAR time interval 1646. In response to the failure, the SBFD-aware UE, performs an additional access attempt (with repetitions) and transmits a PRACH signal in each of: selected non-SBFD RO 1 1670 of SBFD slot 1632, as indicated by arrow 2410, and selected non-SBFD RO 1 1674 of non-SBFD slot 1640, as indicated by arrow 2412. In this example, the additional access attempt was a success, and the UE receives a RAR message, indicating success, during RAR time interval 1650, as indicated by arrow 2414.

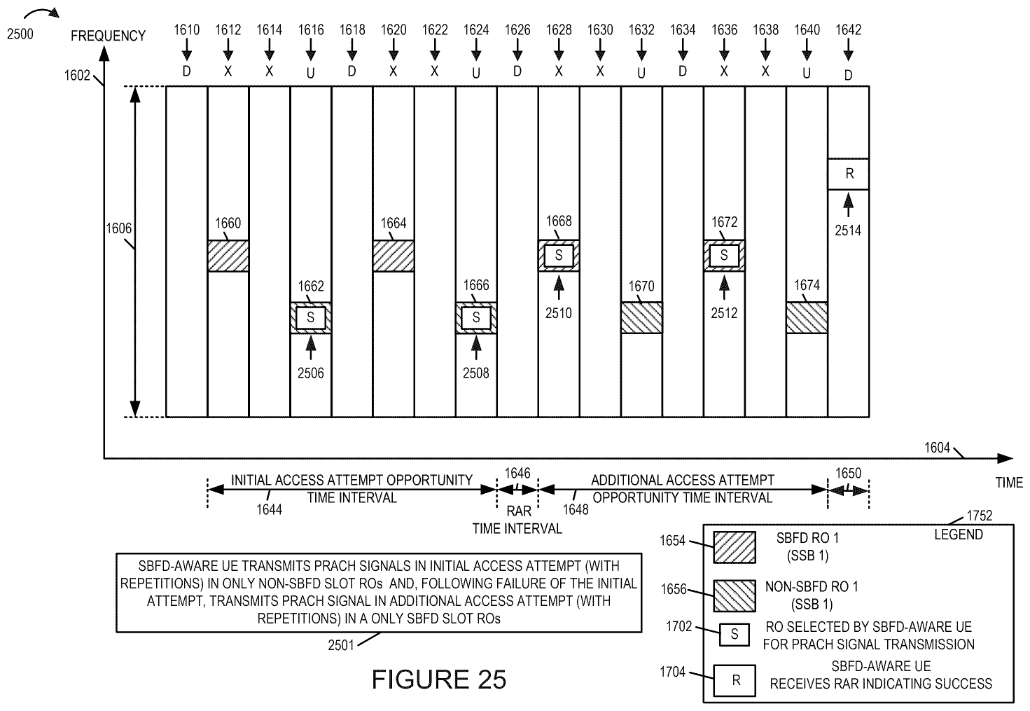

FIG. 25 is a drawing 2500 which illustrates an example in which a SBFD aware UE transmits PRACH signals in an initial access attempt (with repetitions) in only non-SBFD slot ROs, and following failure of the initial attempt, transmits PRACH signals in an additional access attempt (without repetitions) in only SBFD slot ROs, as indicated by information box 2501. The example of FIG. 25 is based on the timing frequency structure of FIG. 16.

FIG. 25 further includes legend 1752, which indicates that a SBFD RO which corresponds to SSB 1, is designated as SBFD RO 1, and is represented in the time-frequency drawing 2500 by a box 1654 with left to right ascending line shading. Legend 1752 further indicates that a non-SBFD RO which corresponds to SSB 1, is designated as non-SBFD RO 1, and is represented in the time-frequency drawing 2500 by a box 1656 with left to right descending line shading. Legend 1752 further indicates that a small box with “S” indicates that the identified RO, has been selected by the SBFD-aware UE for PRACH transmission. Exemplary RO selection criteria and methods are included in the flowchart of FIG. 5. Legend 1752 further indicates that a small box with “R” indicates that the SBFD aware UE has received a RAR indicating success.

In the example of FIG. 25, the SBFD-aware UE, which is using SSB 1, performs an initial access attempt (with repetitions) and transmits a PRACH signal in each of: selected non-SBFD RO 1 1662 of non-SBFD slot 1616, as indicated by arrow 2506 and selected non-SBFD RO 1 1666 of non-SBFD slot 1624, as indicated by arrow 2508. In this example, the initial access attempt was a failure, and the UE did not receive a RAR message, indicating success, during RAR time interval 1646. In response to the failure, the SBFD-aware UE, performs an additional access attempt (with repetitions) and transmits a PRACH signal in each of: selected SBFD RO 1 1668 of SBFD slot 1628, as indicated by arrow 2510, and selected SBFD RO 1 1672 of SBFD slot 1636, as indicated by arrow 2512. In this example, the additional access attempt was a success, and the UE receives a RAR message, indicating success, during RAR time interval 1650, as indicated by arrow 2514.

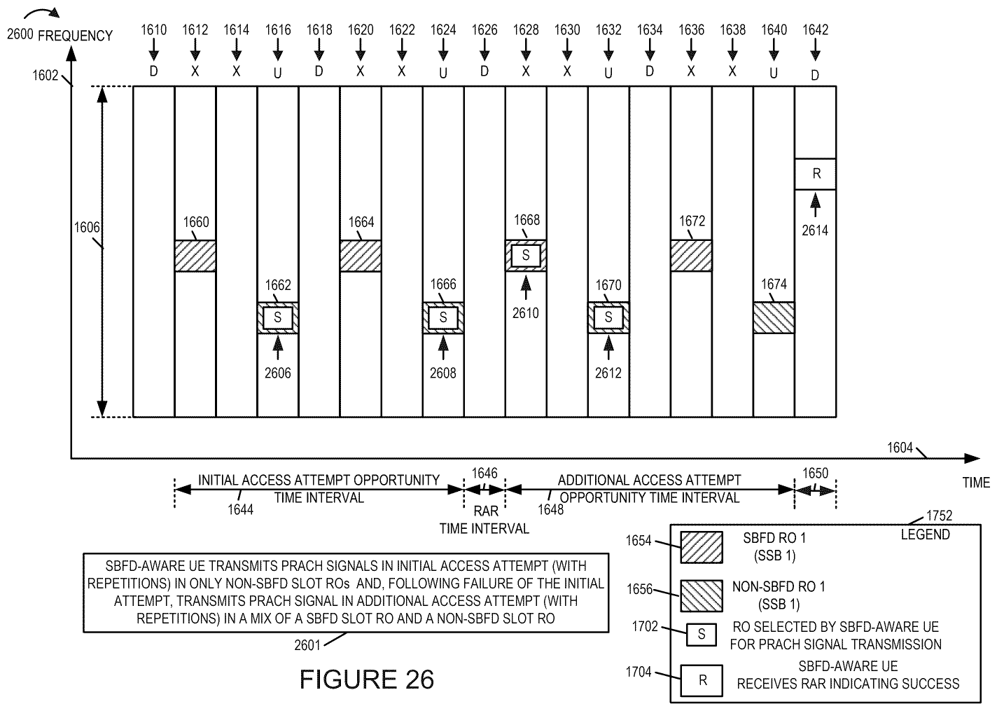

FIG. 26 is a drawing 2600 which illustrates an example in which a SBFD aware UE transmits PRACH signals in an initial access attempt (with repetitions) in only non-SBFD slot ROs, and following failure of the initial attempt, transmits PRACH signals in an additional access attempt (without repetitions) in a mix of a SBFD slot RO and a non-SBFD slot RO, as indicated by information box 2601. The example of FIG. 26 is based on the timing frequency structure of FIG. 16.

FIG. 26 further includes legend 1752, which indicates that a SBFD RO which corresponds to SSB 1, is designated as SBFD RO 1, and is represented in the time-frequency drawing 2600 by a box 1654 with left to right ascending line shading. Legend 1752 further indicates that a non-SBFD RO which corresponds to SSB 1, is designated as non-SBFD RO 1, and is represented in the time-frequency drawing 2600 by a box 1656 with left to right descending line shading. Legend 1752 further indicates that a small box with “S” indicates that the identified RO, has been selected by the SBFD-aware UE for PRACH transmission. Exemplary RO selection criteria and methods are included in the flowchart of FIG. 5. Legend 1752 further indicates that a small box with “R” indicates that the SBFD aware UE has received a RAR indicating success.

In the example of FIG. 26, the SBFD-aware UE, which is using SSB 1, performs an initial access attempt (with repetitions) and transmits a PRACH signal in each of: selected non-SBFD RO 1 1662 of non-SBFD slot 1616, as indicated by arrow 2606 and selected non-SBFD RO 1 1666 of non-SBFD slot 1624, as indicated by arrow 2608. In this example, the initial access attempt was a failure, and the UE did not receive a RAR message, indicating success, during RAR time interval 1646. In response to the failure, the SBFD-aware UE, performs an additional access attempt (with repetitions) and transmits a PRACH signal in each of: selected SBFD RO 1 1668 of SBFD slot 1628, as indicated by arrow 2610, and selected non-SBFD RO 1 1670 of non-SBFD slot 1632, as indicated by arrow 2612. In this example, the additional access attempt was a success, and the UE receives a RAR message, indicating success, during RAR time interval 1650, as indicated by arrow 2614.

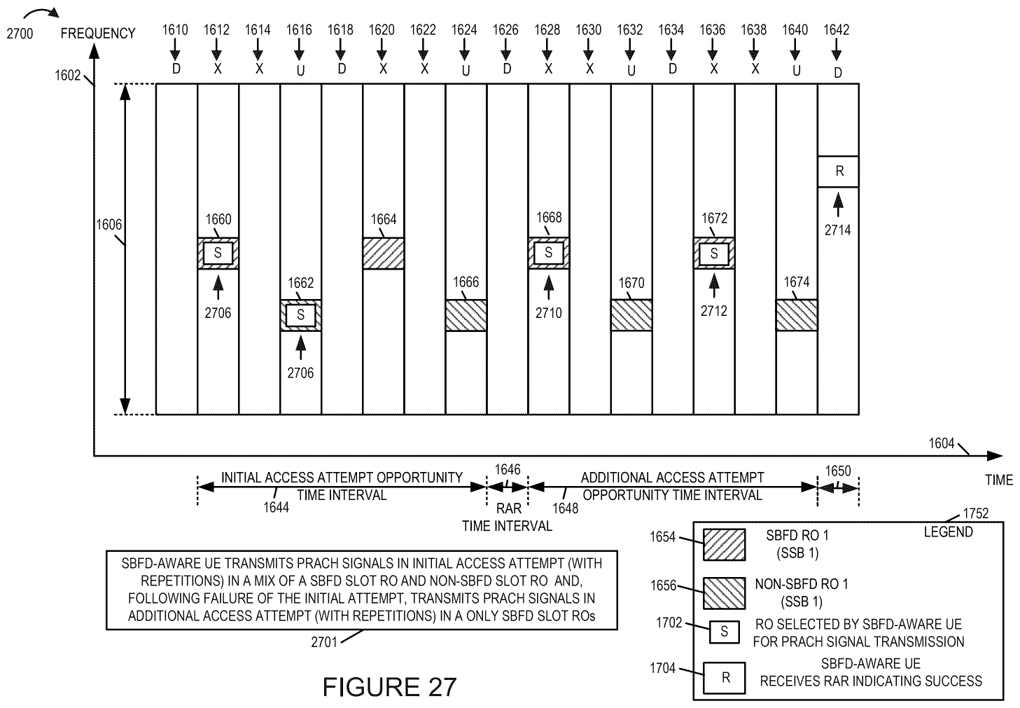

FIG. 27 is a drawing 2700 which illustrates an example in which a SBFD aware UE transmits PRACH signals in an initial access attempt (with repetitions) in a mix of a SBFD slot RO and a non-SBFD slot RO, and following failure of the initial attempt, transmits PRACH signals in an additional access attempt (without repetitions) in only SBFD slot ROs, as indicated by information box 2701. The example of FIG. 27 is based on the timing frequency structure of FIG. 16.

FIG. 27 further includes legend 1752, which indicates that a SBFD RO which corresponds to SSB 1, is designated as SBFD RO 1, and is represented in the time-frequency drawing 2700 by a box 1654 with left to right ascending line shading. Legend 1752 further indicates that a non-SBFD RO which corresponds to SSB 1, is designated as non-SBFD RO 1, and is represented in the time-frequency drawing 2700 by a box 1656 with left to right descending line shading. Legend 1752 further indicates that a small box with “S” indicates that the identified RO, has been selected by the SBFD-aware UE for PRACH transmission. Exemplary RO selection criteria and methods are included in the flowchart of FIG. 5. Legend 1752 further indicates that a small box with “R” indicates that the SBFD aware UE has received a RAR indicating success.

In the example of FIG. 27, the SBFD-aware UE, which is using SSB 1, performs an initial access attempt (with repetitions) and transmits a PRACH signal in each of: selected SBFD RO 1 1660 of SBFD slot 1612, as indicated by arrow 2706 and selected non-SBFD RO 1 1662 of non-SBFD slot 1616, as indicated by arrow 2708. In this example, the initial access attempt was a failure, and the UE did not receive a RAR message, indicating success, during RAR time interval 1646. In response to the failure, the SBFD-aware UE, performs an additional access attempt (with repetitions) and transmits a PRACH signal in each of: selected SBFD RO 1 1668 of SBFD slot 1628, as indicated by arrow 2710, and selected SBFD RO 1 1672 of SBFD slot 1636, as indicated by arrow 2712. In this example, the additional access attempt was a success, and the UE receives a RAR message, indicating success, during RAR time interval 1650, as indicated by arrow 2714.

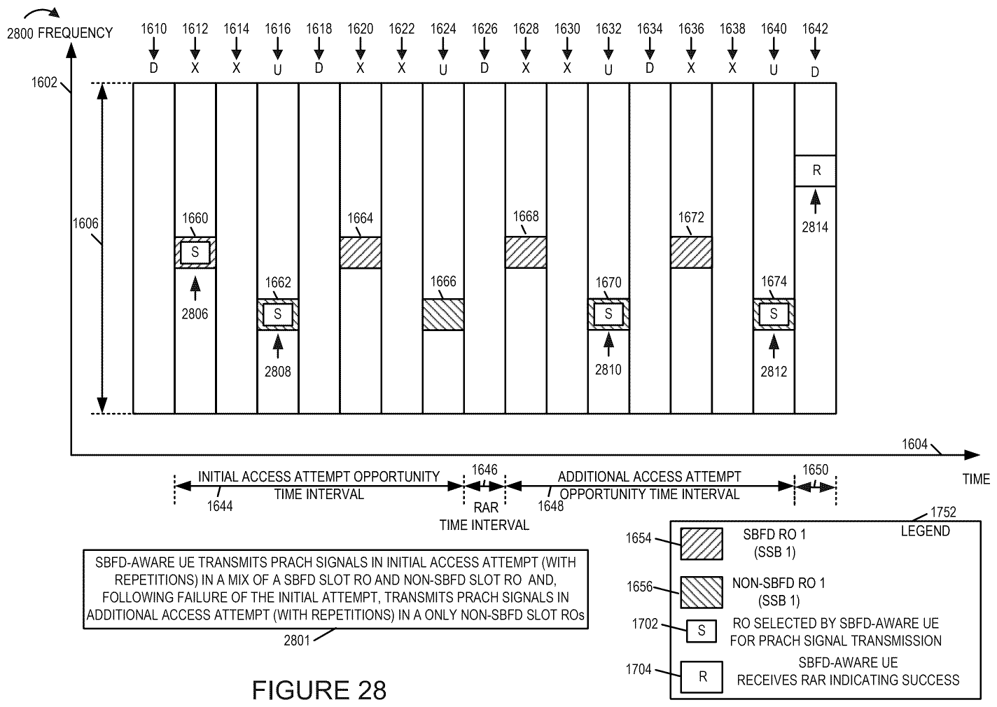

FIG. 28 is a drawing 2800 which illustrates an example in which a SBFD aware UE transmits PRACH signals in an initial access attempt (with repetitions) in a mix of a SBFD slot RO and a non-SBFD slot RO, and following failure of the initial attempt, transmits PRACH signals in an additional access attempt (without repetitions) in only non-SBFD slot ROs, as indicated by information box 2801. The example of FIG. 28 is based on the timing frequency structure of FIG. 16.

FIG. 28 further includes legend 1752, which indicates that a SBFD RO which corresponds to SSB 1, is designated as SBFD RO 1, and is represented in the time-frequency drawing 2800 by a box 1654 with left to right ascending line shading. Legend 1752 further indicates that a non-SBFD RO which corresponds to SSB 1, is designated as non-SBFD RO 1, and is represented in the time-frequency drawing 2800 by a box 1656 with left to right descending line shading. Legend 1752 further indicates that a small box with “S” indicates that the identified RO, has been selected by the SBFD-aware UE for PRACH transmission. Exemplary RO selection criteria and methods are included in the flowchart of FIG. 5. Legend 1752 further indicates that a small box with “R” indicates that the SBFD aware UE has received a RAR indicating success.

In the example of FIG. 28, the SBFD-aware UE, which is using SSB 1, performs an initial access attempt (with repetitions) and transmits a PRACH signal in each of: selected SBFD RO 1 1660 of SBFD slot 1612, as indicated by arrow 2806 and selected non-SBFD RO 1 1662 of non-SBFD slot 1616, as indicated by arrow 2808. In this example, the initial access attempt was a failure, and the UE did not receive a RAR message, indicating success, during RAR time interval 1646. In response to the failure, the SBFD-aware UE, performs an additional access attempt (with repetitions) and transmits a PRACH signal in each of: selected non-SBFD RO 1 1670 of SBFD slot 1632, as indicated by arrow 2810, and selected non-SBFD RO 1 1674 of non-SBFD slot 1640, as indicated by arrow 2812. In this example, the additional access attempt was a success, and the UE receives a RAR message, indicating success, during RAR time interval 1650, as indicated by arrow 2814.

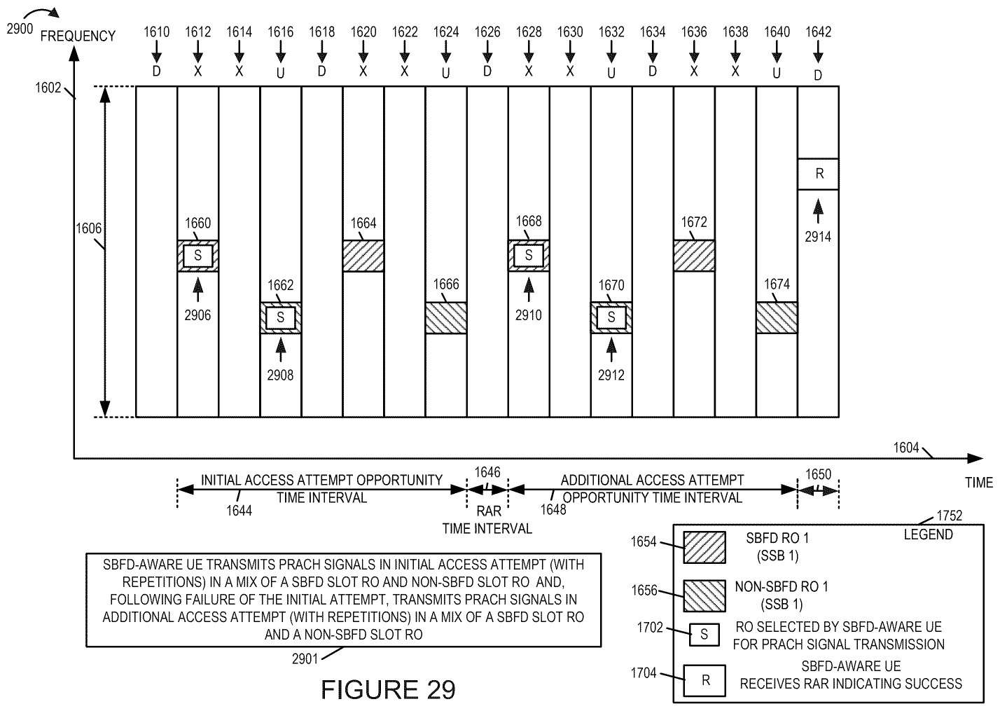

FIG. 29 is a drawing 2900 which illustrates an example in which a SBFD aware UE transmits PRACH signals in an initial access attempt (with repetitions) in a mix of a SBFD slot RO and a non-SBFD slot RO, and following failure of the initial attempt, transmits PRACH signals in an additional access attempt (without repetitions) in a mix of a SBFD slot RO and a non-SBFD slot RO, as indicated by information box 2901. The example of FIG. 29 is based on the timing frequency structure of FIG. 16.

FIG. 29 further includes legend 1752, which indicates that a SBFD RO which corresponds to SSB 1, is designated as SBFD RO 1, and is represented in the time-frequency drawing 2900 by a box 1654 with left to right ascending line shading. Legend 1752 further indicates that a non-SBFD RO which corresponds to SSB 1, is designated as non-SBFD RO 1, and is represented in the time-frequency drawing 2900 by a box 1656 with left to right descending line shading. Legend 1752 further indicates that a small box with “S” indicates that the identified RO, has been selected by the SBFD-aware UE for PRACH transmission. Exemplary RO selection criteria and methods are included in the flowchart of FIG. 5. Legend 1752 further indicates that a small box with “R” indicates that the SBFD aware UE has received a RAR indicating success.

In the example of FIG. 29, the SBFD-aware UE, which is using SSB 1, performs an initial access attempt (with repetitions) and transmits a PRACH signal in each of: selected SBFD RO 1 1660 of SBFD slot 1612, as indicated by arrow 2906 and selected non-SBFD RO 1 1662 of non-SBFD slot 1616, as indicated by arrow 2908. In this example, the initial access attempt was a failure, and the UE did not receive a RAR message, indicating success, during RAR time interval 1646. In response to the failure, the SBFD-aware UE, performs an additional access attempt (with repetitions) and transmits a PRACH signal in each of: selected SBFD RO 1 1668 of SBFD slot 1628, as indicated by arrow 2910, and selected non-SBFD RO 1 1670 of non-SBFD slot 1632, as indicated by arrow 2912. In this example, the additional access attempt was a success, and the UE receives a RAR message, indicating success, during RAR time interval 1650, as indicated by arrow 2914.

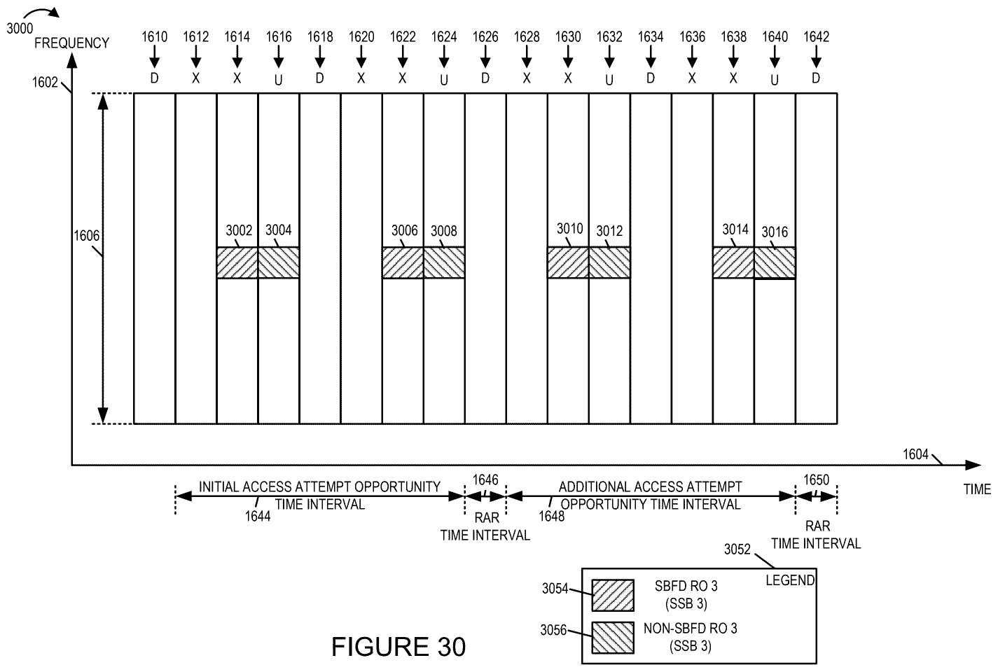

FIG. 30 is a drawing 3000 illustrating an exemplary timing frequency structure including downlink slots, SBFD slots, and uplink slots, in accordance with an exemplary embodiment. The downlink slots carry DL signals. The SBFD slots can carry both downlink and uplink signals, and the uplink slots carry uplink signals. Vertical axis 1602 represents frequency while horizontal axis 1604 represents time. The UL slots are sometimes referred to as non-SBFD slots. Portions of the UL slots are typically used for RACH occasions (ROs). The SBFD slots, represented by X, are predominately used for DL, but include a portion used for uplink, e.g., a portion used for RACH Occasions (ROs). An exemplary slot duration 1608 is shown for slot 1610. For simplicity a pattern of DXXU is shown, which corresponds to a TDD slot pattern of DDDU, although a common choice in practice is DDDDU. Sets of ROs are defined for each of a plurality of SSBs. For simplicity only the ROs, corresponding to SSB1, are shown in FIG. 30; however, it should be appreciated that there are actually sets of ROs corresponding to each SSB beam. FIG. 7 illustrates an exemplary structure showing ROs corresponding to different SSBs.

Drawing 3000 illustrates that the exemplary timing-frequency structure includes the following sequency of slots (downlink slot 1610, SBFD slot 1612, SBFD slot 1614, uplink (non-SBFD) slot 1616, downlink slot 1618, SBFD slot 1620, SBFD slot 1622, uplink (non-SBFD) slot 1624, downlink slot 1626, SBFD slot 1628, SBFD slot 1630, uplink (non-SBFD) slot 1632, downlink slot 1634, SBFD slot 1636, SBFD slot 1638, uplink (non-SBFD) slot 1640, and downlink slot 1642.

FIG. 30 further includes a legend 3052, which indicates that a SBFD RO which corresponds to SSB 3, is designated as SBFD RO 3, and is represented in the time-frequency drawing 3000 by a box 3054 with left to right ascending line shading. Legend 3052, further indicates that a non-SBFD RO which corresponds to SSB 3, is designated as non-SBFD RO 3, and is represented in the time-frequency drawing 3000 by a box 3056 with left to right descending line shading.

SBFD slot 1614 includes SBFD RO 3 3002. Uplink (non-SBFD) slot 3016 includes non-SBFD RO 3062. SBFD slot 1622 includes SBFD RO 3 3006. Uplink (non-SBFD) slot 1624 includes non-SBFD RO 3 3008. SBFD slot 1630 includes SBFD RO 3010. Uplink (non-SBFD) slot 1632 includes non-SBFD RO 3 3012. SBFD slot 1638 includes SBFD RO 3 3014. Uplink (non-SBFD) slot 1640 includes non-SBFD RO 3 3016.

In this example, time interval 1644 represents an initial access opportunity time interval during which a UE, attempting to obtain access, may send one or more PRACH signals to the base station using one or more ROs. Time interval 1646, which maps to downlink slot 1626, corresponds to a RAR time interval, during which the base station may send a RAR signal, indicating success, to a UE, which sent a PRACH signal using a RO during the initial access attempt opportunity time interval 1644. Time interval 1648 represents an additional access opportunity time interval, which may be used by a UE, which failed to obtain access from its PRACH signal attempt(s) during the initial access attempt opportunity, e.g., did not receive a RAR indicating success during RAR time interval 1646. Time interval 1650, which maps to downlink slot 1642, corresponds to a RAR time interval, during which the base station may send a RAR signal, indicating success, to a UE which sent a PRACH signal using a RO during the additional access attempt opportunity time interval 1648.

In the example of FIG. 30, the SBFD ROs and non-SBFD ROs corresponding to SSB 3, use the same frequency block and there is no frequency hopping when switching between a SBFD RO and a non-SBFD RO. The example scenarios described with respect to FIG. 17-29 for a SBFD-aware UE operating on SSB 1, can be extended to the scenario of FIG. 30, except no frequency hopping is involved.

Various exemplary numbered embodiments will now be described.

### NUMBERED EXEMPLARY METHOD EMBODIMENTS

Numbered method embodiment 1 relates to a single transmission access attempt or an access attempt including multiple repeat transmissions as part of an access attempt since the multiple transmission case includes at least one signal transmission.

Numbered method embodiment 1. A method of operating a UE, the method comprising: operating (586 or 590) a UE to transmit a PRACH signal as part of an initial access attempt (578) using a first symbol, said first symbol being a non-SBFD symbol or SBFD symbol in a timing structure including both non-SBFD symbols and SBFD symbols (it is to be understood that the invention can also apply to slots but slots include symbols of a type corresponding to the type of slot, e.g., SBFD symbols are in SBFD slots and non-SBFD symbols are in non-SBFD slots, and thus the claim is written using symbol language); detecting (600) failure of the initial access attempt; and performing (662) an additional access attempt, said step of performing an additional access attempt including transmitting (669 or 672) a PRACH signal using a second symbol corresponding to a second time slot following a first time slot, in which said first symbol used for the initial access attempt was located.

Numbered method embodiment 1A. The method of numbered method embodiment 1, wherein said PRACH signal transmitted as part of an initial access attempt is transmitted on an RACH Occasion (RO).

Numbered method embodiment 1AA. The method of numbered method embodiment 1, wherein the UE is an SBFD capable UE; and wherein the method further comprises: deciding (520) based on a reference signal received power (RSRP) (e, g, SSB-RSRP), prior to performing the initial access attempt, whether to perform the initial access attempt without PRACH signal repetitions or with PRACH signal repetitions.

Numbered method embodiment 1AB. The method of numbered method embodiment 1AA, wherein said step of deciding whether to perform the initial access attempt without PRACH signal repetitions or with PRACH signal repetitions includes deciding (524) to perform the initial access attempt without PRACH signal repetition when the RSRP is above a first threshold (e.g., Threshold_1 used to distinguish when a single initial access attempt is likely to be successful given the RSRP exceeding the predetermined threshold level).

Numbered method embodiment 1AC. The method of numbered method embodiment 1AB, wherein the RSRP exceeds the first threshold; wherein the decision is to perform the initial access attempt without PRACH signal repetitions; and wherein the method further comprises: selecting (528) an RO to use to communicate a PRACH signal as part of the initial access attempt based on at least one of: i) the reference signal received power (RSRP) (see, e.g., step 534); i) the earliest available RO for initial access attempt (e.g., first available slot) (see, e.g., step 544); or iii) whether ROs in SBFD slots have a smaller association period than ROs in non-SBFD slots (see step 550).

Numbered method embodiment 1AD. The method of numbered method embodiment 1AC wherein selecting (528) an RO to use to communicate a PRACH signal as part of the initial access attempt includes selecting (536) an RO corresponding to a SBFD slot when the RSRP is over a second threshold.

Numbered method embodiment 1AE. The method of numbered method embodiment 1AC wherein selecting (528) an RO to use to communicate a PRACH signal as part of the initial access attempt includes selecting (540) a RO which corresponds to a SBFD slot for communicating a PRACH signal when an RO in an SBFD slot is available earlier than an RO in a non-SBFD slot.

Numbered method embodiment 1AF. The method of numbered method embodiment 1AC wherein selecting (528) an RO to use to communicate a PRACH signal as part of the initial access attempt includes selecting (550) an RO in a SBFD slot when ROs in SBFD slots have a smaller association period than ROs in non-SBFD slots.

Numbered method embodiment 1AG. The method of numbered method embodiment 1AA, wherein said step of deciding (520) whether to perform the initial access attempt without PRACH signal repetitions or with PRACH signal repetitions includes deciding (526) to perform the initial access attempt with PRACH signal repetitions; and wherein the method further comprises: selecting (558) ROs corresponding to one type of slot to use for the multiple PRACH signal repetitions based on a received signal power, said one type of slot be a SBFD type of slot or a non-SBFD type of slot (e.g., operate SBFD capable UE to select (564) ROs corresponding to only non-SBFD slots for communicating multiple PRACH signal repetitions when SSB-RSRP is below a third threshold and select (566) ROs which correspond to only SBFD slots for multiple PRACH signal repetitions when SSB-RSRP is not below the third threshold).

Numbered method embodiment 1AG1. The method of numbered method embodiment 1AA, wherein said step of deciding (520) whether to perform the initial access attempt without PRACH signal repetitions or with PRACH signal repetitions includes deciding (526) to perform the initial access attempt with PRACH signal repetitions; and wherein the method further comprises: selecting (560) ROs based on PRACH transmission attempt time.

Numbered method embodiment 1AH. The method of numbered method embodiment 1AG1, wherein selecting (560) ROs based on PRACH transmission attempt time includes determining (568) if combining ROs associated with an individual SSB, in SBFD slots and non-SBFD slots, will result in a faster PRACH repetition during one PRACH transmission attempt than using ROs in only one of SBFD or non-SBFD type slots.

Numbered method embodiment 1AI. The method of numbered method embodiment 1AH, wherein it is determined that wherein selecting (560) ROs based on PRACH transmission attempt time includes determining (568) that combining ROs (associated with an individual SSB,) in SBFD slots and non-SBFD slots, will result in a faster PRACH repetition during one PRACH transmission attempt than using ROs in only one of SBFD or non-SBFD type slots (e.g. Y decision of step 568); and wherein the method further comprises: operating the UE (e.g., SBFD capable UE) to select (576) ROs which include a mix of SBFD and non-SBFD slots for communicating multiple PRACH signal repetitions in the initial access attempt.

Numbered method embodiment 1AJ. The method of numbered method embodiment 1AA, further comprising: performing (578) the initial access attempt; detecting (600) failure of the initial access attempt; and selecting (612), for an additional access attempt, following detection of the failure of the initial access attempt, one or more RO to use for the additional access attempt.

Numbered method embodiment 1AK. The method of numbered method embodiment 1AJ, wherein selecting (612), for an additional access attempt, following detection of the failure of the initial access attempt, one or more RO to use for the additional access attempt includes: selecting (612) an RO to use to communicate a PRACH signal as part of the additional access attempt based on at least one of: i) the reference signal received power (RSRP) (see, e.g., step 614); i) the earliest available RO for the additional access attempt (e.g., first available slot) (see, e.g., step 624); or iii) whether ROs in SBFD slots have a smaller association period than ROs in non-SBFD slots (see step 626).

While numbered method claim 1 relates to a single transmission access attempt or an access attempt including multiple repeat transmissions, numbered method embodiment 1B set forth below is explicitly directed to the case where the initial access attempt includes multiple repeat transmissions prior to detecting the failure.

Numbered method embodiment 1B. The method of numbered method embodiment 1A, wherein said PRACH signal transmitted as part of the initial access attempt is transmitted as one of a plurality of PRACH signals transmitted as part of said initial access attempt, said plurality of PRACH signals transmitted as part of said initial access attempt being transmitted on symbols of the same type (e.g., if the first symbol used for the first transmission of the PRACH signal is on a non-SBFD symbol, the repeat transmission or transmissions will be on a non-SBFD symbol or non-SBFD symbols, and if the first symbol used for the first transmission of the PRACH signal is on a SBFD symbol the repeat transmission or transmissions will be on an SBFD symbol or SBFD symbols.

Numbered method embodiment 1C. The method of numbered method embodiment 1B wherein performing an additional access attempt by transmitting the PRACH signal using the second symbol corresponding to the second time slot follows the plurality of PRACH signals transmitted as part of said initial access attempt and is part of transmitting a plurality of PRACH signals as part of said additional access attempt which follows detection of the failure of the initial access attempt.

Numbered method embodiment 1D. The method of numbered method embodiment 1C wherein performing an additional access attempt by transmitting the PRACH signal using the second symbol corresponding to the second time slot follows the plurality of PRACH signals transmitted as part of said initial access attempt and is part of transmitting a plurality of PRACH signals as part of said additional access attempt which follows detection of the failure of the initial access attempt.

Numbered method embodiment 1E. The method of numbered method embodiment 1D, wherein the plurality of PRACH signals transmitted as part of said additional access attempt are transmitted using symbols of the same type used during said initial access attempt (e.g., all non-SBFD symbols or all SBFD symbols).

Numbered method embodiment 1E1. The method of numbered method embodiment 1E, wherein the plurality of PRACH signals transmitted as part of said additional access attempt are transmitted using slots of the same type used during said initial access attempt (e.g., all non-SBFD slots or all non-SBFD slots).

Numbered method embodiment 1F. The method of numbered method embodiment 1D, wherein the plurality of PRACH signals transmitted as part of said additional access attempt are transmitted using symbols of a different type than the type used during said initial access attempt (e.g., if all non-SBFD symbols used during the initial access attempt, then use or all SBFD symbols during the additional access attempt or if all SBFD symbols used during the initial access attempt, then use or all non-SBFD symbols during the additional access attempt).

Numbered method embodiment 1F1. The method of numbered method embodiment 1F1, wherein the plurality of PRACH signals transmitted as part of said additional access attempt are transmitted using slots of a different type than the type used during said initial access attempt (e.g., if all non-SBFD slots used during the initial access attempt, then use or all SBFD slots during the additional access attempt or if all SBFD slots used during the initial access attempt, then use or all SBFD slots during the additional access attempt).

Numbered method embodiment 2. The method of numbered method embodiment 1, wherein said the second symbol is the same type of symbol as the first symbol.

Numbered method embodiment 3. The method of numbered method embodiment 2, wherein UE is a non-SBFD capable UE; and wherein the first symbol is a non-SBFD symbol (e.g., non-SBFD capable UEs are limited to using non-SBFD symbols for access attempts).

Numbered method embodiment 4. The method of numbered method embodiment 2, wherein the UE is an SBFD capable UE; wherein the first symbol is a SBFD symbol; and wherein the second symbol is an SBFD symbol (in some cases when an SBFD capable UE transmits the initial access attempt in a SBFD symbol or slot it will limit corresponding additional access attempts to symbols/slots of the same type however this is not the case in all embodiments).

Numbered method embodiment 5. The method of numbered method embodiment 1, wherein the UE is an SBFD capable UE; wherein the first symbol is a non-SBFD symbol; and wherein the second symbol is either a non-SBFD symbol or an SBFD symbol, the method comprising: operating the UE to select (624) for the additional access attempt, following detection(684) of a failed initial access attempt, a first available RACH Occasion (RO) regardless of whether the first available RO corresponds to a non-SBFD slot or a SBFD slot (e.g., SBFD capable UEs will make the most in terms of use of the available ROs in some embodiments to reduce the amount of time between an initial failed access attempt and a subsequent access attempt retry).

Numbered method embodiment 6. The method of numbered method embodiment 5, wherein the additional access attempt includes transmitting a PRACH signal at a different frequency than the frequency used to transmit the PRACH signal as part of the initial access attempt, when the first and second symbols are different types of symbols (e.g., frequency hopping is supported and a retransmission at a different frequency from the frequency used to transmit the initial access attempt is permitted).

Numbered method embodiment 7. The method of numbered method embodiment 6, wherein the method includes using a first frequency for transmitting the PRACH signal in a non-SBFD slot as part of the initial access attempt and using a second frequency for transmitting the PRACH signal in an SBFD slot as part of the additional access attempt, said second frequency being different than said first frequency.

Numbered method embodiment 8. The method of numbered method embodiment 6, further comprising: using the same frequency for transmitting the PRACH signal as part of the initial access attempt and for transmitting the PRACH signal as part of the additional access attempt when the first and second symbols correspond to slots of the same type (e.g., if the initial and additional attempt are in non-SBFD symbols they use the same frequency in some embodiments).

Numbered method embodiment 5A. The method of numbered method embodiment 1, wherein the UE is an SBFD capable UE; wherein the first symbol is a SBFD symbol; and wherein the second symbol is either a non-SBFD symbol or an SBFD symbol, the method comprising: operating the UE to select (624) for the additional access attempt, following detection (684) of a failed initial access attempt, a first available RACH Occasion (RO) regardless of whether the first available RO corresponds to a non-SBFD slot or a SBFD slot (e.g., SBFD capable UEs will make the most in terms of use of the available ROs in some embodiments to reduce the amount of time between an initial failed access attempt and a subsequent access attempt retry).

Numbered method embodiment 6A. The method of numbered method embodiment 5A, wherein the additional access attempt includes transmitting a PRACH signal at a different frequency than the frequency used to transmit the PRACH signal as part of the initial access attempt, when the first and second symbols are different types of symbols (e.g., frequency hopping is supported and a retransmission at a different frequency from the frequency used to transmit the initial access attempt is permitted).

Numbered method embodiment 7A. The method of numbered method embodiment 6A, wherein the method includes using a first frequency for transmitting the PRACH signal in a SBFD slot as part of the initial access attempt and using a second frequency for transmitting the PRACH signal in a non-SBFD slot as part of the additional access attempt, said second frequency being different than said first frequency.

Numbered method embodiment 8A. The method of numbered method embodiment 6A, further comprising:
using the same frequency for transmitting the PRACH signal as part of the initial access attempt and for transmitting the PRACH signal as part of the additional access attempt when the first and second symbols correspond to slots of the same type.

### LITS OF EXEMPLARY NUMBERED APPARATUS EMBODIMENTS

Numbered apparatus embodiment 1. A user Equipment (UE) (106, 108, 110, 112, 114, 116, 118, 120, 300 or 400), comprising: a receiver (324 or 424) for receiving information (e.g., SIB 1 information); a transmitter (326 or 426) (e.g., capable of transmitting signals (e.g., a PRACH signal including a Preamble (e.g., a msg-1-PRACH signal as part of a 4 step access attempt) on a PRACH); a processor (302 or 402) configured to control the UE to: transmit (586 or 590) a PRACH signal on a as part of an initial access attempt using a first symbol, said first symbol being a non-SBFD symbol or SBFD symbol in a timing structure including both non-SBFD symbols and SBFD symbols (it is to be understood that the invention can also apply to slots but slots include symbols of a type corresponding to the type of slot, e.g., SBFD symbols are in SBFD slots and non-SBFD symbols are in non-SBFD slots and thus the claim is written using symbol language); detect (600) failure of the initial access attempt (e.g., assuming the initial access attempt was not successful); and perform (662) an additional access attempt including transmitting (669 or 672) a PRACH signal using a second symbol corresponding to a second time slot following a first time slot in which said first symbol used for the initial access attempt was located.

Numbered apparatus embodiment 1A. The UE of numbered apparatus embodiment 1, wherein said PRACH signal transmitted as part of an initial access attempt is transmitted on a RACH Occasion (RO).

Numbered apparatus embodiment 1AA. The UE of numbered apparatus embodiment 1, wherein the UE is an SBFD capable UE (106, 108, 114 or 116 or 300); and wherein the processor (302) is further configured to control the UE to: decide (520) based on a reference signal received power (RSRP) (e, g, SSB-RSRP), prior to performing the initial access attempt, whether to perform the initial access attempt without PRACH signal repetitions or with PRACH signal repetitions.

Numbered apparatus embodiment 1AB. The UE of numbered apparatus embodiment 1AA, wherein said step of deciding whether to perform the initial access attempt without PRACH signal repetitions or with PRACH signal repetitions includes deciding (524) to perform the initial access attempt without PRACH signal repetition when the RSRP is above a first threshold (e.g., Threshold_1 used to distinguish when a single initial access attempt is likely to be successful given the RSRP exceeding the predetermined threshold level).

Numbered apparatus embodiment 1AC. The UE of numbered apparatus embodiment 1AB, wherein the RSRP exceeds the first threshold; wherein the decision is to perform the initial access attempt without PRACH signal repetitions; and wherein the processor (302) is further configured to control the UE to: select (528) an RO to use to communicate a PRACH signal as part of the initial access attempt based on at least one of: i) the reference signal received power (RSRP) (see, e.g., step 534); i) the earliest available RO for initial access attempt (e.g., first available slot) (see, e.g., step 544); or iii) whether ROs in SBFD slots have a smaller association period than ROs in non-SBFD slots (see step 550).

Numbered apparatus embodiment 1AD. The UE of numbered apparatus embodiment 1AC, wherein said processor (302) is configured to control the UE to:
select (536) an RO corresponding to a SBFD slot when the RSRP is over a second threshold, as part of being configured to select (528) an RO to use to communicate a PRACH signal as part of the initial access attempt.

Numbered apparatus embodiment 1AE. The UE of numbered apparatus embodiment 1AC, wherein said processor (302) is configured to control the UE to: select (540) a RO which corresponds to a SBFD slot for communicating a PRACH signal when an RO in an SBFD slot is available earlier than an RO in a non-SBFD slot, as part of being configured to control the UE to select (528) an RO to use to communicate a PRACH signal as part of the initial access attempt.

Numbered apparatus embodiment 1AF. The UE of numbered apparatus embodiment 1AC wherein said processor (302) is configured to control the UE to:
select (550) an RO in a SBFD slot when ROs in SBFD slots have a smaller association period than ROs in non-SBFD slots, as part of being configured to control the UE to select (528) an RO to use to communicate a PRACH signal as part of the initial access attempt.

Numbered apparatus embodiment 1AG. The UE of numbered apparatus embodiment 1AA, wherein said step of deciding (520) whether to perform the initial access attempt without PRACH signal repetitions or with PRACH signal repetitions includes deciding (526) to perform the initial access attempt with PRACH signal repetitions; and wherein the processor (302) is further configured to control the UE to: select (558) ROs corresponding to one type of slot to use for the multiple PRACH signal repetitions based on a received signal power, said one type of slot be a SBFD type of slot or a non-SBFD type of slot (e, g,. operate SBFD capable UE to select (564) ROs corresponding to only non-SBFD slots for communicating multiple PRACH signal repetitions when SSB-RSRP is below a third threshold and select (566) ROs which correspond to only SBFD slots for multiple PRACH signal repetitions when SSB-RSRP is not below the third threshold).

Numbered apparatus embodiment 1AG1. The UE of numbered apparatus embodiment 1AA, wherein said step of deciding (520) whether to perform the initial access attempt without PRACH signal repetitions or with PRACH signal repetitions includes deciding (526) to perform the initial access attempt with PRACH signal repetitions; and wherein the processor (302) is further configured to control the UE to: select (560) ROs based on PRACH transmission attempt time.

Numbered apparatus embodiment 1AH. The UE of numbered apparatus embodiment 1AG1, wherein said processor (302) is configured to control the UE to: determine (568) if combining ROs associated with an individual SSB, in SBFD slots and non-SBFD slots, will result in a faster PRACH repetition during one PRACH transmission attempt than using ROs in only one of SBFD or non-SBFD type slots, as part of being configured to control the UE to select (560) ROs based on PRACH transmission attempt time.

Numbered apparatus embodiment 1AI. The UE of numbered apparatus embodiment 1AH, wherein it is determined that wherein selecting (560) ROs based on PRACH transmission attempt time includes determining (568) that combining ROs (associated with an individual SSB,) in SBFD slots and non-SBFD slots, will result in a faster PRACH repetition during one PRACH transmission attempt than using ROs in only one of SBFD or non-SBFD type slots (e.g. Y decision of step 568); and wherein the processor (302) is further configured to: operate the UE (e.g., SBFD capable UE) to select (576) ROs which include a mix of SBFD and non-SBFD slots for communicating multiple PRACH signal repetitions in the initial access attempt.

Numbered apparatus embodiment 1AJ. The UE of numbered apparatus embodiment 1AA, wherein said processor (302) is further configured to control the UE to: perform (578) the initial access attempt; detect (600) failure of the initial access attempt; and selecting (612), for an additional access attempt, following detection of the failure of the initial access attempt, one or more RO to use for the additional access attempt.

Numbered apparatus embodiment 1AK. The UE of numbered apparatus embodiment 1AJ, wherein said processor (302) is configured to control the UE to: select (612) an RO to use to communicate a PRACH signal as part of the additional access attempt based on at least one of: i) the reference signal received power (RSRP) (see, e.g., step 614); i) the earliest available RO for the additional access attempt (e.g., first available slot) (see, e.g., step 624); or iii) whether ROs in SBFD slots have a smaller association period than ROs in non-SBFD slots (see step 626), as part of being configured to control the UE to select (612), for an additional access attempt, following detection of the failure of the initial access attempt, one or more RO to use for the additional access attempt.

Numbered apparatus embodiment 1B The UE of numbered apparatus embodiment 1A, wherein said PRACH signal transmitted as part of the initial access attempt is transmitted as one of a plurality of PRACH signals transmitted as part of said initial access attempt, said plurality of PRACH signals transmitted as part of said initial access attempt being transmitted on symbols of the same type (e.g., if the first symbol used for the first transmission of the PRACH signal is on a non-SBFD symbol, the repeat transmission or transmissions will be on a non-SBFD symbol or non-SBFD symbols and if the first symbol used for the first transmission of the PRACH signal is on a SBFD symbol the repeat transmission or transmissions will be on an SBFD symbol or SBFD symbols.

Numbered apparatus embodiment 1C. The UE of numbered apparatus embodiment 1B wherein performing an additional access attempt by transmitting the PRACH signal using the second symbol corresponding to the second time slot follows the plurality of PRACH signals transmitted as part of said initial access attempt and is part of transmitting a plurality of PRACH signals as part of said additional access attempt which follows detection of the failure of the initial access attempt.

Numbered apparatus embodiment 1D. The UE of numbered apparatus embodiment 1C wherein performing an additional access attempt by transmitting the PRACH signal using the second symbol corresponding to the second time slot follows the plurality of PRACH signals transmitted as part of said initial access attempt and is part of transmitting a plurality of PRACH signals as part of said additional access attempt which follows detection of the failure of the initial access attempt.

Numbered apparatus embodiment 1E. The UE of numbered apparatus embodiment 1D, wherein the plurality of PRACH signals transmitted as part of said additional access attempt are transmitted using symbols of the same type used during said initial access attempt (e.g., all non-SBFD symbols or all SBFD symbols).

Numbered apparatus embodiment 1E1. The UE of numbered apparatus embodiment 1E, wherein the plurality of PRACH signals transmitted as part of said additional access attempt are transmitted using slots of the same type used during said initial access attempt (e.g., all non-SBFD slots or all non-SBFD slots).

Numbered apparatus embodiment 1F. The UE of numbered apparatus embodiment 1D, wherein the plurality of PRACH signals transmitted as part of said additional access attempt are transmitted using symbols of a different type than the type used during said initial access attempt (e.g., if all non-SBFD symbols used during the initial access attempt, then use or all SBFD symbols during the additional access attempt or if all SBFD symbols used during the initial access attempt, then use or all non-SBFD symbols during the additional access attempt).

Numbered apparatus embodiment 1F1. The UE of numbered apparatus embodiment 1F, wherein the plurality of PRACH signals transmitted as part of said additional access attempt are transmitted using slots of a different type than the type used during said initial access attempt (e.g., if all non-SBFD slots used during the initial access attempt, then use or all SBFD slots during the additional access attempt or if all SBFD slots used during the initial access attempt, then use or all SBFD slots during the additional access attempt).

Numbered apparatus embodiment 2. The UE of numbered apparatus embodiment 1, wherein said the second symbol is the same type of symbol as the first symbol.

Numbered apparatus embodiment 3. The UE of numbered apparatus embodiment 2, wherein UE is a non-SBFD capable UE (110, 112, 118, 120, or 400) and the first symbol is a non-SBFD symbol (e.g., non-SBFD devices are limited to using non-SBFD symbols for access attempts).

Numbered apparatus embodiment 4. The UE of numbered apparatus embodiment 3, wherein the UE is an SBFD capable UE (106, 108, 114 or 116 or 300); and wherein the first symbol is a SBFD symbol and the second symbol is an SBFD symbol (in some cases when an SBFD capable UE transmits the initial access attempt in a SBFD symbol or slot it will limit corresponding additional access attempts to symbols/slots of the same type however this is not the case in all embodiments).

Numbered apparatus embodiment 5. The UE of numbered apparatus embodiment 3, wherein the UE is an SBFD capable UE (106, 108, 114, 116 or 300); wherein the first symbol is a non-SBFD symbol; and wherein the second symbol is either a non-SBFD symbol or an SBFD symbol, the processor is further configured to: control the UE to select (624) for the access attempt, following detection of a failed initial access attempt, a first available RACH Occasion (RO) regardless of whether the first available RO corresponds to a non-SBFD or SBFD slot (e.g., SBFD capable UEs will make the most in terms of use of the available ROs in some embodiments to reduce the amount of time between an initial failed access attempt and a subsequent access attempt retry).

Numbered apparatus embodiment 6. The UE of numbered apparatus embodiment 5, wherein the additional access attempt includes transmitting a PRACH signal at a different frequency than the frequency used to transmit the PRACH signal as part of the initial access attempt, when the first and second symbols are different types of symbols (e.g., frequency hopping is supported and a retransmission at a different frequency from the frequency used to transmit the initial access attempt is permitted).

Numbered apparatus embodiment 7. The UE of numbered apparatus embodiment 6, wherein the UE uses a first frequency for transmitting the PRACH signal in a non-SBFD slot as part of the initial access attempt and the UE uses a second frequency for transmitting the PRACH signal in an SBFD slot as part of the additional access attempt, said second frequency being different than said first frequency.

Numbered apparatus embodiment 8. The UE of numbered apparatus embodiment 6, wherein said processor (302) is further configured to control the UE to: use the same frequency for transmitting the PRACH signal as part of the initial access attempt and for transmitting the PRACH signal as part of the additional access attempt when the first and second symbols correspond to slots of the same type (e.g., if the initial and additional attempt are in non-SBFD symbols they use the same frequency in some embodiments).

Numbered apparatus embodiment 5A. The UE of numbered apparatus embodiment 1, wherein the UE is an SBFD capable UE; wherein the first symbol is a SBFD symbol; and wherein the second symbol is either a non-SBFD symbol or an SBFD symbol, and wherein the processor (302) is further configured to: operate the UE to select (624) for the additional access attempt, following detection (684) of a failed initial access attempt, a first available RACH Occasion (RO) regardless of whether the first available RO corresponds to a non-SBFD slot or a SBFD slot (e.g., SBFD capable UEs will make the most in terms of use of the available ROs in some embodiments to reduce the amount of time between an initial failed access attempt and a subsequent access attempt retry).

Numbered apparatus embodiment 6A. The UE of numbered apparatus embodiment 5A, wherein the additional access attempt includes transmitting a PRACH signal at a different frequency than the frequency used to transmit the PRACH signal as part of the initial access attempt, when the first and second symbols are different types of symbols (e.g., frequency hopping is supported and a retransmission at a different frequency from the frequency used to transmit the initial access attempt is permitted).

Numbered apparatus embodiment 7A. The UE of numbered apparatus embodiment 6A, wherein the UE uses a first frequency for transmitting the PRACH signal in a SBFD slot as part of the initial access attempt and the UE uses a second frequency for transmitting the PRACH signal in a non-SBFD slot as part of the additional access attempt, said second frequency being different than said first frequency.

Numbered apparatus embodiment 8A. The UE of numbered apparatus embodiment 6A, wherein said processor (302) is configured to control the UE to: use the same frequency for transmitting the PRACH signal as part of the initial access attempt and for transmitting the PRACH signal as part of the additional access attempt when the first and second symbols correspond to slots of the same type.

The techniques of various embodiments may be implemented using software, hardware and/or a combination of software and hardware. Various embodiments are directed to apparatus, e.g., base stations, user equipment (UE) devices, core network devices (e.g., PCF devices, AMF devices, SMF devices, UPF devices, UDM devices, UDR devices, AUSF devices, etc.), access network devices (e.g., WLAN APs, base stations, WiFi access nodes, cable network access devices), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. Various embodiments are also directed to methods, e.g., method of controlling and/or operating base stations, user equipment (UE) devices, core network devices (e.g., PCF devices, AMF devices, SMF devices, UPF devices, AUSF devices, UDM devices, UDR devices, etc.), access network devices (e.g., WLAN APs, base stations, WiFi access nodes, cable network access devices), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. Various embodiments are also directed to a machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order and are not meant to be limited to the specific order or hierarchy presented. In some embodiments, one or more processors are used to carry out one or more steps of each of the described methods.

In various embodiments each of the steps or elements of a method are implemented using one or more processors. In some embodiments, each of elements or steps are implemented using hardware circuitry.

In various embodiments devices, e.g., base stations, user equipment (UE) devices, core network devices (e.g., PCF devices, AMF devices, SMF devices, UPF devices, UDM devices, UDR devices, AUSF devices, etc.), access network devices (e.g., base stations, WLAN APs, WiFi access nodes, cable network access devices), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements described herein are implemented using one or more components to perform the steps corresponding to one or more methods, for example, provisioning and/or configuring user equipment devices, provisioning and/or configuring AP devices, provisioning AAA servers, provisioning orchestration servers, generating messages, message reception, message transmission, signal processing, sending, comparing, determining and/or transmission steps. Thus, in some embodiments various features are implemented using components, or in some embodiments logic such as for example logic circuits. Such components may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more devices, servers, nodes and/or elements. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a controller, including a processor configured to implement one, multiple or all of the steps of one or more methods of the invention.

In some embodiments, the processor or processors, e.g., CPUs, of one or more devices, e.g., base stations, user (UE) devices, core network devices (e.g., PCF devices, AMF devices, SMF devices, UPF devices, AUSF devices, UDM devices, UDR devices, etc.), access network devices (e.g., base stations, WLAN APs, WiFi access nodes, cable network access devices), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, are configured to perform the steps of the methods described as being performed by the base stations, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. The configuration of the processor may be achieved by using one or more components, e.g., software components, to control processor configuration and/or by including hardware in the processor, e.g., hardware components, to perform the recited steps and/or control processor configuration. Accordingly, some but not all embodiments are directed to a device, e.g., a base station, a user equipment (UE) device, core network device (e.g., PCF device, AMF device, SMF device, UPF device, AUSF device, UDM device, UDR device, etc.), access network device (e.g., base station, WLAN AP, WiFi access node, cable network access device), wireless device, mobile device, smartphone, subscriber device, desktop computer, printer, IPTV, laptop, tablet, network edge device, Access Point, wireless router, switch, WLAN controller, orchestration server, orchestrator, Gateway, AAA server, server, node and/or element, with a processor which includes a component corresponding to each of the steps of the various described methods performed by the device in which the processor is included. In some but not all embodiments a device, e.g., a base station, a user equipment (UE) device, core network devices (e.g., PCF devices, AMF devices, SMF devices, UPF devices, AUSF devices, UDM devices, UDR devices, etc.), access network devices (e.g., base stations, WLAN APs, WiFi access nodes, cable network access devices), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, includes a controller corresponding to each of the steps of the various described methods performed by the device in which the processor is included. The components may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above. Depending on the embodiment, the computer program product can, and sometimes does, include different code for each step to be performed. Thus, the computer program product may, and sometimes does, include code for each individual step of a method, e.g., a method of controlling a device, e.g., a base station, a user equipment (UE) device, core network device (e.g., PCF device, AMF device, SMF device, UPF device, AUSF device, UDM device, UDR device, etc.), access network device (e.g., base station, WLAN AP, WiFi access node, cable network access device), wireless device, mobile device, smartphone, subscriber device, desktop computer, printer, IPTV, laptop, tablet, network edge device, Access Point, wireless router, switch, WLAN controller, orchestration server, orchestrator, Gateway, AAA server, server, nodes and/or element. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device such as a base station, a user equipment (UE) device, core network device (e.g., PCF device, AMF device, SMF device, UPF device, AUSF device, UDM device, UDR device, etc.), access network device (e.g., base station, WLAN AP, WiFi access node, cable network access device), wireless device, mobile device, smartphone, subscriber device, desktop computer, printer, IPTV, laptop, tablets, network edge device, Access Point, wireless router, switch, WLAN controller, orchestration server, orchestrator, Gateway, AAA server, server, node and/or element or other device described in the present application.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A method of operating a UE, the method comprising:
operating a UE to transmit a PRACH signal as part of an initial access attempt using a first symbol, said first symbol being a non-SBFD symbol or SBFD symbol in a timing structure including both non-SBFD symbols and SBFD symbols (it is to be understood that the invention can also apply to slots but slots include symbols of a type corresponding to the type of slot, e.g., SBFD symbols are in SBFD slots and non-SBFD symbols are in non-SBFD slots, and thus the claim is written using symbol language);
detecting failure of the initial access attempt; and
performing an additional access attempt, said step of performing an additional access attempt including transmitting a PRACH signal using a second symbol corresponding to a second time slot following a first time slot, in which said first symbol used for the initial access attempt was located.

2. The method of claim 1, wherein said the second symbol is the same type of symbol as the first symbol.

3. The method of claim 2, wherein UE is a non-SBFD capable UE; and wherein the first symbol is a non-SBFD symbol.

4. The method of claim 2, wherein the UE is an SBFD capable UE; wherein the first symbol is a SBFD symbol; and wherein the second symbol is an SBFD symbol.

5. The method of claim 1, wherein the UE is an SBFD capable UE; wherein the first symbol is a non-SBFD symbol; and wherein the second symbol is either a non-SBFD symbol or an SBFD symbol, the method comprising:
operating the UE to select for the additional access attempt, following detection of a failed initial access attempt, a first available RACH Occasion (RO) regardless of whether the first available RO corresponds to a non-SBFD slot or a SBFD slot.

6. The method of claim 5, wherein the additional access attempt includes transmitting a PRACH signal at a different frequency than the frequency used to transmit the PRACH signal as part of the initial access attempt, when the first and second symbols are different types of symbols (e.g., frequency hopping is supported and a retransmission at a different frequency from the frequency used to transmit the initial access attempt is permitted).

7. The method of claim 6, wherein the method includes using a first frequency for transmitting the PRACH signal in a non-SBFD slot as part of the initial access attempt and using a second frequency for transmitting the PRACH signal in an SBFD slot as part of the additional access attempt, said second frequency being different than said first frequency.

8. The method of claim 6, further comprising:
using the same frequency for transmitting the PRACH signal as part of the initial access attempt and for transmitting the PRACH signal as part of the additional access attempt when the first and second symbols correspond to slots of the same type.

9. The method of claim 1, wherein the UE is an SBFD capable UE; wherein the first symbol is a SBFD symbol; and wherein the second symbol is either a non-SBFD symbol or an SBFD symbol, the method comprising:
operating the UE to select for the additional access attempt, following detection of a failed initial access attempt, a first available RACH Occasion (RO) regardless of whether the first available RO corresponds to a non-SBFD slot or a SBFD slot.

10. The method of claim 9, wherein the additional access attempt includes transmitting a PRACH signal at a different frequency than the frequency used to transmit the PRACH signal as part of the initial access attempt, when the first and second symbols are different types of symbols.

11. The method of claim 10, wherein the method includes using a first frequency for transmitting the PRACH signal in a SBFD slot as part of the initial access attempt and using a second frequency for transmitting the PRACH signal in a non-SBFD slot as part of the additional access attempt, said second frequency being different than said first frequency.

12. The method of claim 10, further comprising:
using the same frequency for transmitting the PRACH signal as part of the initial access attempt and for transmitting the PRACH signal as part of the additional access attempt when the first and second symbols correspond to slots of the same type.

13. A user Equipment (UE), comprising:
a receiver for receiving information;
a transmitter;
a processor configured to control the UE to:
transmit a PRACH signal on a as part of an initial access attempt using a first symbol, said first symbol being a non-SBFD symbol or SBFD symbol in a timing structure including both non-SBFD symbols and SBFD symbols;
detect failure of the initial access attempt; and
perform an additional access attempt including transmitting a PRACH signal using a second symbol corresponding to a second time slot following a first time slot in which said first symbol used for the initial access attempt was located.

14. The UE of claim 13, wherein said the second symbol is the same type of symbol as the first symbol.

15. The UE of claim 14, wherein UE is a non-SBFD capable UE and the first symbol is a non-SBFD symbol.

16. The UE of claim 15,
wherein the UE is an SBFD capable UE; and
wherein the first symbol is a SBFD symbol and the second symbol is an SBFD symbol.

17. The UE of claim 15,
wherein the UE is an SBFD capable UE;
wherein the first symbol is a non-SBFD symbol; and wherein the second symbol is either a non-SBFD symbol or an SBFD symbol, the processor is further configured to:
control the UE to select (624) for the access attempt, following detection of a failed initial access attempt, a first available RACH Occasion (RO) regardless of whether the first available RO corresponds to a non-SBFD or SBFD slot.

18. The UE of claim 17, wherein the additional access attempt includes transmitting a PRACH signal at a different frequency than the frequency used to transmit the PRACH signal as part of the initial access attempt, when the first and second symbols are different types of symbols.

19. The UE of claim 18, wherein the UE uses a first frequency for transmitting the PRACH signal in a non-SBFD slot as part of the initial access attempt and the UE uses a second frequency for transmitting the PRACH signal in an SBFD slot as part of the additional access attempt, said second frequency being different than said first frequency.

20. The UE of claim 18, wherein said processor is further configured to control the UE to:
use the same frequency for transmitting the PRACH signal as part of the initial access attempt and for transmitting the PRACH signal as part of the additional access attempt when the first and second symbols correspond to slots of the same type.
